(19) United States
(12) Patent Application Publication
(10) Pub. No.: US 2026/0178178 A1
(43) Pub. Date: Jun. 25, 2026

(54) USER INTERFACES BASED ON AMBIENT CONDITIONS

(71) Applicant: Apple Inc., Cupertino, CA (US)

(72) Inventors: Eileen Y. LEE, San Francisco, CA (US); Gary I. BUTCHER, Los Gatos, CA (US); Bruno CANALES, San Francisco, CA (US); Marie E. DOMMENGET, San Francisco, CA (US); Lisa K. FORSSELL, Palo Alto, CA (US); Christopher P. FOSS, San Francisco, CA (US); Roxane GATAUD, San Francisco, CA (US); Vincenzo O. GIULIANI, Thousand Oaks, CA (US); Erik R. KLIMCZAK, Mill Valley, CA (US); Josiah W. LARSON, Union City, CA (US); Rudi LIDEN, Glendale, CA (US); Louis R. MIKOLAY, San Francisco, CA (US); James J. OWEN, San Francisco, CA (US); Dennis S. PARK, San Francisco, CA (US); Jonathon O. RACZ, San Francisco, CA (US); Alex TROCHUT, San Rafael, CA (US); Vincenzo VUONO, Cupertino, CA (US)

(21) Appl. No.: 19/409,329

(22) Filed: Dec. 4, 2025

Related U.S. Application Data
(60) Provisional application No. 63/737,553, filed on Dec. 20, 2024.
(60) Provisional application No. 63/878,015, filed on Sep. 8, 2025.

(51) Int. Cl. G06F 3/04845; G06F 3/01; G06T 11/10; G06T 13/80

(52) U.S. Cl. CPC G06F 3/04845; G06F 3/011; G06T 11/10; G06T 13/80; G06F 2203/04804; G06T 2200/24

(57) ABSTRACT

The present disclosure generally relates to user interfaces that are based on ambient conditions. In accordance with some embodiments, user interfaces based on a color temperature of ambient lighting, a lighting angle, presence of a user, and/or a position of a user are described.

### CROSS-REFERENCE TO RELATED APPLICATIONS

This application claims priority to U.S. Provisional Patent Application Ser. No. 63/737,553, entitled “USER INTERFACES BASED ON AMBIENT CONDITIONS,” filed on Dec. 20, 2024, and U.S. Provisional Patent Application Ser. No. 63/878,015, entitled “USER INTERFACES BASED ON AMBIENT CONDITIONS,” filed on Sep. 8, 2025. The contents of these applications are hereby incorporated by reference in their entirety.

### FIELD

The present disclosure relates generally to computer user interfaces, and more specifically to techniques for displaying user interfaces based on ambient conditions.

### BACKGROUND

Electronic devices include displays that can be used to display various types of content and to provide information to a user. Electronic devices, such as smartphones and smartwatches, can be used in environments that have ambient conditions.

### BRIEF SUMMARY

Some techniques for displaying user interfaces based on ambient conditions using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for displaying user interfaces based on ambient conditions. Such methods and interfaces optionally complement or replace other methods for displaying user interfaces based on ambient conditions. Such methods and interfaces reduce the cognitive burden on a user and produce a more efficient human-machine interface. Such methods and interfaces reduce the consumption of processing power and minimize the number of unnecessary received inputs. For battery-operated computing devices, such methods and interfaces conserve power and increase the time between battery charges.

In accordance with some embodiments, a method is described. The method comprises: at a computer system that is in communication with one or more display generation components and one or more input devices: while displaying a user interface with a first appearance, detecting, via the one or more input devices, a change in an ambient lighting condition that includes one or more values for one or more lighting parameters of an environment surrounding the computer system from a first ambient lighting condition to a second ambient lighting condition that is different from the first ambient lighting condition, wherein the first ambient lighting condition includes a first color temperature of ambient light in the environment surrounding the computer system; and in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, changing the user interface to having a second appearance that is based on the change in the color temperature to the second color temperature.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: while displaying a user interface with a first appearance, detecting, via the one or more input devices, a change in an ambient lighting condition that includes one or more values for one or more lighting parameters of an environment surrounding the computer system from a first ambient lighting condition to a second ambient lighting condition that is different from the first ambient lighting condition, wherein the first ambient lighting condition includes a first color temperature of ambient light in the environment surrounding the computer system; and in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, changing the user interface to having a second appearance that is based on the change in the color temperature to the second color temperature.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: while displaying a user interface with a first appearance, detecting, via the one or more input devices, a change in an ambient lighting condition that includes one or more values for one or more lighting parameters of an environment surrounding the computer system from a first ambient lighting condition to a second ambient lighting condition that is different from the first ambient lighting condition, wherein the first ambient lighting condition includes a first color temperature of ambient light in the environment surrounding the computer system; and in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, changing the user interface to having a second appearance that is based on the change in the color temperature to the second color temperature.

In accordance with some embodiments, a computer system configured to communicate with one or more display generation components and one or more input devices is described. The computer system comprises: one or more processors; and memory storing one or more programs configured to be executed by the one or more processors, the one or more programs including instructions for: while displaying a user interface with a first appearance, detecting, via the one or more input devices, a change in an ambient lighting condition that includes one or more values for one or more lighting parameters of an environment surrounding the computer system from a first ambient lighting condition to a second ambient lighting condition that is different from the first ambient lighting condition, wherein the first ambient lighting condition includes a first color temperature of ambient light in the environment surrounding the computer system; and in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, changing the user interface to having a second appearance that is based on the change in the color temperature to the second color temperature.

In accordance with some embodiments, a computer system configured to communicate with one or more display generation components and one or more input devices is described. A computer system comprises: while displaying a user interface with a first appearance, means for detecting, via the one or more input devices, a change in an ambient lighting condition that includes one or more values for one or more lighting parameters of an environment surrounding the computer system from a first ambient lighting condition to a second ambient lighting condition that is different from the first ambient lighting condition, wherein the first ambient lighting condition includes a first color temperature of ambient light in the environment surrounding the computer system; and in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, means for changing the user interface to having a second appearance that is based on the change in the color temperature to the second color temperature.

In accordance with some embodiments, a computer program product is described. The computer program product comprises one or more programs configured to be executed by one or more processors of a computer system that is in communication with one or more display generation components and one or more input devices, the one or more programs including instructions for: while displaying a user interface with a first appearance, detecting, via the one or more input devices, a change in an ambient lighting condition that includes one or more values for one or more lighting parameters of an environment surrounding the computer system from a first ambient lighting condition to a second ambient lighting condition that is different from the first ambient lighting condition, wherein the first ambient lighting condition includes a first color temperature of ambient light in the environment surrounding the computer system; and in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, changing the user interface to having a second appearance that is based on the change in the color temperature to the second color temperature.

In accordance with some embodiments, a method is described. The method comprises: at a computer system that is in communication with one or more display generation components and one or more input devices: detecting, via the one or more input devices, an event corresponding to a request to display a respective user interface; and in response to detecting the event, displaying, via the one or more display generation components, the respective user interface having a respective appearance based on a detected direction of ambient light, including: in accordance with a determination that the detected direction of ambient light is a first direction, displaying, via the one or more display generation components, the respective user interface having a first appearance; and in accordance with a determination that the detected direction of ambient light is a second direction that is different from the first direction, displaying, via the one or more display generation components, the respective user interface having a second appearance that is different from the first appearance.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, an event corresponding to a request to display a respective user interface; and in response to detecting the event, displaying, via the one or more display generation components, the respective user interface having a respective appearance based on a detected direction of ambient light, including: in accordance with a determination that the detected direction of ambient light is a first direction, displaying, via the one or more display generation components, the respective user interface having a first appearance; and in accordance with a determination that the detected direction of ambient light is a second direction that is different from the first direction, displaying, via the one or more display generation components, the respective user interface having a second appearance that is different from the first appearance.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: detecting, via the one or more input devices, an event corresponding to a request to display a respective user interface; and in response to detecting the event, displaying, via the one or more display generation components, the respective user interface having a respective appearance based on a detected direction of ambient light, including: in accordance with a determination that the detected direction of ambient light is a first direction, displaying, via the one or more display generation components, the respective user interface having a first appearance; and in accordance with a determination that the detected direction of ambient light is a second direction that is different from the first direction, displaying, via the one or more display generation components, the respective user interface having a second appearance that is different from the first appearance.

In accordance with some embodiments, a computer system configured to communicate with one or more display generation components and one or more input devices is described. The computer system comprises: one or more processors; and memory storing one or more programs configured to be executed by the one or more processors, the one or more programs including instructions for: detecting, via the one or more input devices, an event corresponding to a request to display a respective user interface; and in response to detecting the event, displaying, via the one or more display generation components, the respective user interface having a respective appearance based on a detected direction of ambient light, including: in accordance with a determination that the detected direction of ambient light is a first direction, displaying, via the one or more display generation components, the respective user interface having a first appearance; and in accordance with a determination that the detected direction of ambient light is a second direction that is different from the first direction, displaying, via the one or more display generation components, the respective user interface having a second appearance that is different from the first appearance.

In accordance with some embodiments, a computer system configured to communicate with one or more display generation components and one or more input devices is described. The computer system comprises: means for detecting, via the one or more input devices, an event corresponding to a request to display a respective user interface; and in response to detecting the event, means for displaying, via the one or more display generation components, the respective user interface having a respective appearance based on a detected direction of ambient light, including: in accordance with a determination that the detected direction of ambient light is a first direction, displaying, via the one or more display generation components, the respective user interface having a first appearance; and in accordance with a determination that the detected direction of ambient light is a second direction that is different from the first direction, displaying, via the one or more display generation components, the respective user interface having a second appearance that is different from the first appearance.

In accordance with some embodiments, a computer program product is described. The computer program product comprises one or more programs configured to be executed by one or more processors of a computer system that is in communication with one or more display generation components and one or more input devices, the one or more programs including instructions for: detecting, via the one or more input devices, an event corresponding to a request to display a respective user interface; and in response to detecting the event, displaying, via the one or more display generation components, the respective user interface having a respective appearance based on a detected direction of ambient light, including: in accordance with a determination that the detected direction of ambient light is a first direction, displaying, via the one or more display generation components, the respective user interface having a first appearance; and in accordance with a determination that the detected direction of ambient light is a second direction that is different from the first direction, displaying, via the one or more display generation components, the respective user interface having a second appearance that is different from the first appearance.

In accordance with some embodiments, a method is described. The method comprises: at a computer system that is in communication with one or more display generation components and one or more input devices: displaying, via the one or more display generation components, a user interface with a visual effect with a first appearance; detecting, via the one or more input devices, a change in position of a person relative to the one or more display generation components; and in response to detecting the change in the position of the person relative to the one or more display generation components, displaying, via the one or more display generation components, the user interface with a change in the visual effect, wherein: in accordance with a determination that the change in position of the person is a first change, displaying the change in the visual effect includes displaying the visual effect with a first updated appearance that is different from the first appearance; and in accordance with a determination that the change in position of the person is a second change that is different from the first change, displaying the change in the visual effect includes displaying the visual effect with a second updated appearance that is different from the first appearance and the first updated appearance.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a user interface with a visual effect with a first appearance; detecting, via the one or more input devices, a change in position of a person relative to the one or more display generation components; and in response to detecting the change in the position of the person relative to the one or more display generation components, displaying, via the one or more display generation components, the user interface with a change in the visual effect, wherein: in accordance with a determination that the change in position of the person is a first change, displaying the change in the visual effect includes displaying the visual effect with a first updated appearance that is different from the first appearance; and in accordance with a determination that the change in position of the person is a second change that is different from the first change, displaying the change in the visual effect includes displaying the visual effect with a second updated appearance that is different from the first appearance and the first updated appearance.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a user interface with a visual effect with a first appearance; detecting, via the one or more input devices, a change in position of a person relative to the one or more display generation components; and in response to detecting the change in the position of the person relative to the one or more display generation components, displaying, via the one or more display generation components, the user interface with a change in the visual effect, wherein: in accordance with a determination that the change in position of the person is a first change, displaying the change in the visual effect includes displaying the visual effect with a first updated appearance that is different from the first appearance; and in accordance with a determination that the change in position of the person is a second change that is different from the first change, displaying the change in the visual effect includes displaying the visual effect with a second updated appearance that is different from the first appearance and the first updated appearance.

In accordance with some embodiments, a computer system configured to communicate with one or more display generation components and one or more input devices is described. The computer system comprises: one or more processors; and memory storing one or more programs configured to be executed by the one or more processors, the one or more programs including instructions for: displaying, via the one or more display generation components, a user interface with a visual effect with a first appearance; detecting, via the one or more input devices, a change in position of a person relative to the one or more display generation components; and in response to detecting the change in the position of the person relative to the one or more display generation components, displaying, via the one or more display generation components, the user interface with a change in the visual effect, wherein: in accordance with a determination that the change in position of the person is a first change, displaying the change in the visual effect includes displaying the visual effect with a first updated appearance that is different from the first appearance; and in accordance with a determination that the change in position of the person is a second change that is different from the first change, displaying the change in the visual effect includes displaying the visual effect with a second updated appearance that is different from the first appearance and the first updated appearance.

In accordance with some embodiments, a computer system configured to communicate with one or more display generation components and one or more input devices is described. The computer system comprises: means for displaying, via the one or more display generation components, a user interface with a visual effect with a first appearance; means for detecting, via the one or more input devices, a change in position of a person relative to the one or more display generation components; and in response to detecting the change in the position of the person relative to the one or more display generation components, means for displaying, via the one or more display generation components, the user interface with a change in the visual effect, wherein: in accordance with a determination that the change in position of the person is a first change, displaying the change in the visual effect includes displaying the visual effect with a first updated appearance that is different from the first appearance; and in accordance with a determination that the change in position of the person is a second change that is different from the first change, displaying the change in the visual effect includes displaying the visual effect with a second updated appearance that is different from the first appearance and the first updated appearance.

In accordance with some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a user interface with a visual effect with a first appearance; detecting, via the one or more input devices, a change in position of a person relative to the one or more display generation components; and in response to detecting the change in the position of the person relative to the one or more display generation components, displaying, via the one or more display generation components, the user interface with a change in the visual effect, wherein: in accordance with a determination that the change in position of the person is a first change, displaying the change in the visual effect includes displaying the visual effect with a first updated appearance that is different from the first appearance; and in accordance with a determination that the change in position of the person is a second change that is different from the first change, displaying the change in the visual effect includes displaying the visual effect with a second updated appearance that is different from the first appearance and the first updated appearance.

In accordance with some embodiments, a method is described. The method comprises: at a computer system that is in communication with one or more display generation components and one or more input: displaying, via the one or more display generation components, a user interface that includes status information; and while displaying the user interface that includes the status information: in accordance with a determination that presence of a person is detected, displaying, via the one or more display generation components, a dynamic element concurrently with the status information, wherein the dynamic element responds to movement of the person; and in accordance with a determination that presence of a person is not detected, displaying, via the display generation component, the user interface that includes the status information without displaying the dynamic element.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a user interface that includes status information; and while displaying the user interface that includes the status information: in accordance with a determination that presence of a person is detected, displaying, via the one or more display generation components, a dynamic element concurrently with the status information, wherein the dynamic element responds to movement of the person; and in accordance with a determination that presence of a person is not detected, displaying, via the display generation component, the user interface that includes the status information without displaying the dynamic element.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a user interface that includes status information; and while displaying the user interface that includes the status information: in accordance with a determination that presence of a person is detected, displaying, via the one or more display generation components, a dynamic element concurrently with the status information, wherein the dynamic element responds to movement of the person; and in accordance with a determination that presence of a person is not detected, displaying, via the display generation component, the user interface that includes the status information without displaying the dynamic element.

In accordance with some embodiments, a computer system configured to communicate with one or more display generation components and one or more input devices is described. The computer system comprises: one or more processors; and memory storing one or more programs configured to be executed by the one or more processors, the one or more programs including instructions for: displaying, via the one or more display generation components, a user interface that includes status information; and while displaying the user interface that includes the status information: in accordance with a determination that presence of a person is detected, displaying, via the one or more display generation components, a dynamic element concurrently with the status information, wherein the dynamic element responds to movement of the person; and in accordance with a determination that presence of a person is not detected, displaying, via the display generation component, the user interface that includes the status information without displaying the dynamic element.

In accordance with some embodiments, a computer system configured to communicate with one or more display generation components and one or more input devices is described. The computer system comprises: means for displaying, via the one or more display generation components, a user interface that includes status information; and while displaying the user interface that includes the status information: in accordance with a determination that presence of a person is detected, means for displaying, via the one or more display generation components, a dynamic element concurrently with the status information, wherein the dynamic element responds to movement of the person; and in accordance with a determination that presence of a person is not detected, means for displaying, via the display generation component, the user interface that includes the status information without displaying the dynamic element.

In accordance with some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a user interface that includes status information; and while displaying the user interface that includes the status information: in accordance with a determination that presence of a person is detected, displaying, via the one or more display generation components, a dynamic element concurrently with the status information, wherein the dynamic element responds to movement of the person; and in accordance with a determination that presence of a person is not detected, displaying, via the display generation component, the user interface that includes the status information without displaying the dynamic element.

In accordance with some embodiments, a method is described. The method comprises: at a computer system that is in communication with one or more display generation components and one or more input devices: displaying, via the one or more display generation components, a user interface that includes contextual information; while displaying the user interface that includes contextual information, detecting, via the one or more input devices, a change in presence of a person in a respective region of a physical environment near the one or more display generation components; and in response to detecting the change in presence of the person in the respective region of the physical environment near the one or more display generation components, displaying, via the one or more display generation components, in the user interface, an animation of an anthropomorphic character that is displayed concurrently with at least a portion of the contextual information.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a user interface that includes contextual information; while displaying the user interface that includes contextual information, detecting, via the one or more input devices, a change in presence of a person in a respective region of a physical environment near the one or more display generation components; and in response to detecting the change in presence of the person in the respective region of the physical environment near the one or more display generation components, displaying, via the one or more display generation components, in the user interface, an animation of an anthropomorphic character that is displayed concurrently with at least a portion of the contextual information.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a user interface that includes contextual information; while displaying the user interface that includes contextual information, detecting, via the one or more input devices, a change in presence of a person in a respective region of a physical environment near the one or more display generation components; and in response to detecting the change in presence of the person in the respective region of the physical environment near the one or more display generation components, displaying, via the one or more display generation components, in the user interface, an animation of an anthropomorphic character that is displayed concurrently with at least a portion of the contextual information.

In accordance with some embodiments, a computer system configured to communicate with one or more display generation components and one or more input devices is described. The computer system comprises: one or more processors; and memory storing one or more programs configured to be executed by the one or more processors, the one or more programs including instructions for: displaying, via the one or more display generation components, a user interface that includes contextual information; while displaying the user interface that includes contextual information, detecting, via the one or more input devices, a change in presence of a person in a respective region of a physical environment near the one or more display generation components; and in response to detecting the change in presence of the person in the respective region of the physical environment near the one or more display generation components, displaying, via the one or more display generation components, in the user interface, an animation of an anthropomorphic character that is displayed concurrently with at least a portion of the contextual information.

In accordance with some embodiments, a computer system configured to communicate with one or more display generation components and one or more input devices is described. The computer system comprises: means for displaying, via the one or more display generation components, a user interface that includes contextual information; while displaying the user interface that includes contextual information, means for detecting, via the one or more input devices, a change in presence of a person in a respective region of a physical environment near the one or more display generation components; and in response to detecting the change in presence of the person in the respective region of the physical environment near the one or more display generation components, means for displaying, via the one or more display generation components, in the user interface, an animation of an anthropomorphic character that is displayed concurrently with at least a portion of the contextual information.

In accordance with some embodiments, a computer program product is described. The computer program product comprises one or more programs configured to be executed by one or more processors of a computer system that is in communication with one or more display generation components and one or more input devices, the one or more programs including instructions for: displaying, via the one or more display generation components, a user interface that includes contextual information; while displaying the user interface that includes contextual information, detecting, via the one or more input devices, a change in presence of a person in a respective region of a physical environment near the one or more display generation components; and in response to detecting the change in presence of the person in the respective region of the physical environment near the one or more display generation components, displaying, via the one or more display generation components, in the user interface, an animation of an anthropomorphic character that is displayed concurrently with at least a portion of the contextual information.

In accordance with some embodiments, a method is described. The method comprises: at a computer system that is in communication with one or more display generation components: while the computer system is in a first power state, displaying, via the one or more display generation components, a time user interface with a first appearance, wherein displaying the time user interface with the first appearance includes concurrently displaying: an indication of a respective time; and an animated background; while displaying the time user interface with the first appearance, detecting that low power state criteria are met; and in response to detecting that the low power state criteria are met: displaying, via the one or more display generation components, the time user interface with a second appearance different from the first appearance, wherein, displaying the time user interface with the second appearance includes: displaying an indication of time that includes one or more visual characteristics that are determined based on a respective portion of the animated background that is selected based on a shape of the indication of time; and ceasing to display the animated background outside of the respective portion of the animated background.

In accordance with some embodiments, a non-transitory computer-readable storage medium is described. The non-transitory computer-readable storage medium stores one or more programs configured to be executed by one or more processors of a computer system that is in communication with one or more display generation components, the one or more programs including instructions for: while the computer system is in a first power state, displaying, via the one or more display generation components, a time user interface with a first appearance, wherein displaying the time user interface with the first appearance includes concurrently displaying: an indication of a respective time; and an animated background; while displaying the time user interface with the first appearance, detecting that low power state criteria are met; and in response to detecting that the low power state criteria are met: displaying, via the one or more display generation components, the time user interface with a second appearance different from the first appearance, wherein, displaying the time user interface with the second appearance includes: displaying an indication of time that includes one or more visual characteristics that are determined based on a respective portion of the animated background that is selected based on a shape of the indication of time; and ceasing to display the animated background outside of the respective portion of the animated background.

In accordance with some embodiments, a transitory computer-readable storage medium is described. The transitory computer-readable storage medium stores one or more programs configured to be executed by one or more processors of a computer system that is in communication with one or more display generation components, the one or more programs including instructions for: while the computer system is in a first power state, displaying, via the one or more display generation components, a time user interface with a first appearance, wherein displaying the time user interface with the first appearance includes concurrently displaying: an indication of a respective time; and an animated background; while displaying the time user interface with the first appearance, detecting that low power state criteria are met; and in response to detecting that the low power state criteria are met: displaying, via the one or more display generation components, the time user interface with a second appearance different from the first appearance, wherein, displaying the time user interface with the second appearance includes: displaying an indication of time that includes one or more visual characteristics that are determined based on a respective portion of the animated background that is selected based on a shape of the indication of time; and ceasing to display the animated background outside of the respective portion of the animated background.

In accordance with some embodiments, a computer system configured to communicate with one or more display generation components is described. The computer system comprises: one or more processors; and memory storing one or more programs configured to be executed by the one or more processors, the one or more programs including instructions for: while the computer system is in a first power state, displaying, via the one or more display generation components, a time user interface with a first appearance, wherein displaying the time user interface with the first appearance includes concurrently displaying: an indication of a respective time; and an animated background; while displaying the time user interface with the first appearance, detecting that low power state criteria are met; and in response to detecting that the low power state criteria are met: displaying, via the one or more display generation components, the time user interface with a second appearance different from the first appearance, wherein, displaying the time user interface with the second appearance includes: displaying an indication of time that includes one or more visual characteristics that are determined based on a respective portion of the animated background that is selected based on a shape of the indication of time; and ceasing to display the animated background outside of the respective portion of the animated background.

In accordance with some embodiments, a computer system configured to communicate with one or more display generation components and one or more input devices is described. The computer system comprises: means for, while the computer system is in a first power state, displaying, via the one or more display generation components, a time user interface with a first appearance, wherein displaying the time user interface with the first appearance includes concurrently displaying: an indication of a respective time; and an animated background; means for, while displaying the time user interface with the first appearance, detecting that low power state criteria are met; and means for, in response to detecting that the low power state criteria are met: displaying, via the one or more display generation components, the time user interface with a second appearance different from the first appearance, wherein, displaying the time user interface with the second appearance includes: displaying an indication of time that includes one or more visual characteristics that are determined based on a respective portion of the animated background that is selected based on a shape of the indication of time; and ceasing to display the animated background outside of the respective portion of the animated background.

In accordance with some embodiments, a computer program product is described. The computer program product comprises one or more programs configured to be executed by one or more processors of a computer system that is in communication with one or more display generation components, the one or more programs including instructions for: while the computer system is in a first power state, displaying, via the one or more display generation components, a time user interface with a first appearance, wherein displaying the time user interface with the first appearance includes concurrently displaying: an indication of a respective time; and an animated background; while displaying the time user interface with the first appearance, detecting that low power state criteria are met; and in response to detecting that the low power state criteria are met: displaying, via the one or more display generation components, the time user interface with a second appearance different from the first appearance, wherein, displaying the time user interface with the second appearance includes: displaying an indication of time that includes one or more visual characteristics that are determined based on a respective portion of the animated background that is selected based on a shape of the indication of time; and ceasing to display the animated background outside of the respective portion of the animated background.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying user interfaces based on ambient conditions, thereby increasing the effectiveness, efficiency, and user satisfaction with such devices. Such methods and interfaces may complement or replace other methods for displaying user interfaces based on ambient conditions.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 4C illustrates examples of a computer system detecting the attention and/or the focus of one or more users in accordance with some embodiments.

FIG. 5A illustrates a personal electronic device in accordance with some embodiments.

FIG. 5B is a block diagram illustrating a personal electronic device in accordance with some embodiments.

FIGS. 6A-6H illustrate exemplary user interfaces based on a color temperature of ambient lighting in accordance with some embodiments.

FIG. 7 is a flow diagram illustrating methods for displaying a user interface based on a color temperature of ambient lighting in accordance with some embodiments.

FIGS. 8A-8L illustrate exemplary user interfaces based on lighting angle using a computer system in accordance with some embodiments.

FIG. 9 is a flow diagram illustrating methods for displaying a user interface based on lighting angle using a computer system in accordance with some embodiments.

FIGS. 10A-10P2 illustrate exemplary user interfaces based on a position of a user using a computer system in accordance with some embodiments.

FIG. 11 is a flow diagram illustrating methods for displaying a user interface based on a position of a user using a computer system in accordance with some embodiments.

FIGS. 12A-12K illustrate exemplary user interfaces based on the presence of a user using a computer system in accordance with some embodiments.

FIG. 13 is a flow diagram illustrating methods for displaying a user interface based on the presence of a user using a computer system in accordance with some embodiments.

FIGS. 14A-14U illustrate exemplary user interfaces based on the presence of a user using a computer system in accordance with some embodiments.

FIG. 15 is a flow diagram illustrating methods for displaying a user interface based on the presence of a user using a computer system in accordance with some embodiments.

FIGS. 16A-16L illustrate exemplary user interfaces for displaying a time user interface in accordance with some embodiments.

FIG. 17 is a flow diagram illustrating methods for displaying a time user interface in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for displaying user interfaces based on ambient conditions. Such techniques can reduce the cognitive burden on a user who views and accesses user interfaces based on ambient conditions, thereby enhancing productivity. Further, such techniques can reduce processor and battery power otherwise wasted on redundant user inputs.

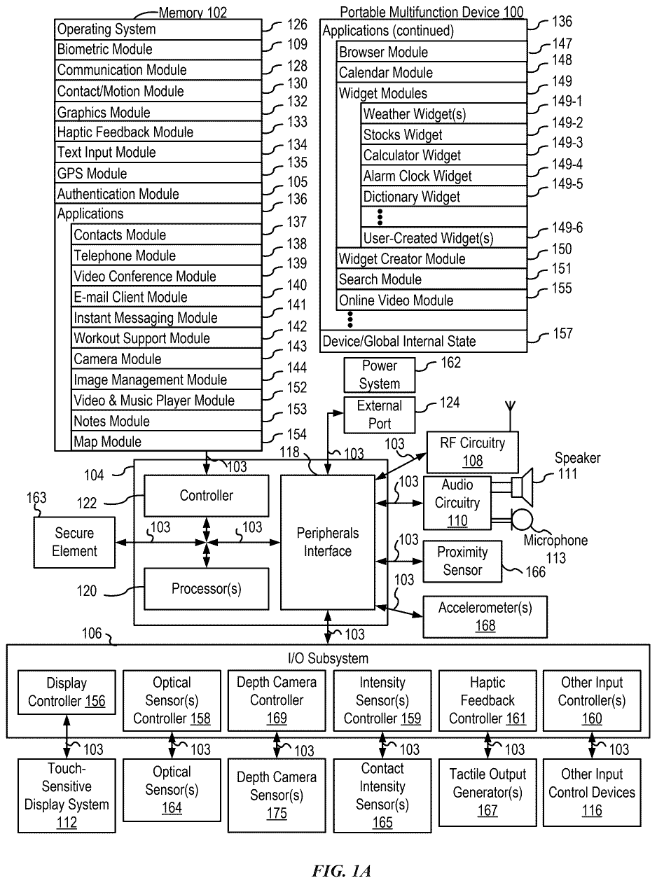

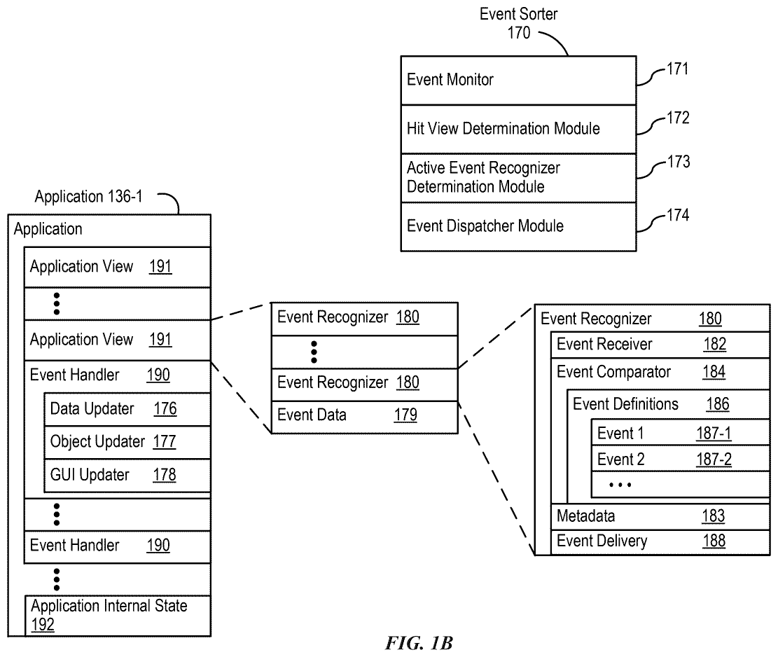

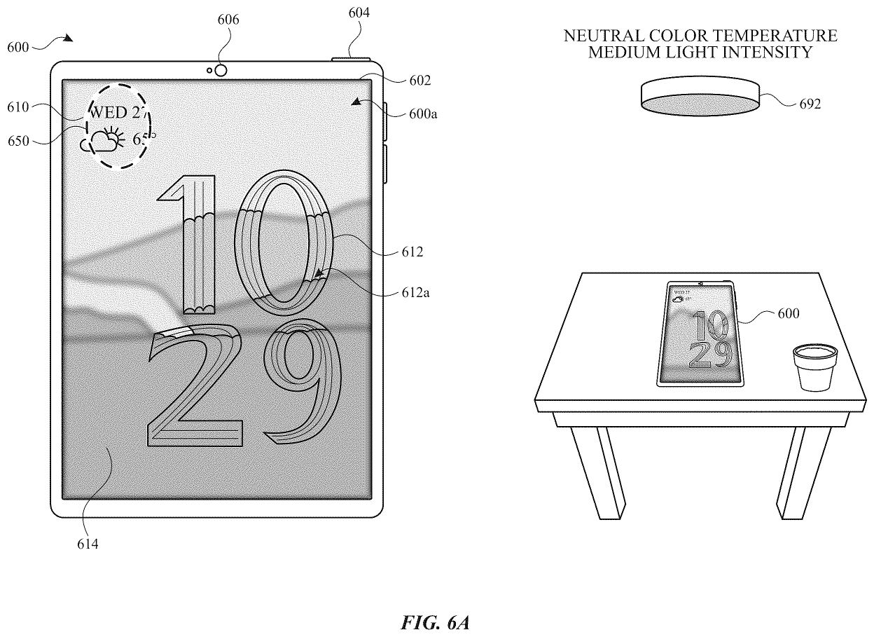

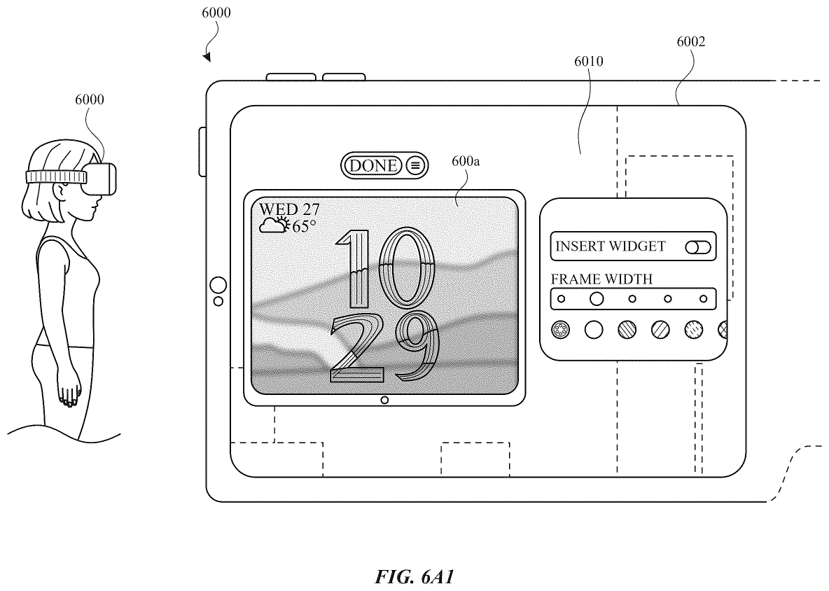

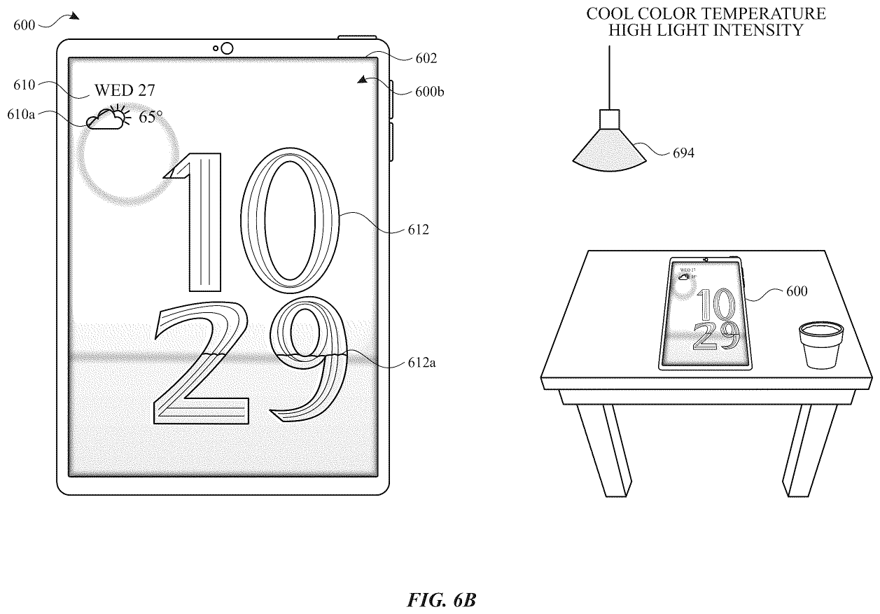

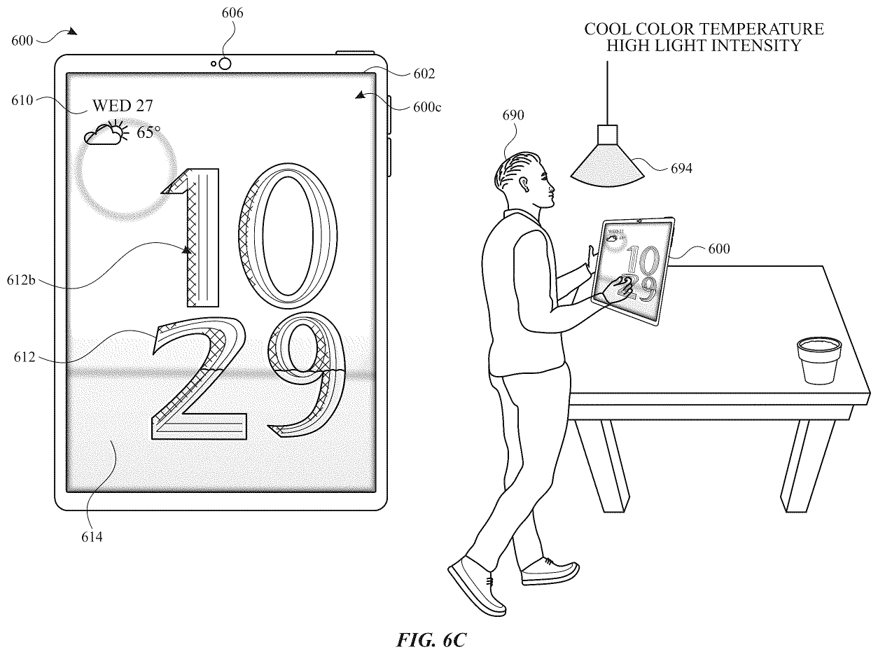

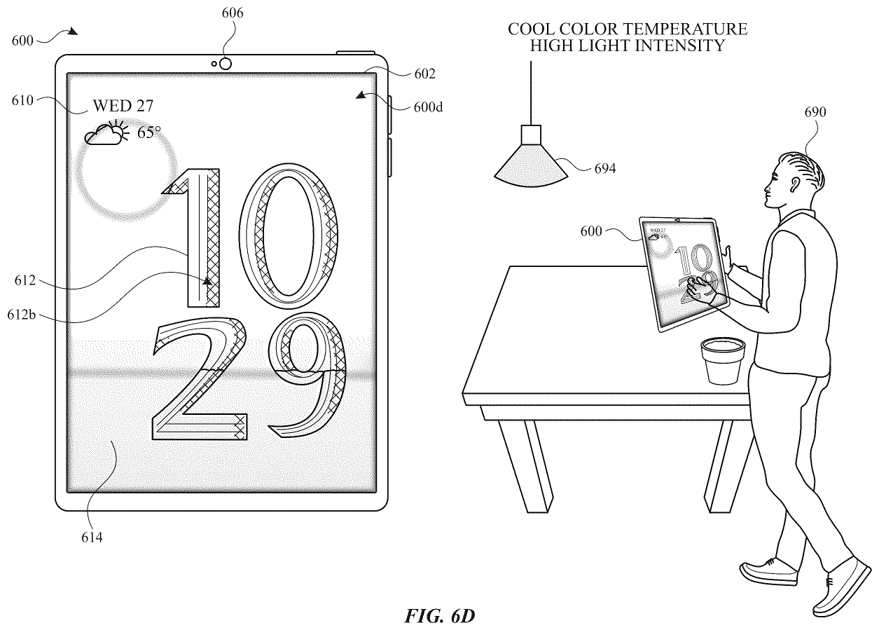

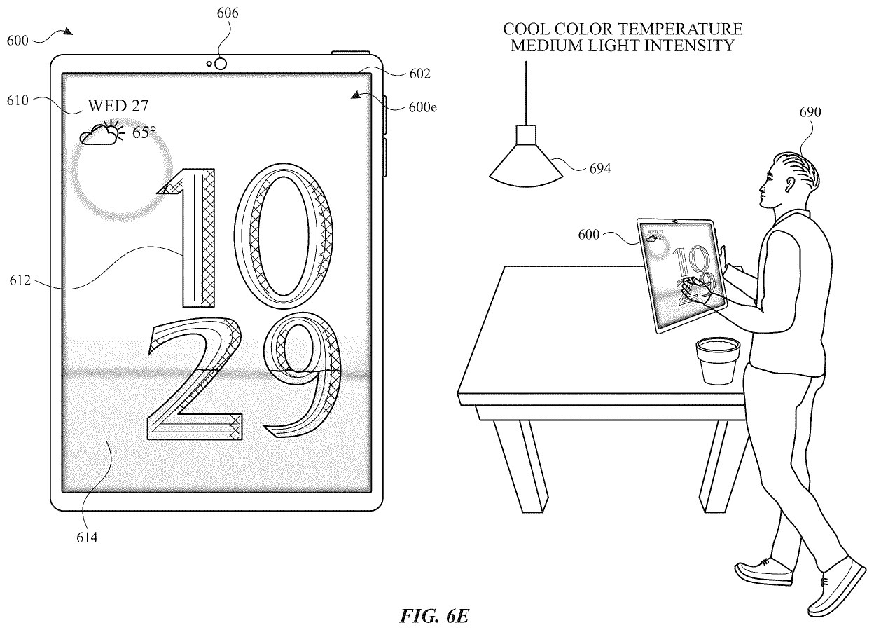

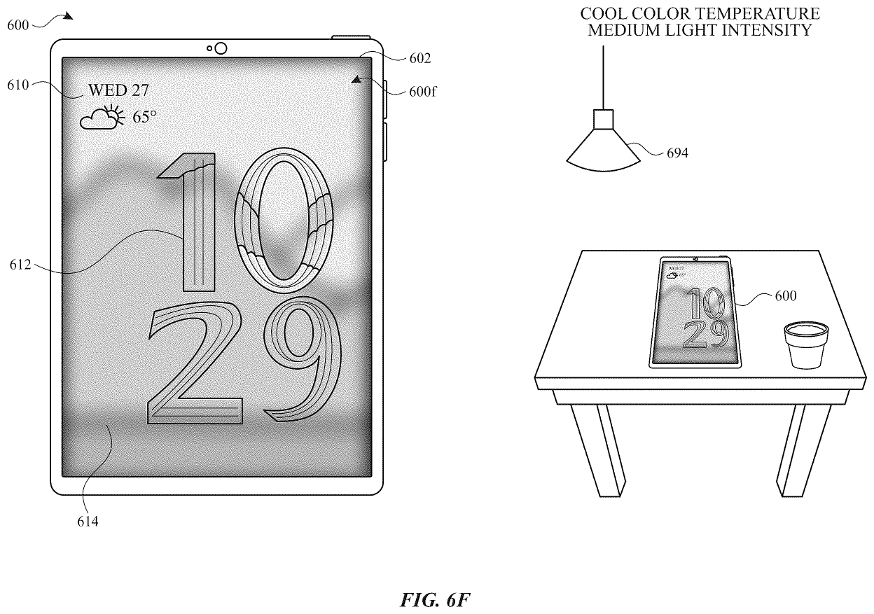

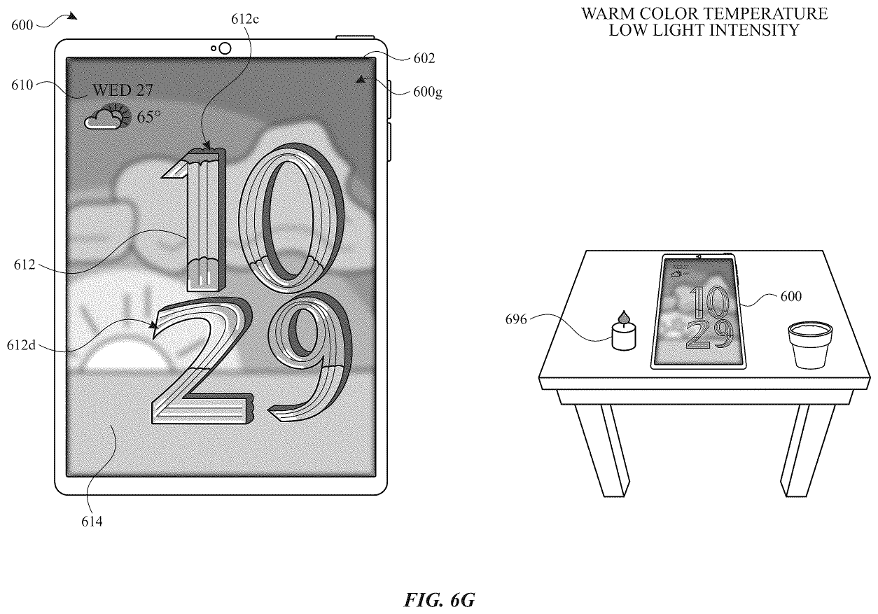

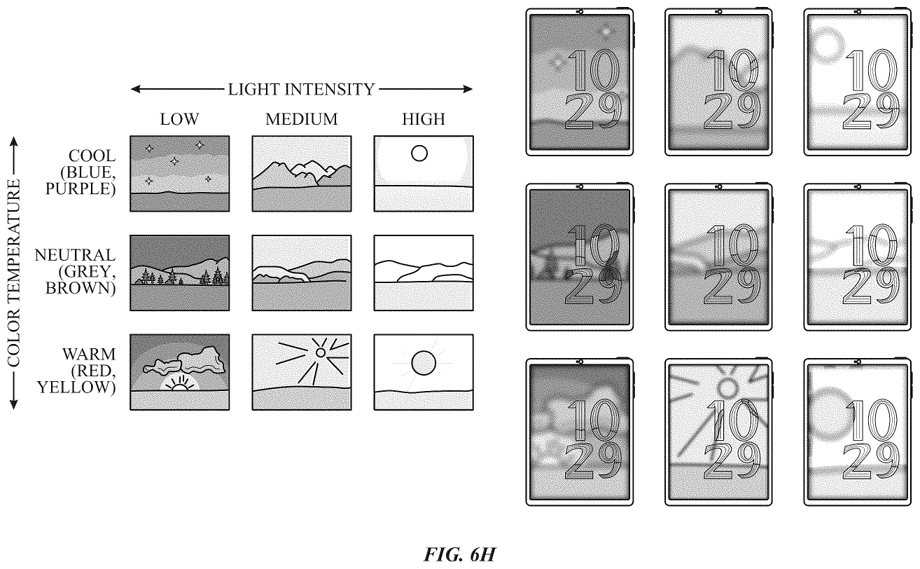

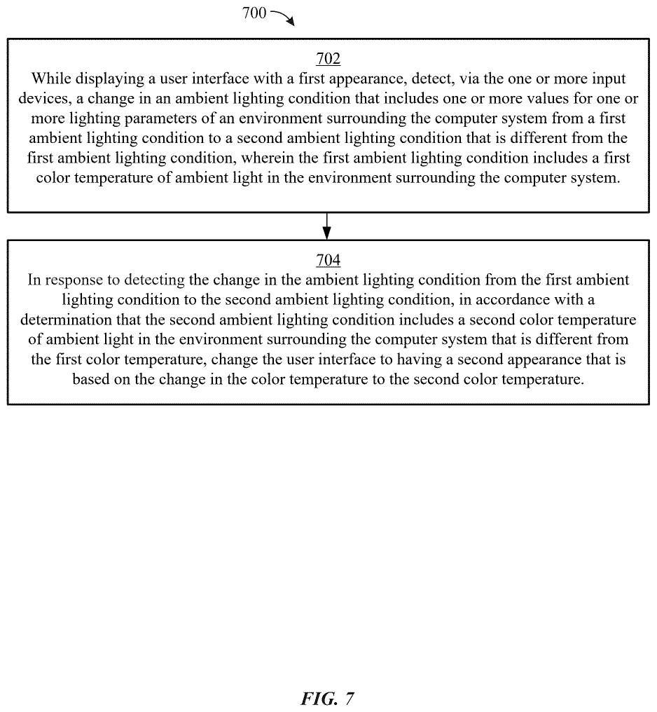

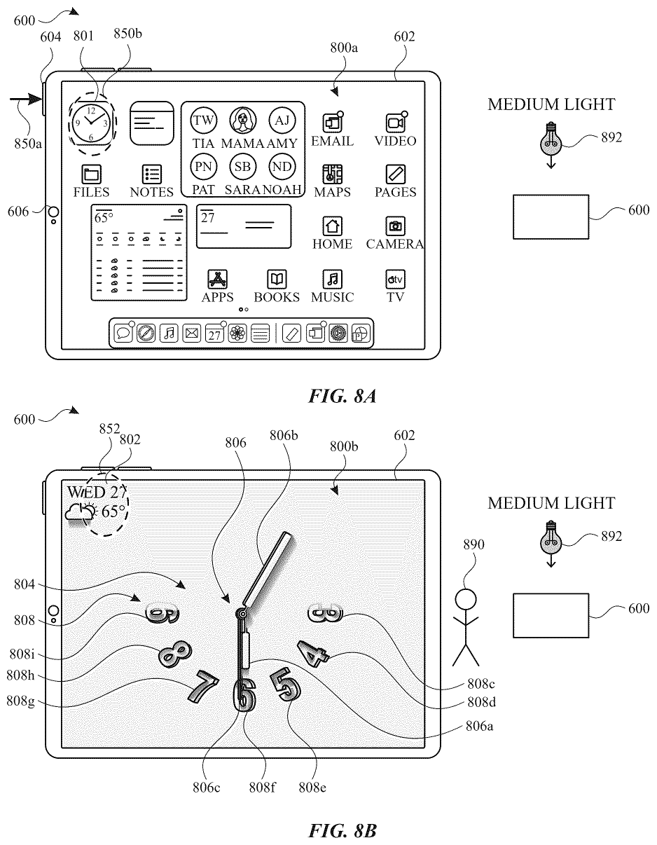

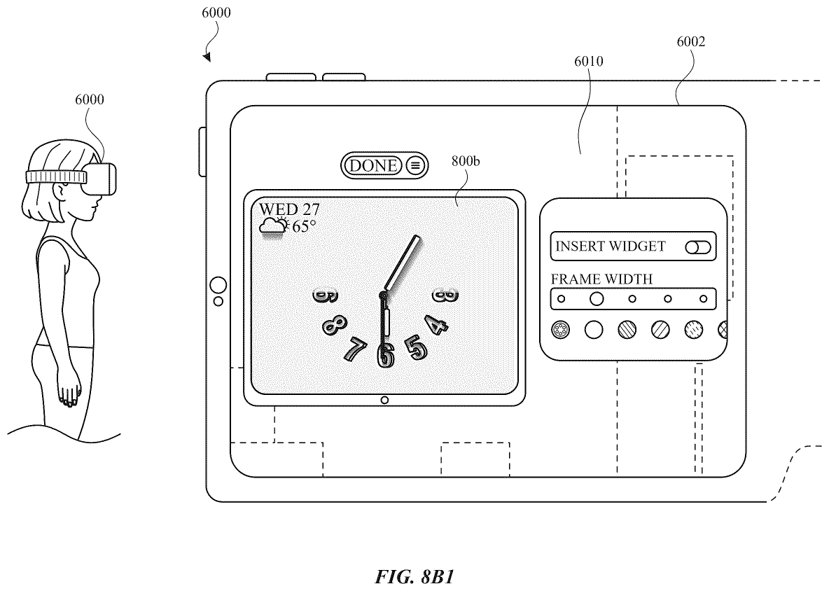

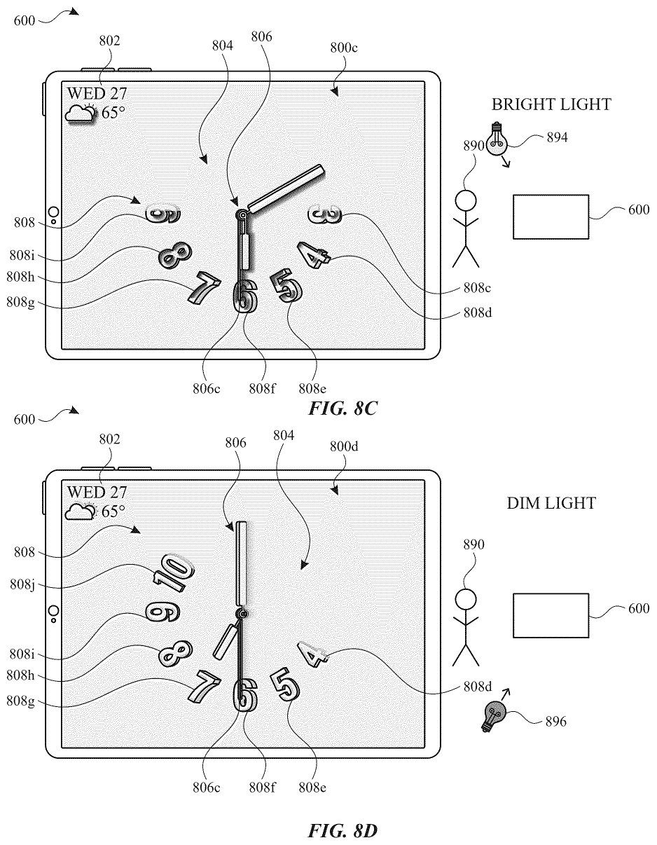

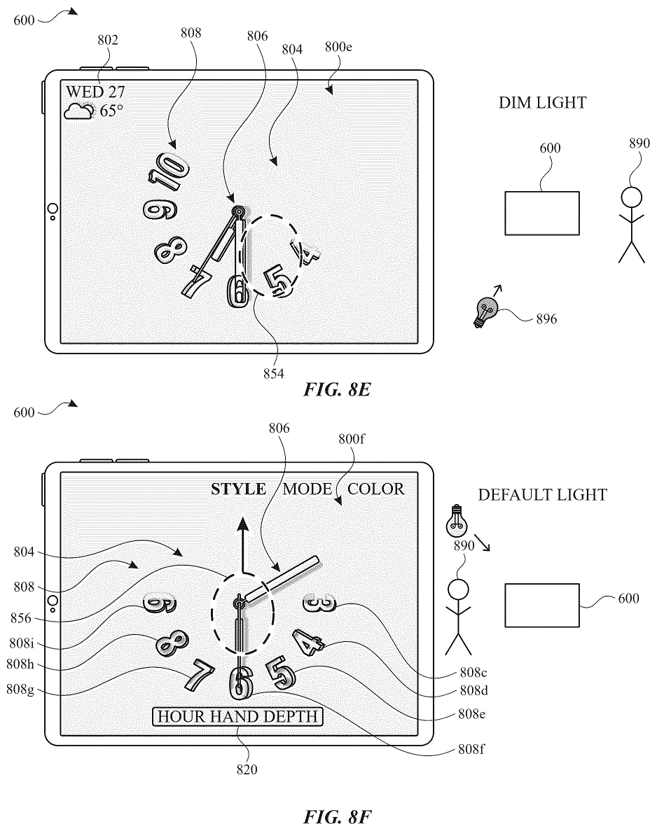

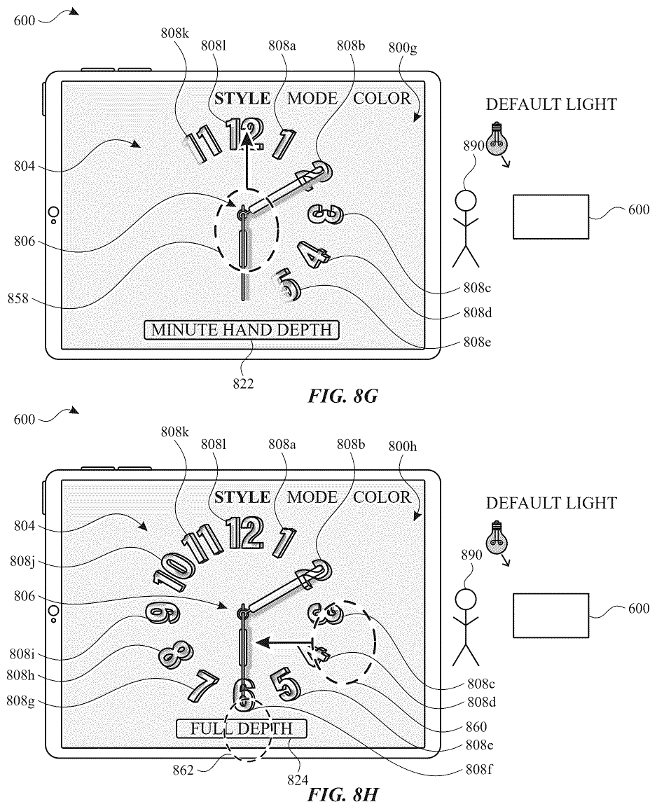

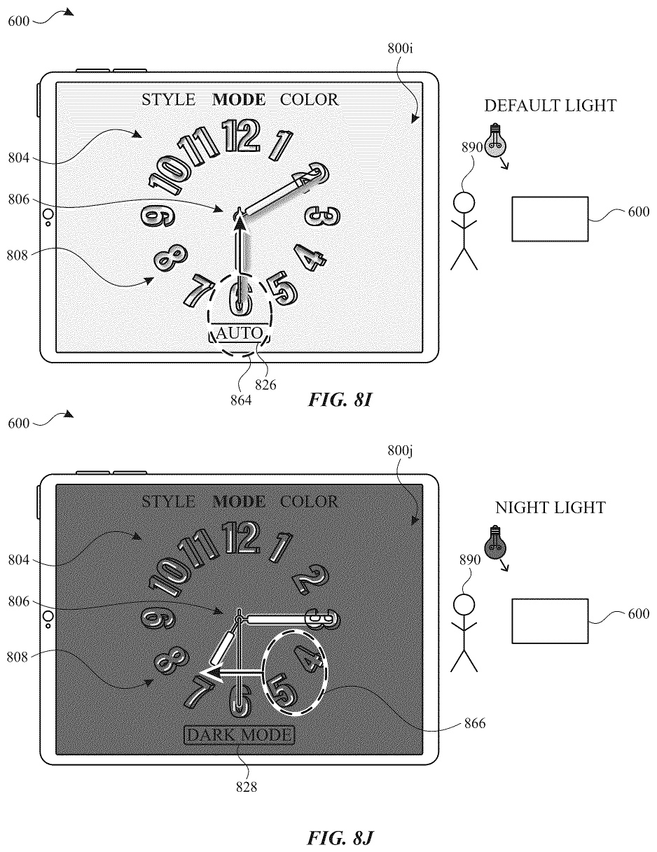

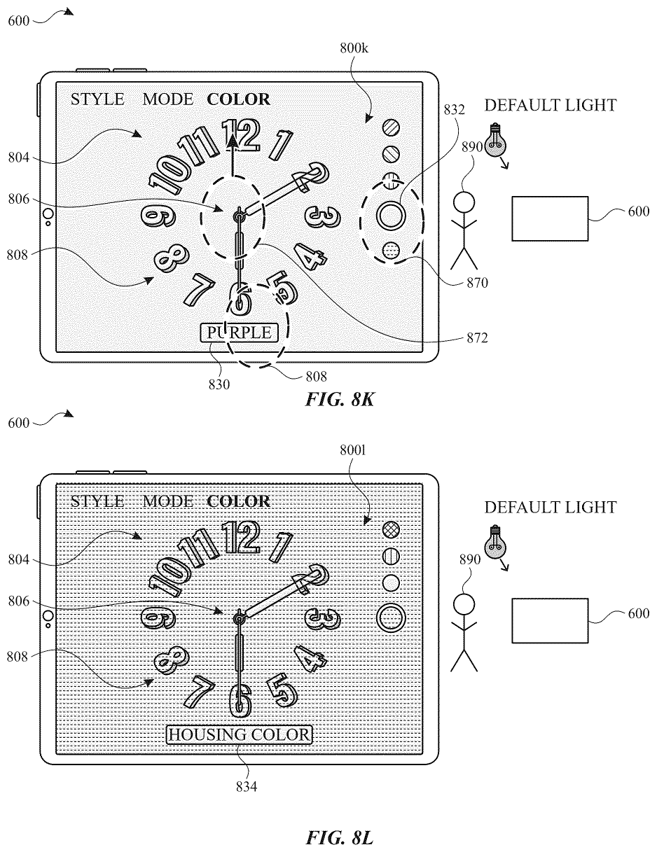

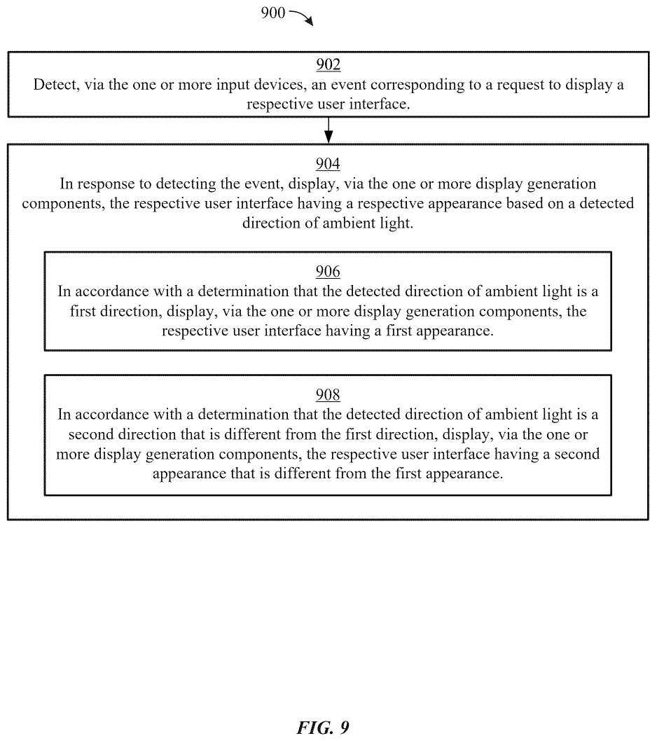

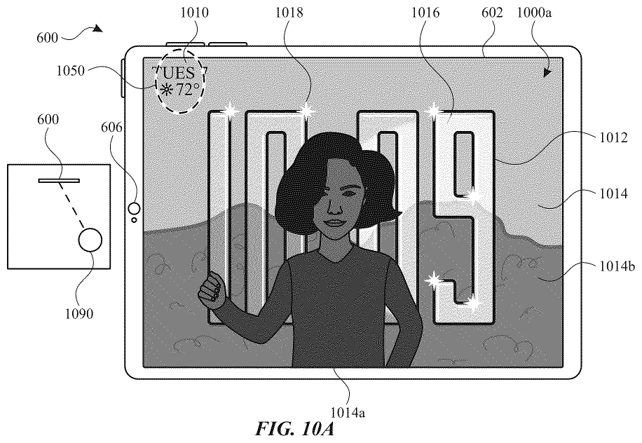

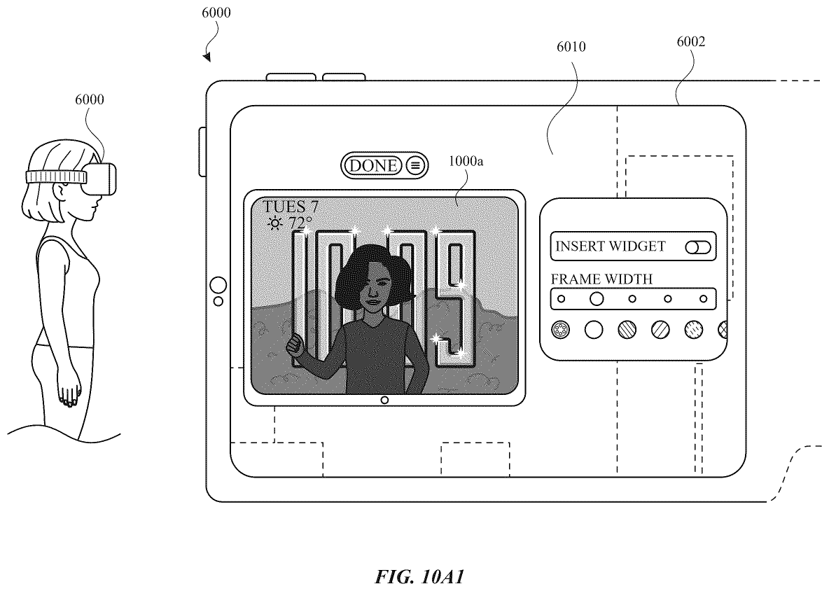

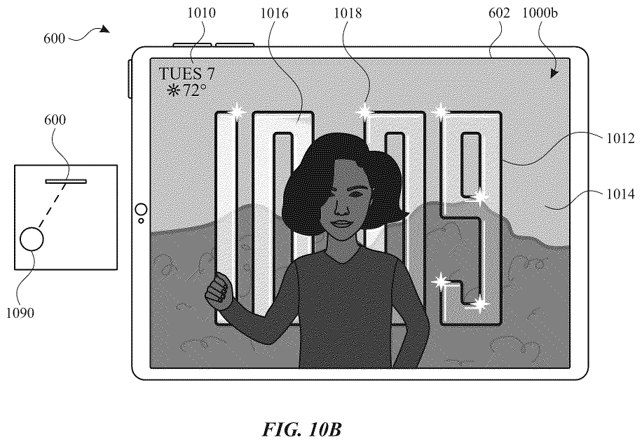

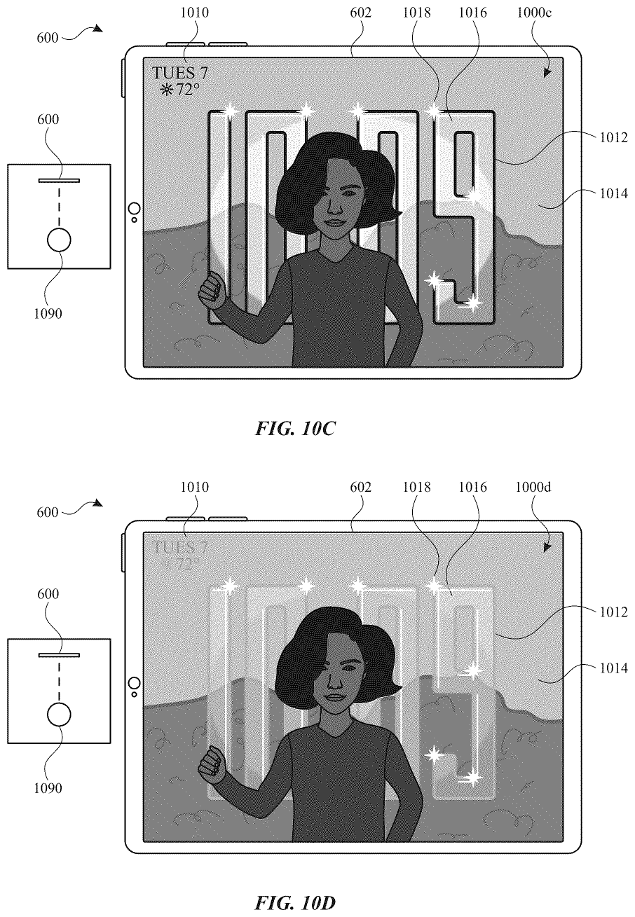

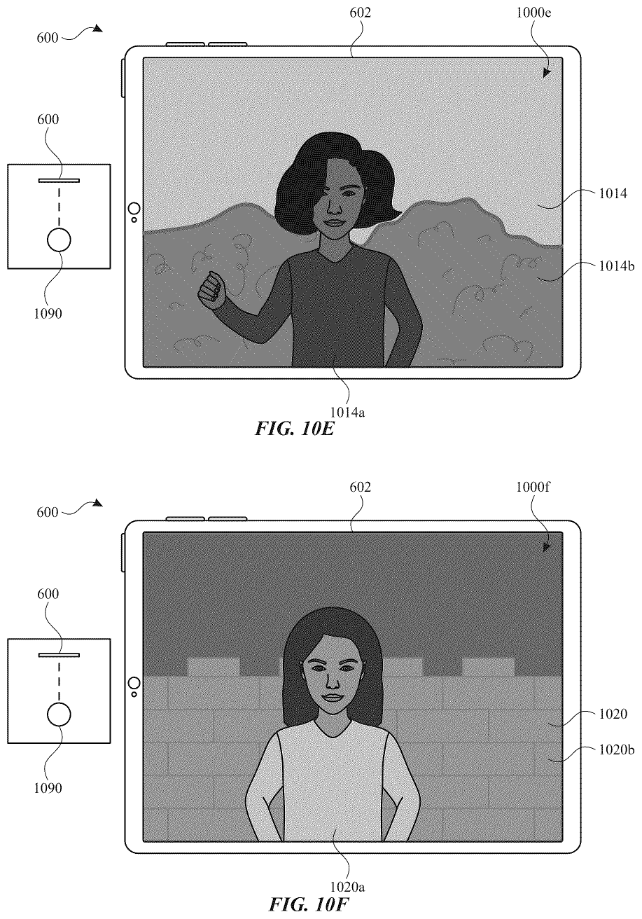

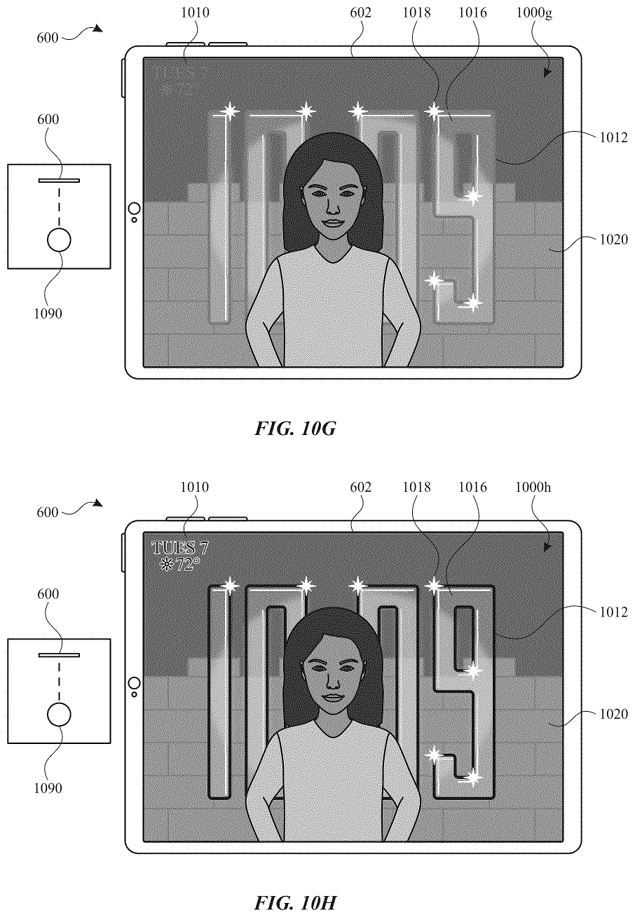

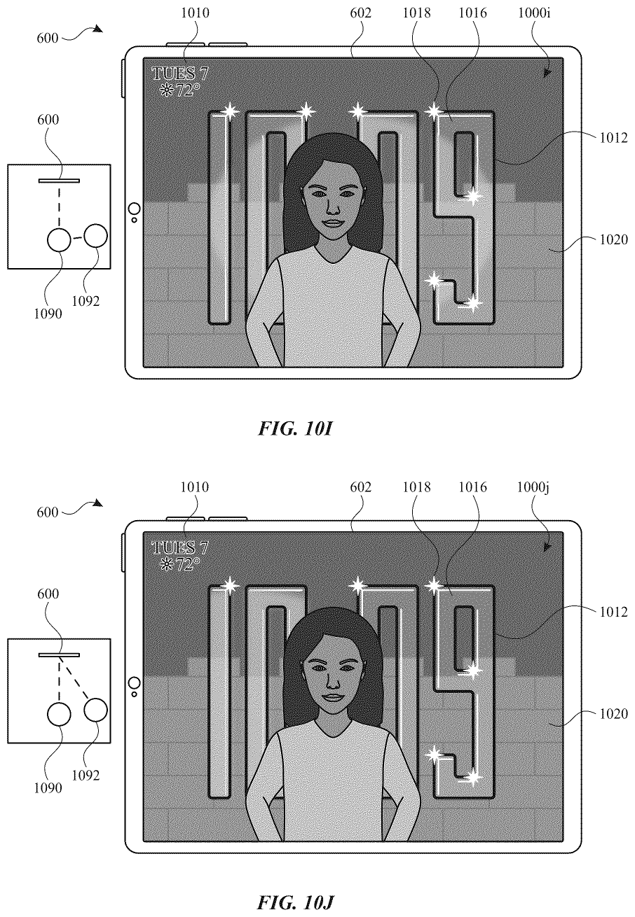

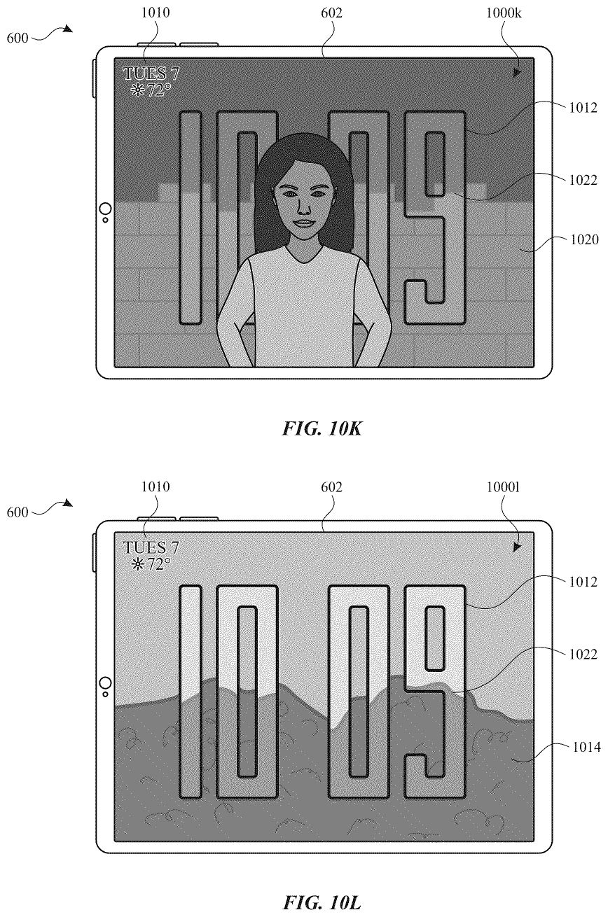

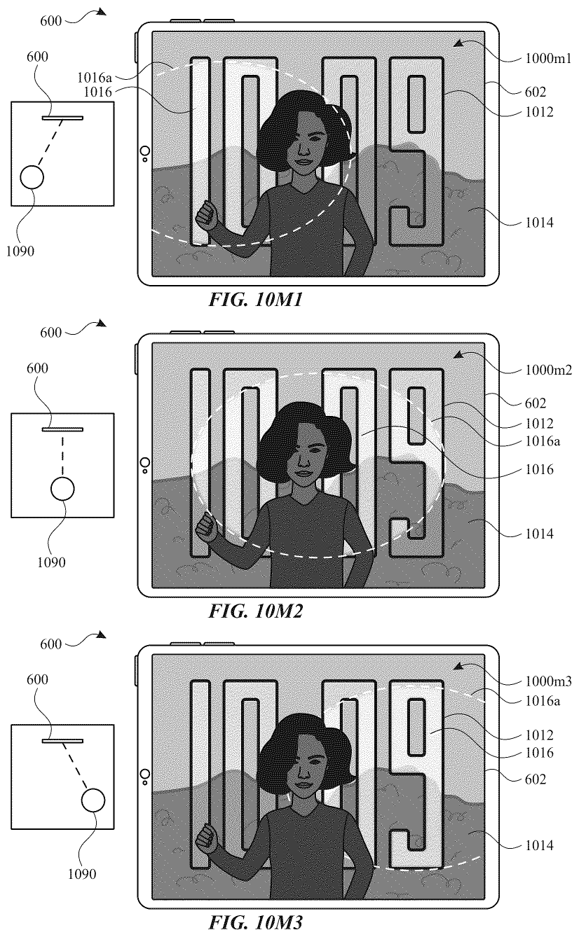

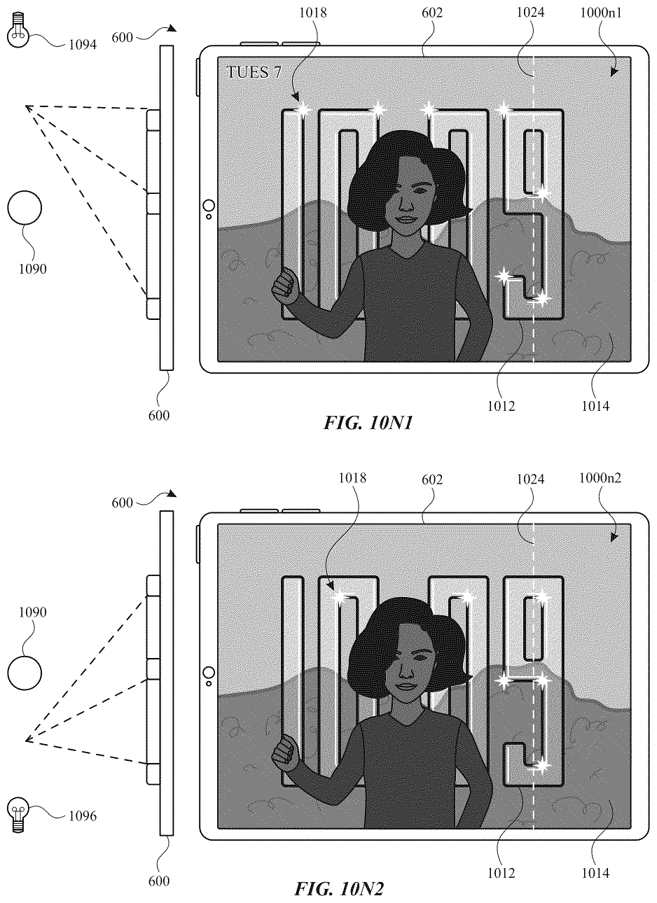

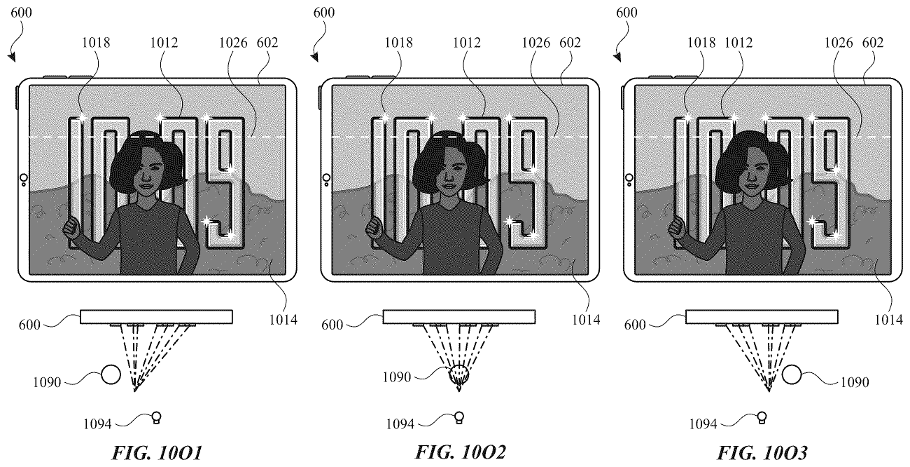

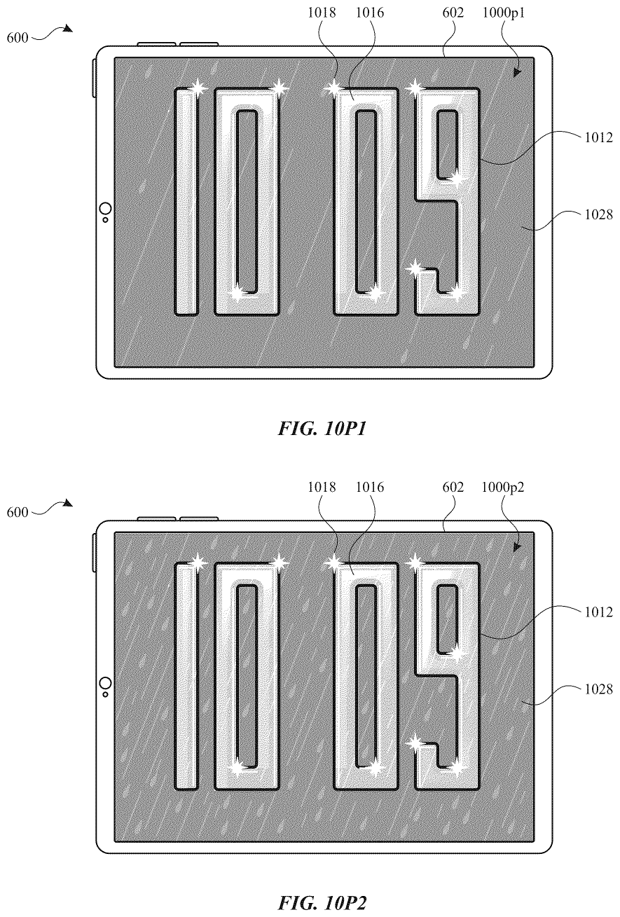

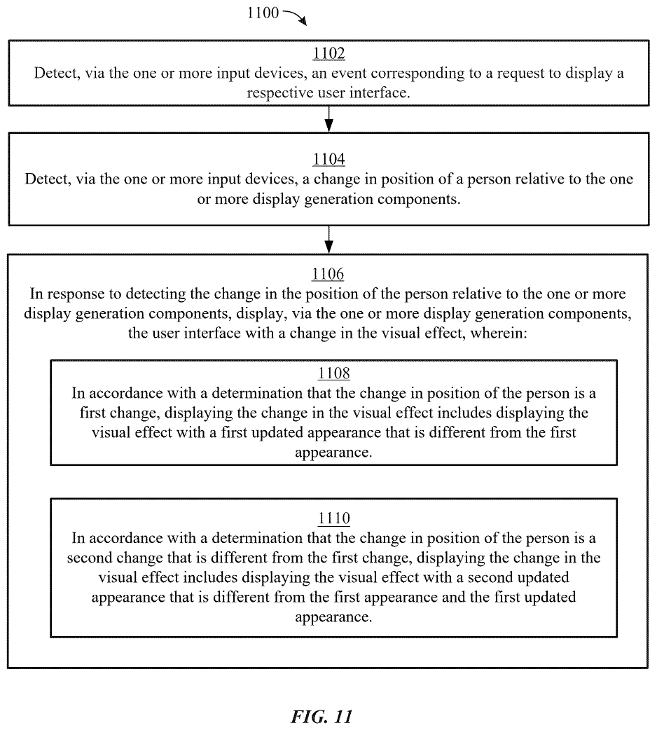

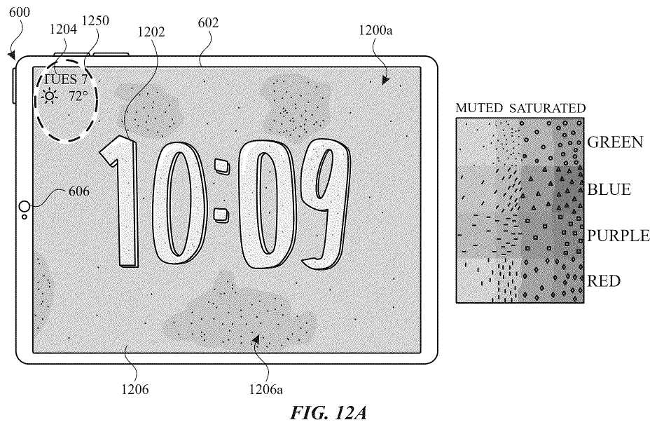

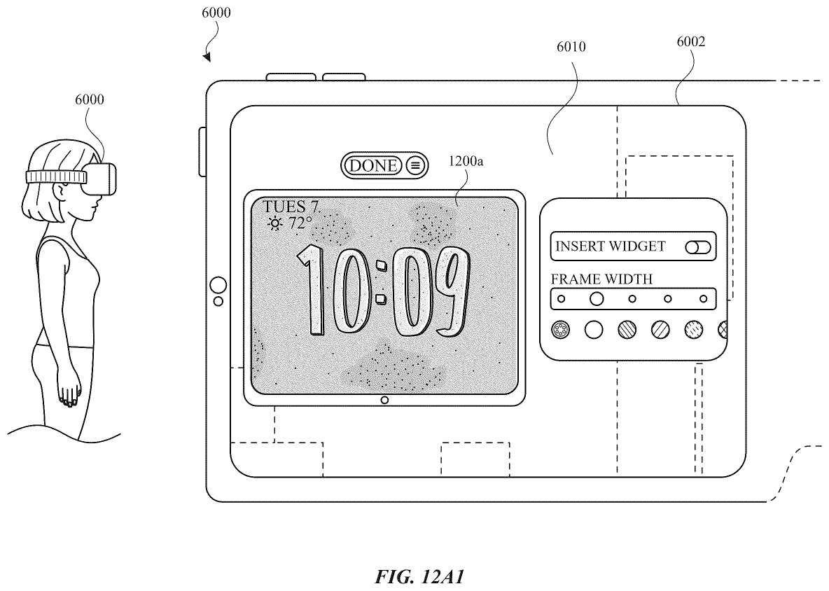

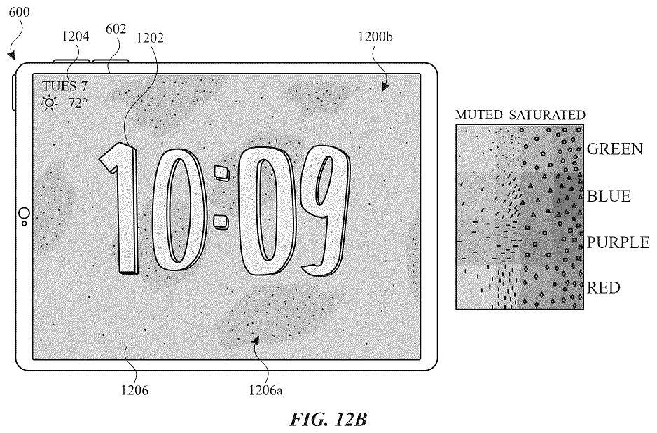

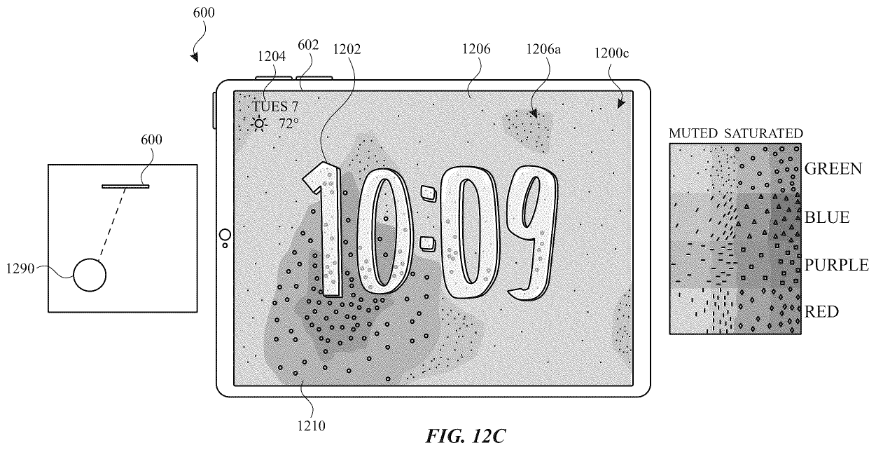

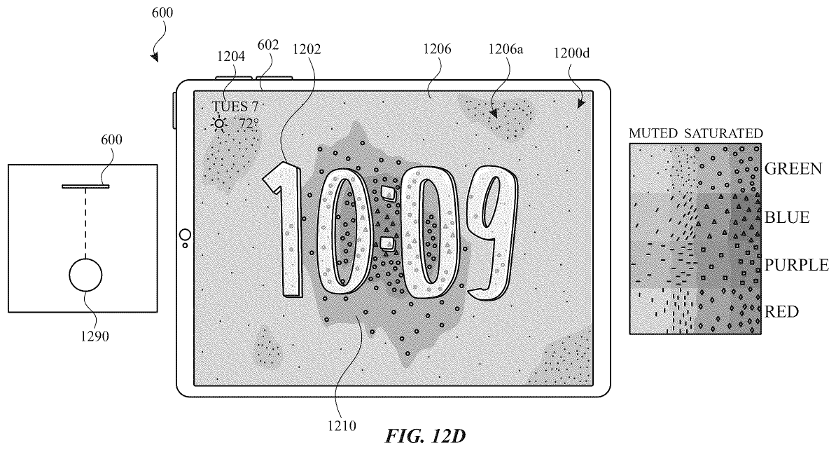

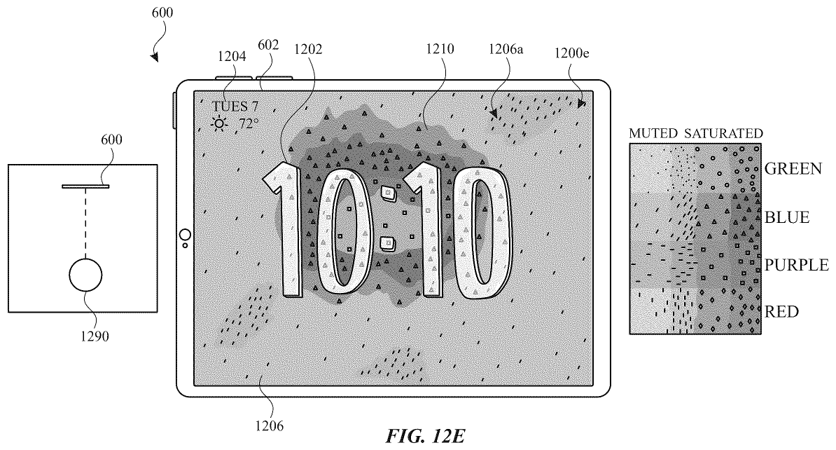

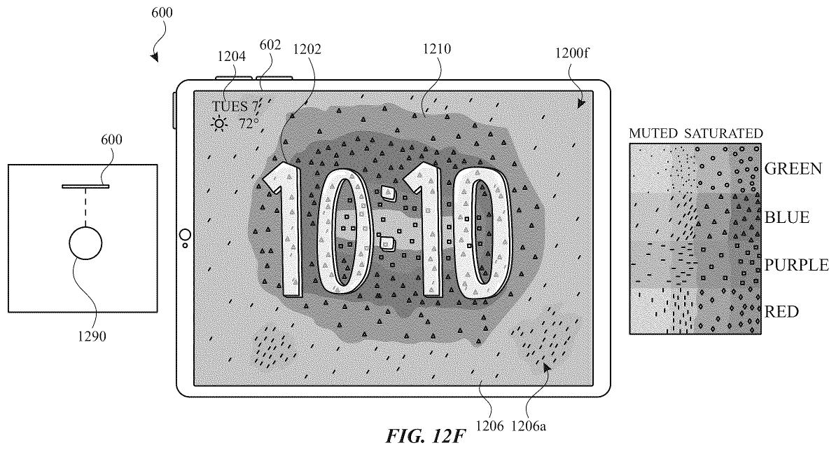

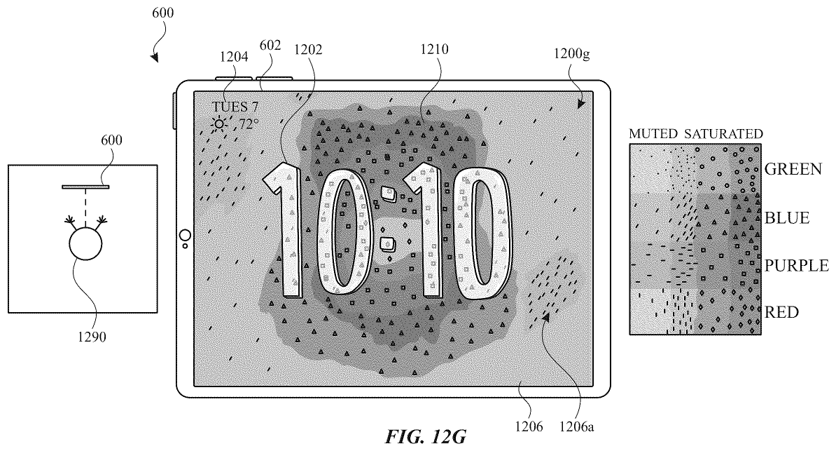

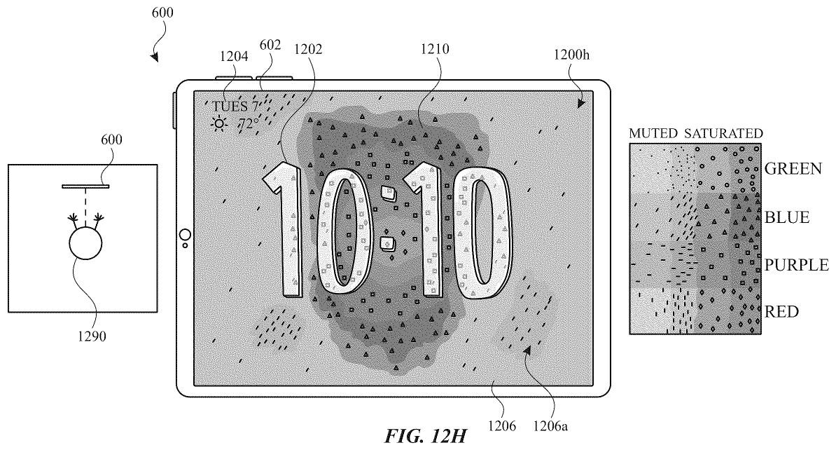

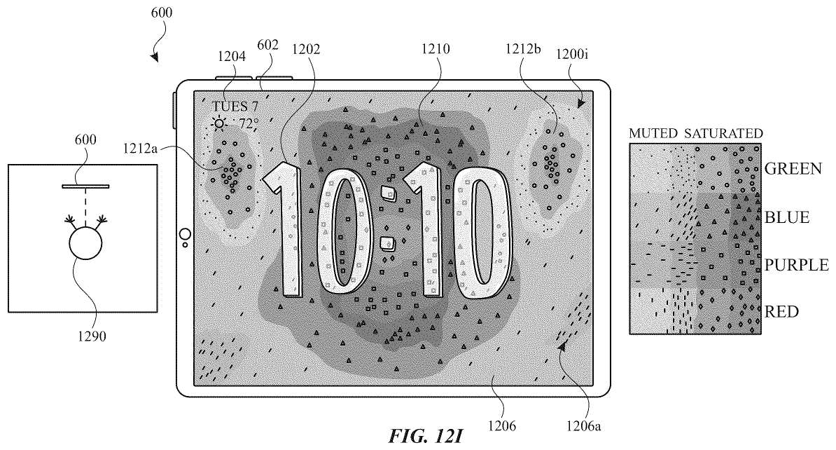

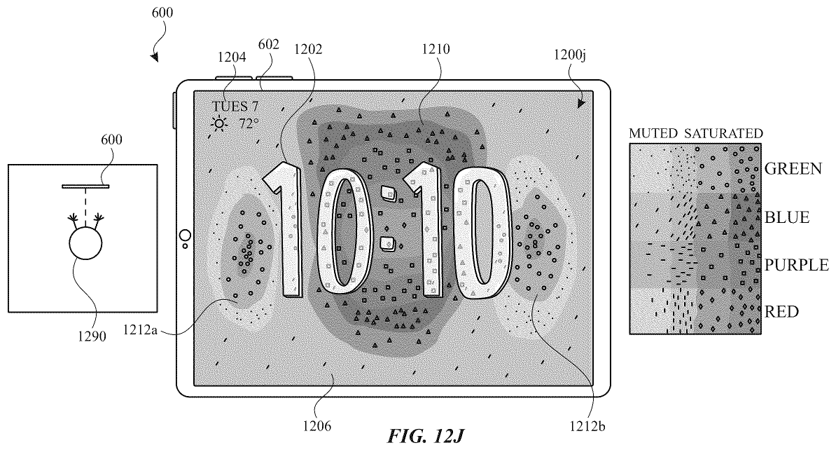

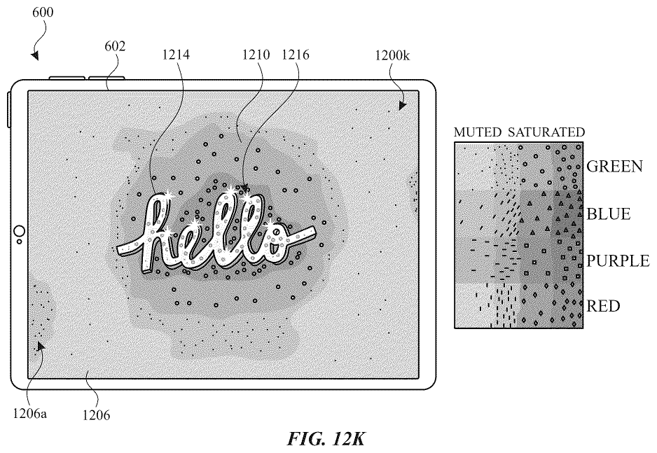

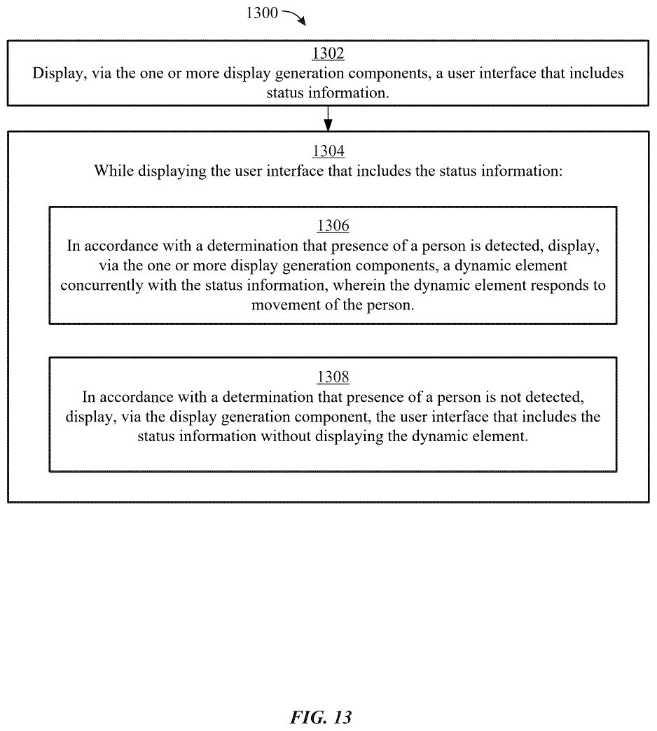

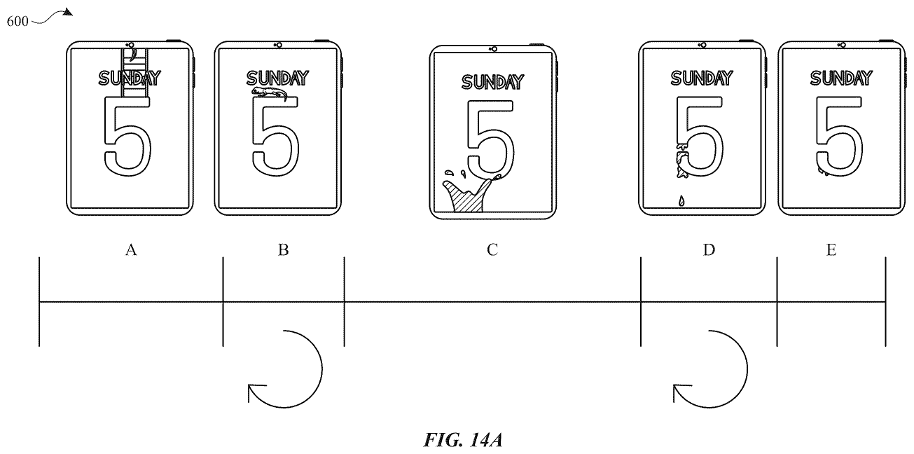

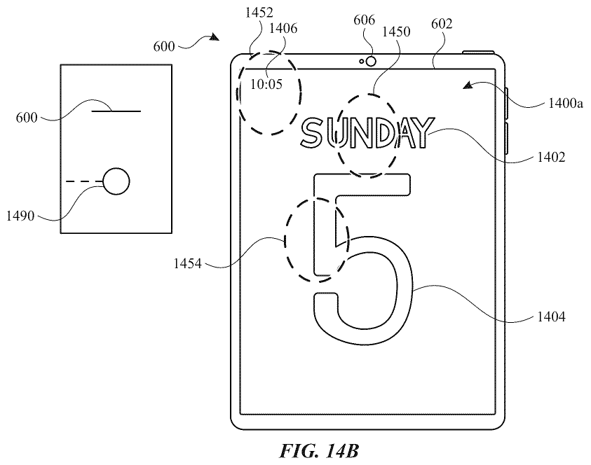

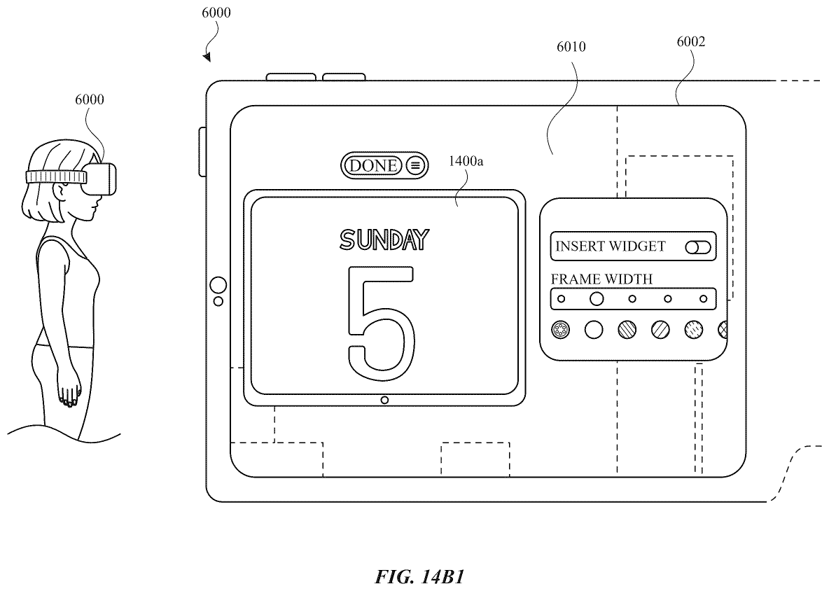

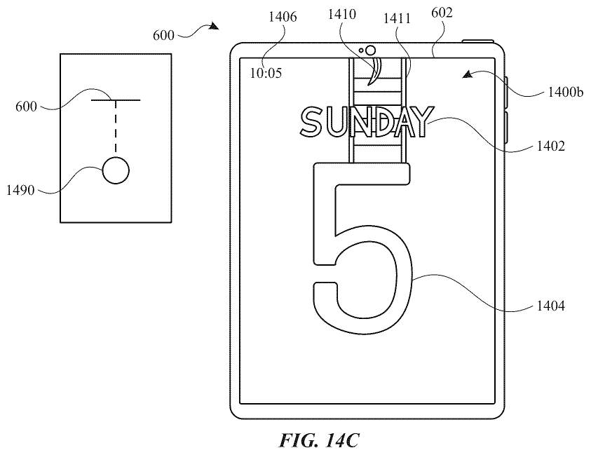

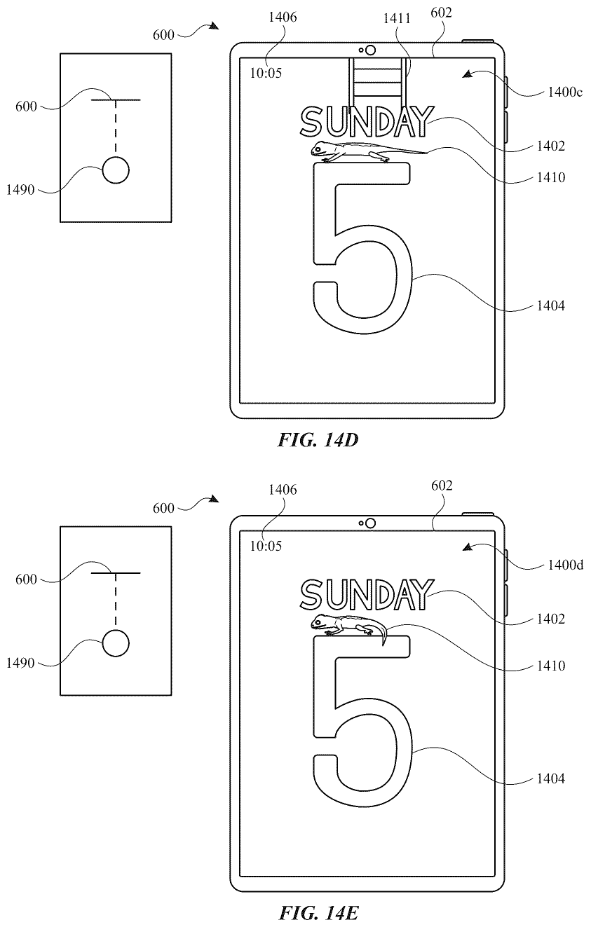

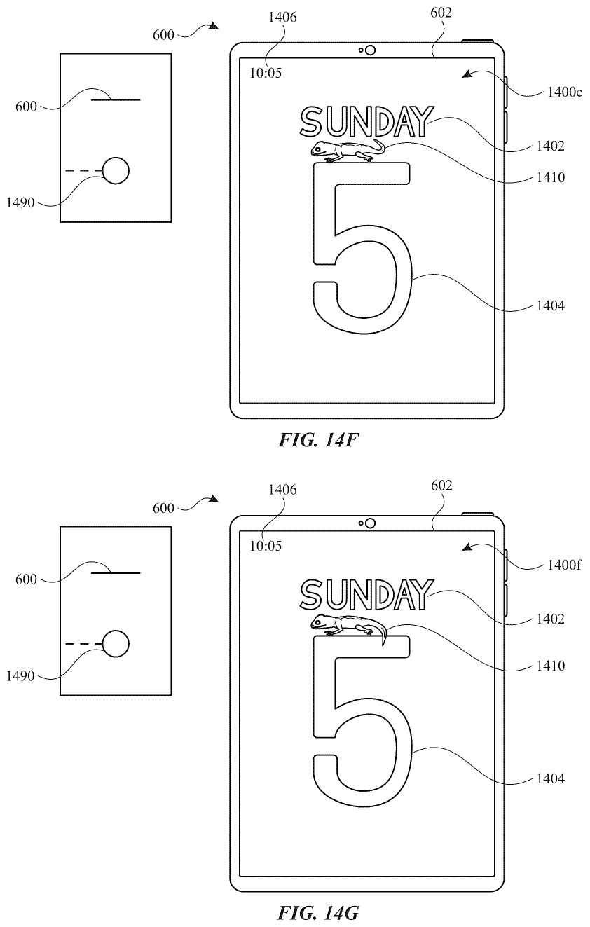

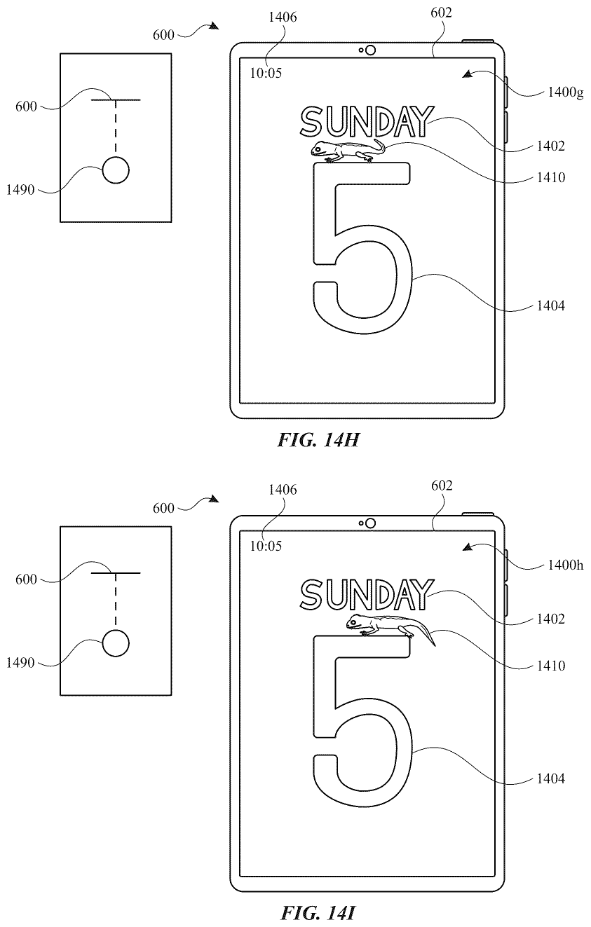

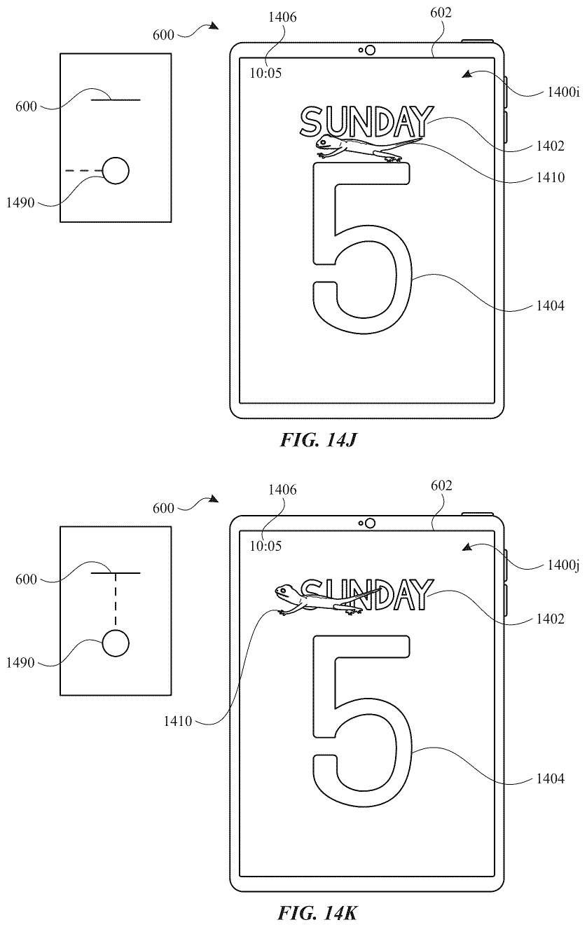

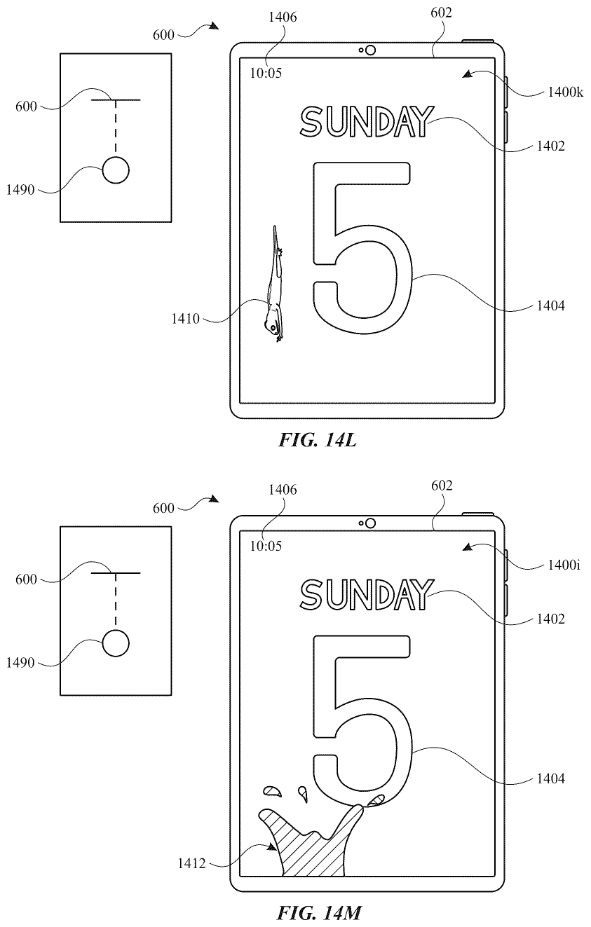

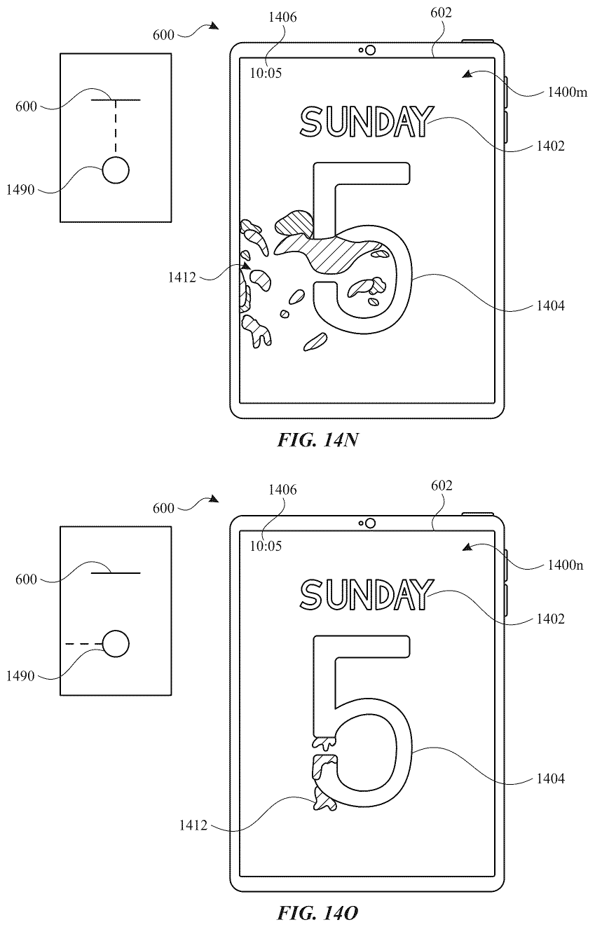

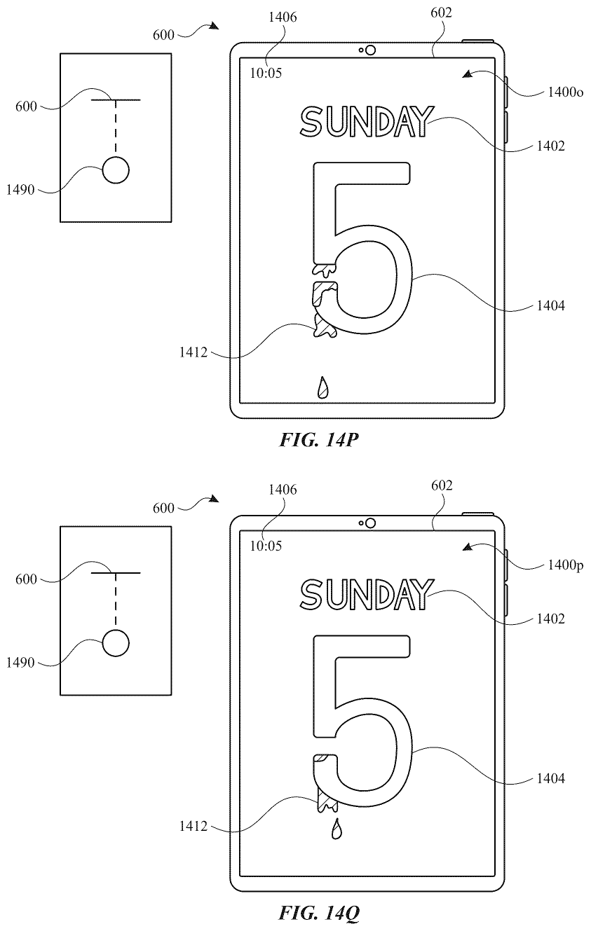

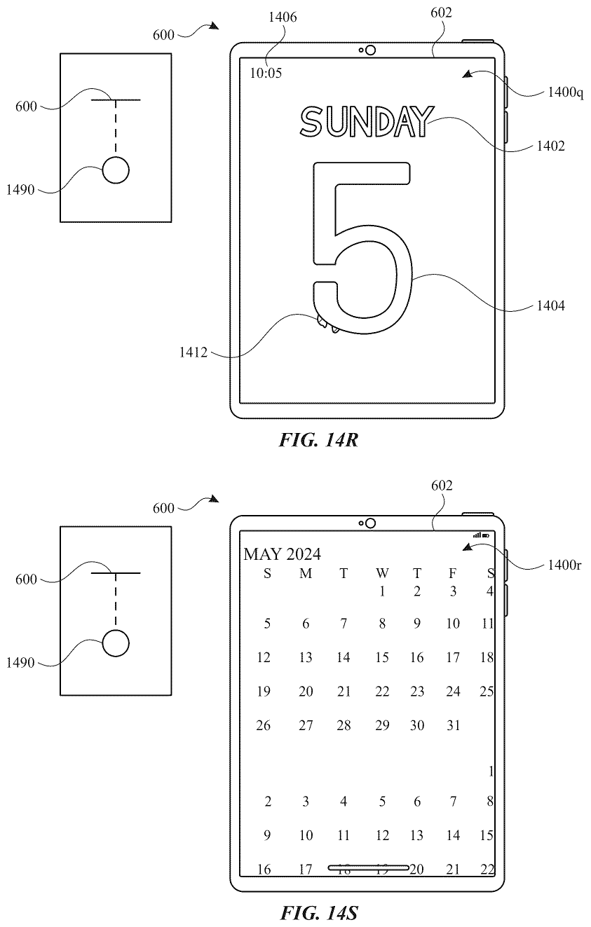

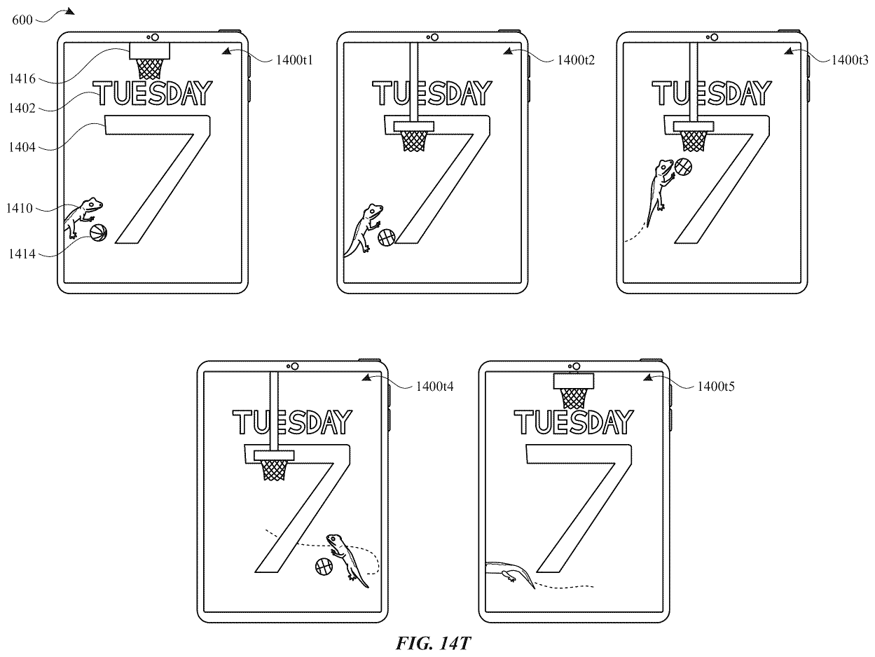

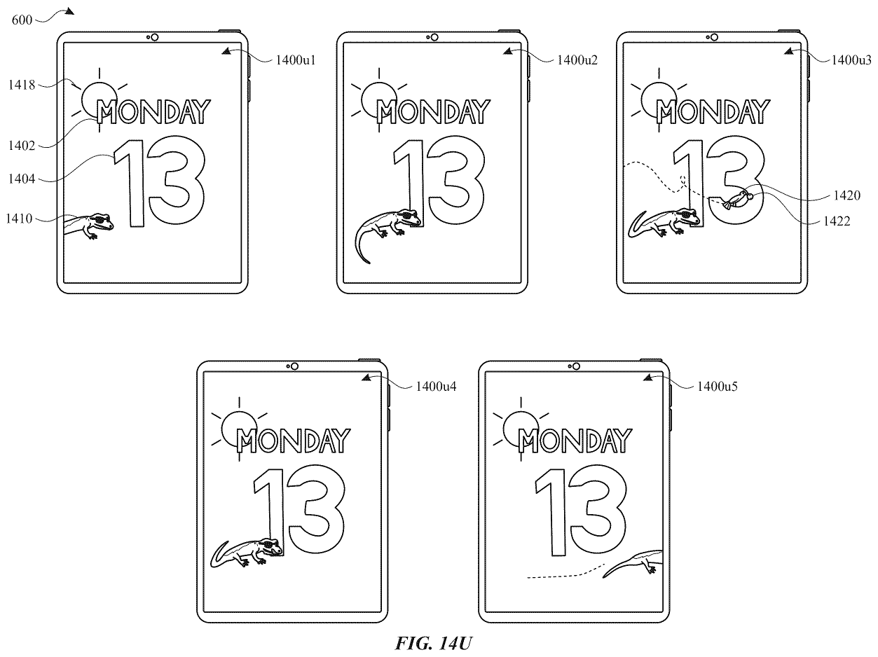

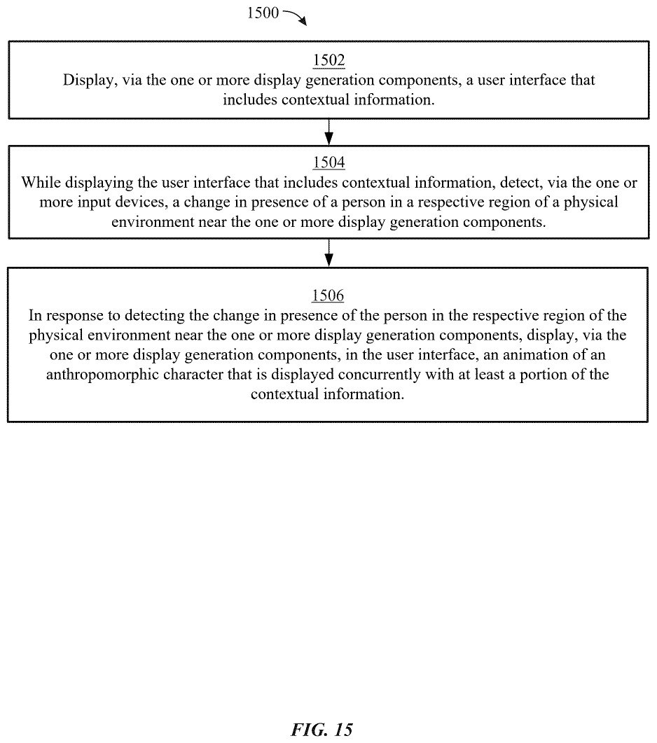

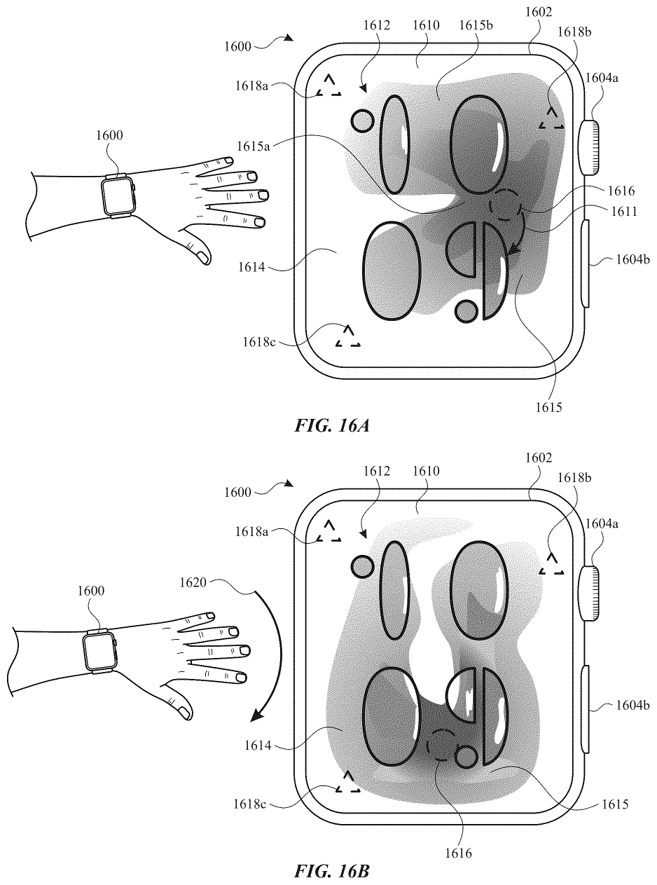

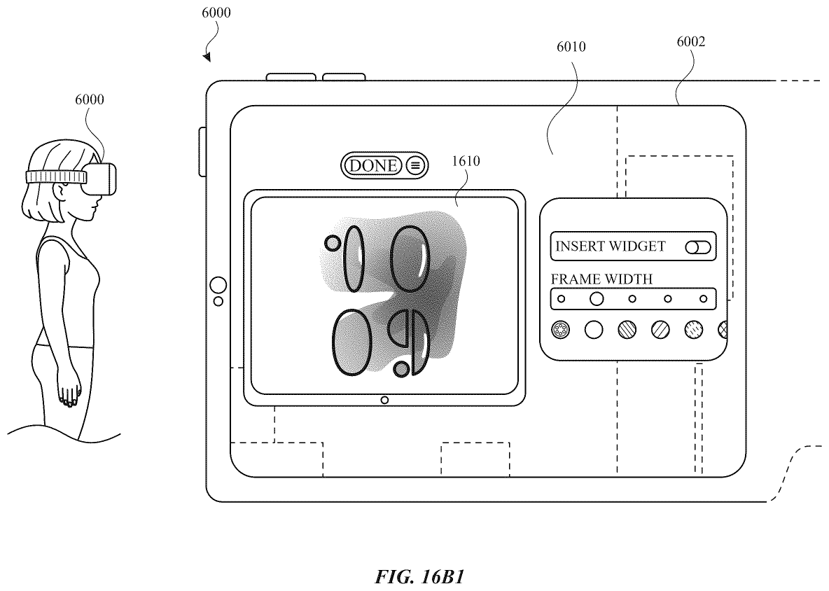

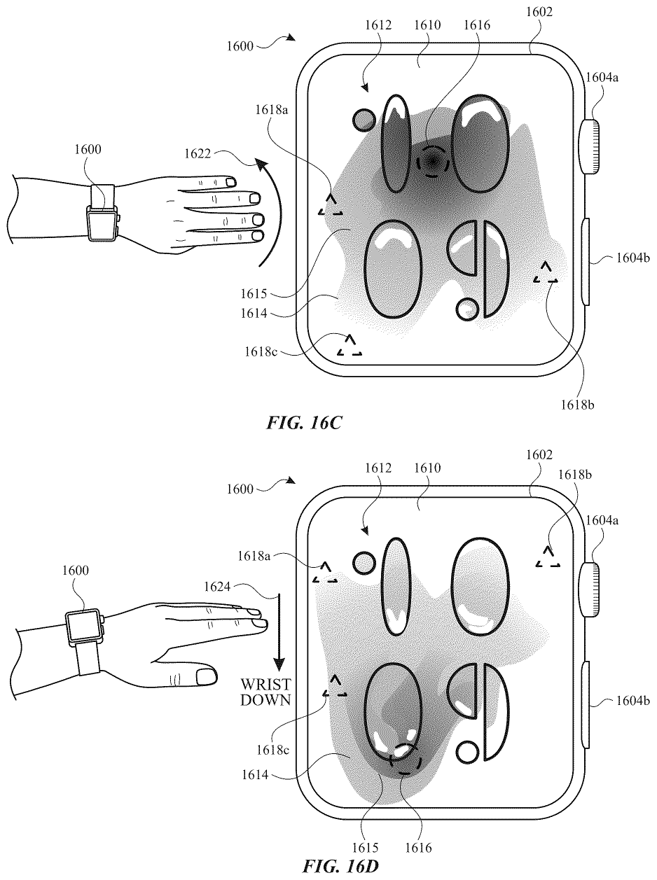

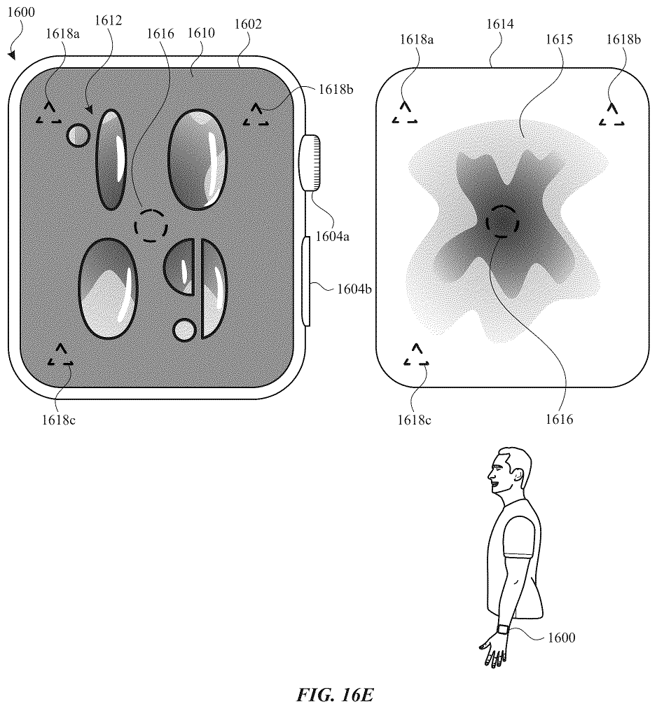

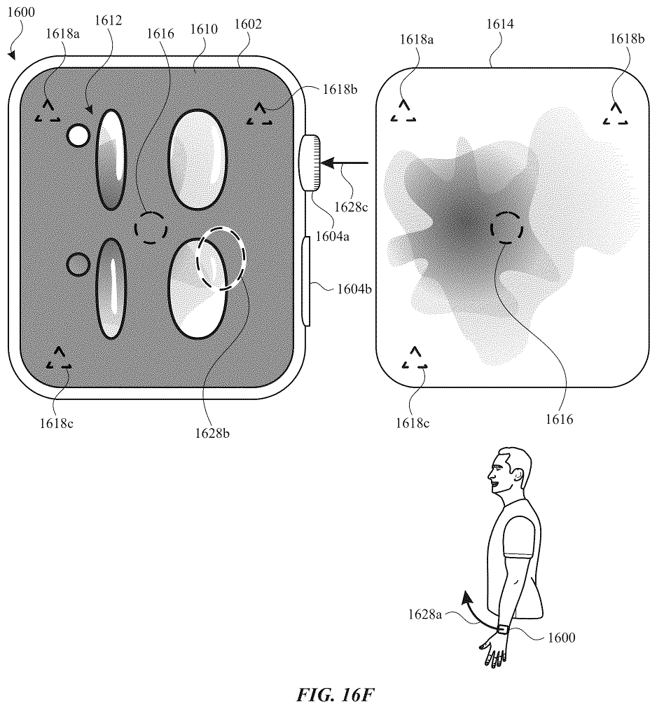

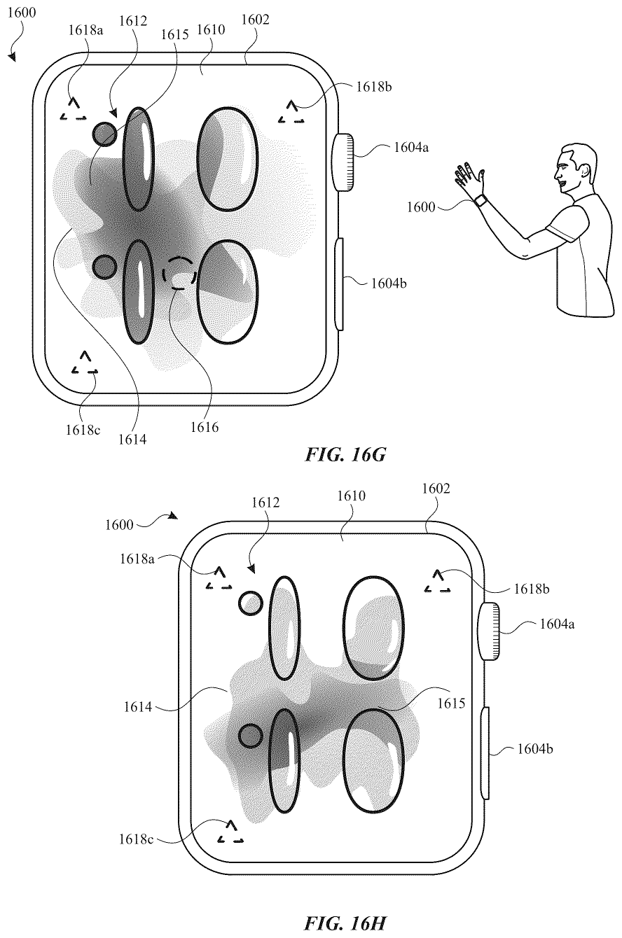

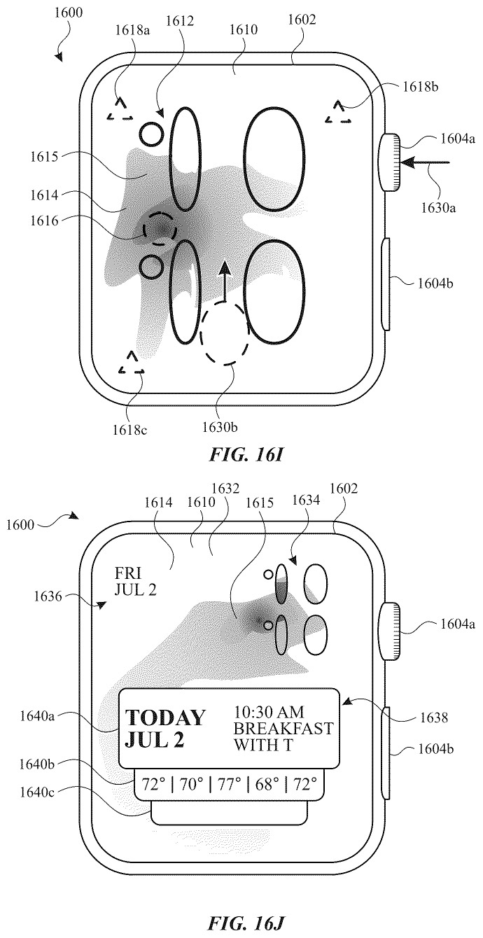

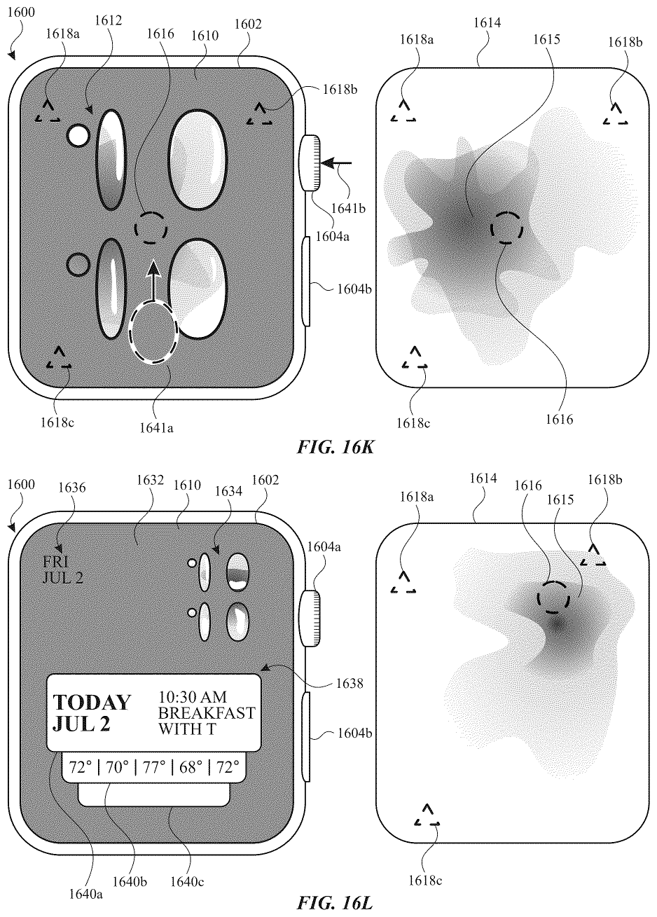

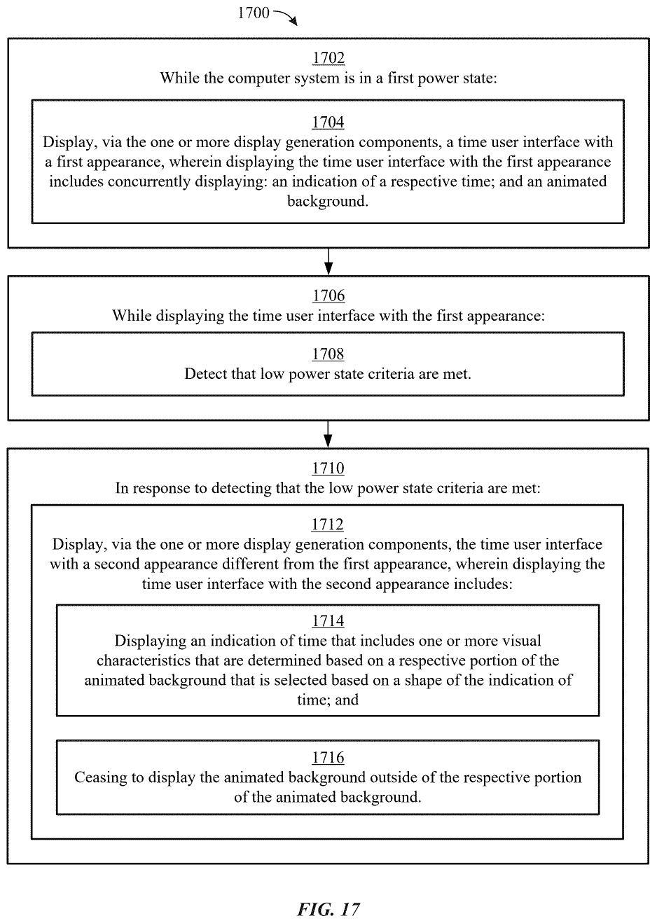

Below, FIGS. 1A-1B, 2, 3A-3G, 4A-4C, and 5A-5B provide a description of exemplary devices for performing the techniques for managing event notifications. FIGS. 6A-6H illustrate exemplary user interfaces based on a color temperature of ambient lighting. FIG. 7 is a flow diagram illustrating methods of displaying a user interface based on a color temperature of ambient lighting in accordance with some embodiments. The user interfaces in FIGS. 6A-6H are used to illustrate the processes described below, including the processes in FIG. 7. FIGS. 8A-8L illustrate exemplary user interfaces based on lighting angle using a computer system. FIG. 9 is a flow diagram illustrating methods of displaying user interfaces based on lighting angle using a computer system in accordance with some embodiments. The user interfaces in FIGS. 8A-8L are used to illustrate the processes described below, including the processes in FIG. 9. FIGS. 10A-10P2 illustrate exemplary user interfaces based on a position of a user using a computer system. FIG. 11 is a flow diagram illustrating methods of displaying a user interface based on a position of a user using a computer system in accordance with some embodiments. The user interfaces in FIGS. 10A-10P2 are used to illustrate the processes described below, including the processes in FIG. 11. FIGS. 12A-12K illustrate exemplary user interfaces based on the presence of a user using a computer system. FIG. 13 is a flow diagram illustrating methods of displaying user interfaces based on the presence of a user using a computer system in accordance with some embodiments. The user interfaces in FIGS. 12A-12K are used to illustrate the processes described below, including the processes in FIG. 13. FIGS. 14A-14U illustrate exemplary user interfaces based on the presence of a user using a computer system. FIG. 15 is a flow diagram illustrating methods of displaying a user interface based on the presence of a user using a computer system in accordance with some embodiments. The user interfaces in FIGS. 14A-14U are used to illustrate the processes described below, including the processes in FIG. 15. FIGS. 16A-16L illustrate exemplary user interfaces for displaying a time user interface in accordance with some embodiments. FIG. 17 is a flow diagram illustrating methods of displaying a time user interface in accordance with some embodiments. The user interfaces in FIGS. 16A-16L are used to illustrate the processes described below, including the processes in FIG. 17.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.1 in, and/or IEEE 802.1 lac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

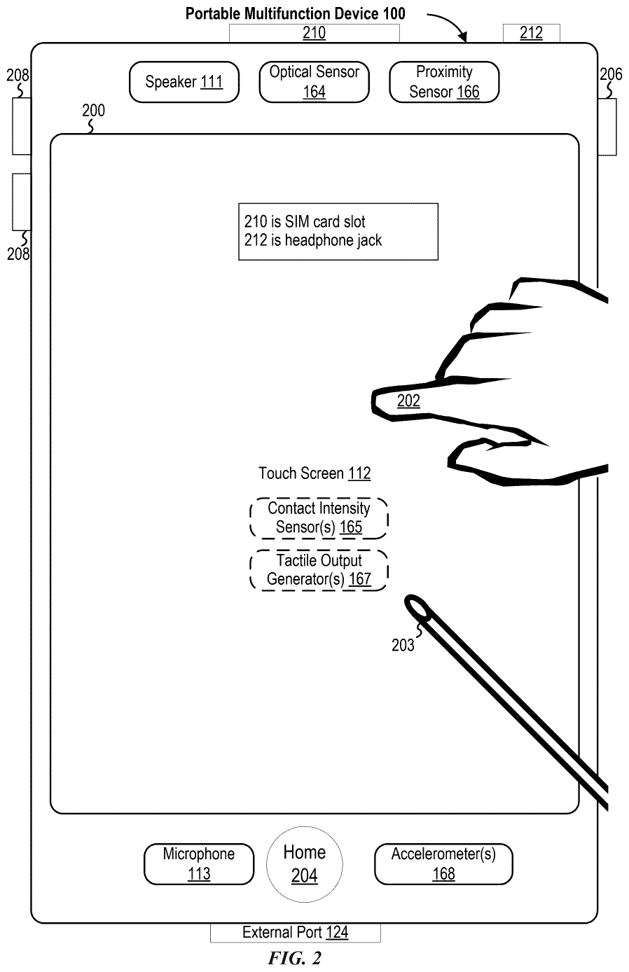

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

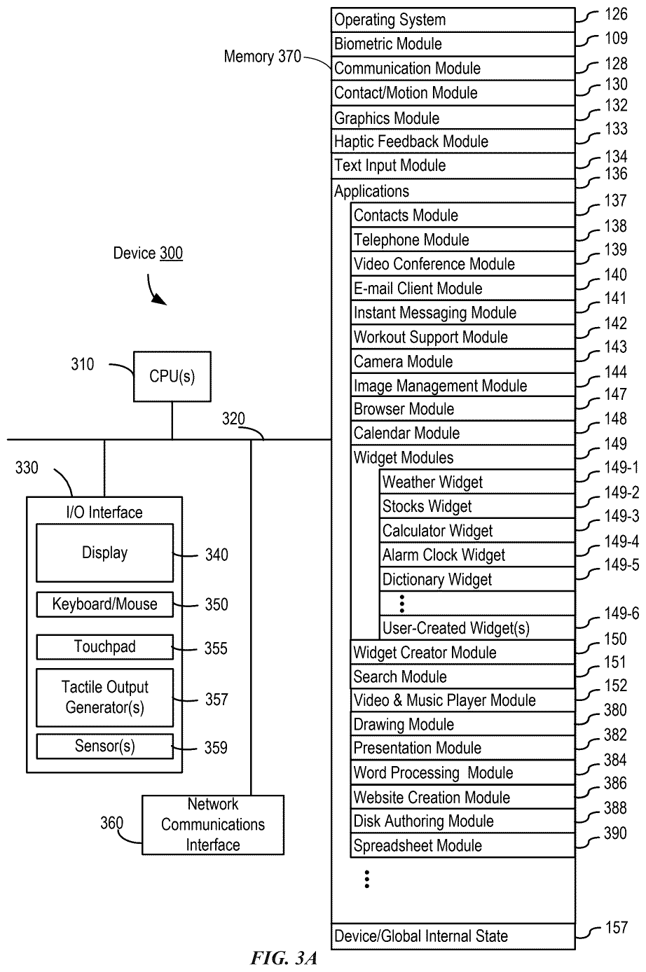

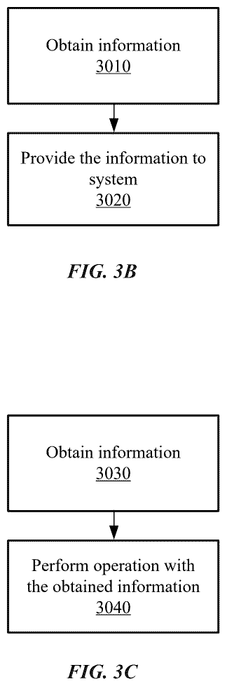

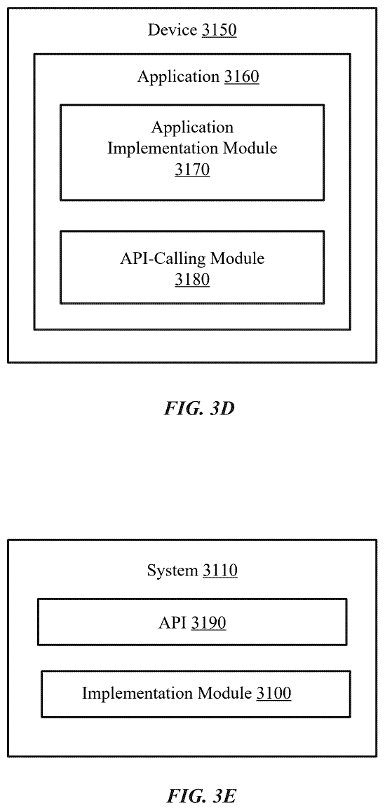

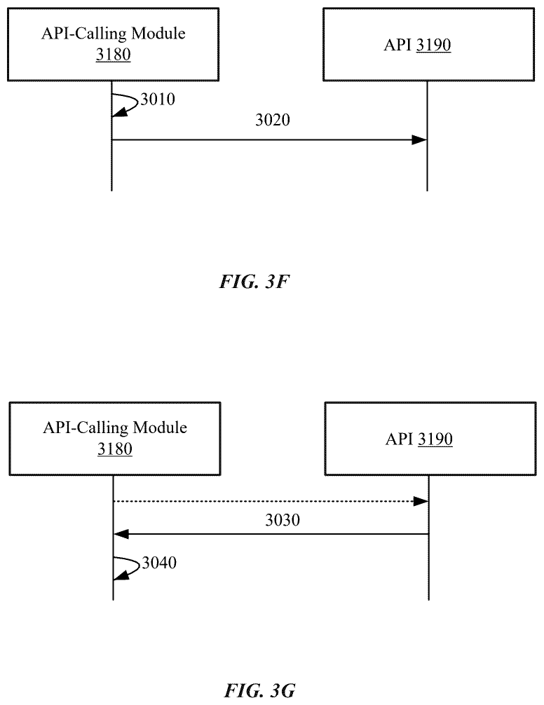

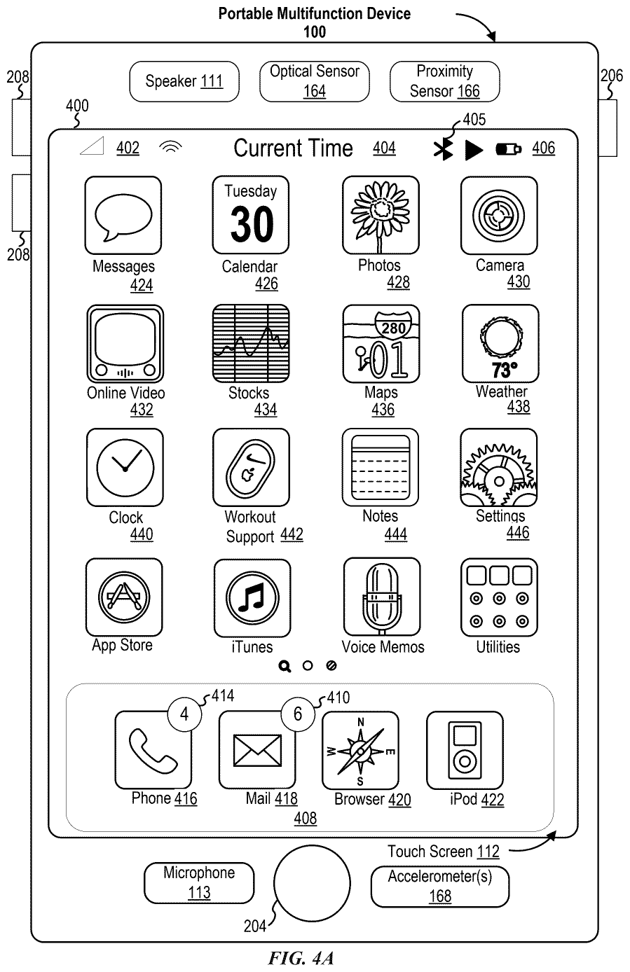

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, 1100, 1300, 1500, and/or 1700 (FIGS. 7, 9, 11, 13, 15, and/or 17) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

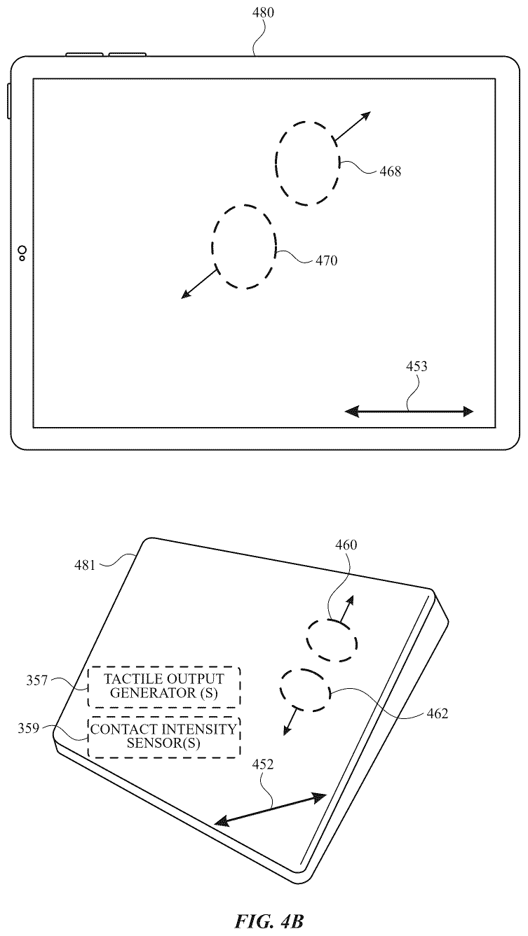

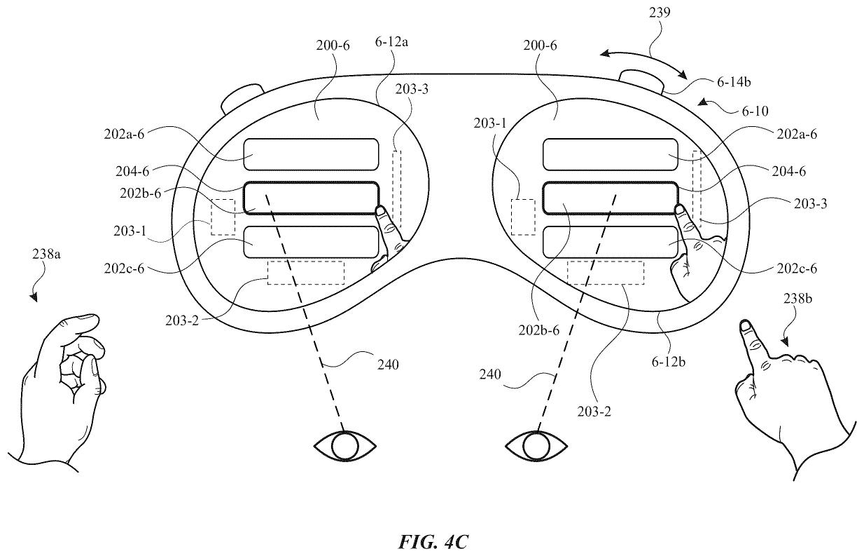

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 481 (e.g., a tablet or touchpad 355, FIG. 3A) that is separate from the display 480 (e.g., touch screen display 112). Device 300 also, optionally, includes one or more contact intensity sensors (e.g., one or more of sensors 359) for detecting intensity of contacts on touch-sensitive surface 481 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 481 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 481 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 481 in FIG. 4B) are used by the device to manipulate the user interface on the display (e.g., 480 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 4C depicts computer system 6-10, which is a head-mounted device (HMD). In FIG. 4C, computer system 6-10 displays user interface 200-6 via display generation component 6-12a and display generation component 6-12b. User interface 200-6 includes three user interface objects 202a-6, 202b-6, and 202c-6 and one or more elements 203-1, 203-2, 203-3 representing a physical environment of the user (e.g., visible via virtual passthrough or optical passthrough). When an input is detected (e.g., a selection input, a movement input, a long selection input, a multiple selection input, and/or other type of input), attention of a user can be used to determine which of the user interface objects the input was directed toward. For an HMD 6-10, attention can be determined based on a location of an air gesture (e.g., a location of a finger 238b or air pinch 238a), a direction of gaze 240, and/or a location of a selection indicator (e.g., 204-6) which is, optionally, adjusted based on a location or direction of an air gesture and/or interaction with an input device such as a button (e.g., a button on a keyboard, a button on a mouse, a button on a controller such as a spatial controller) or a rotatable input element (e.g., a mouse wheel or dial).

In some embodiments, a gesture includes an “air gesture.” An air gesture is a gesture that is detected without the user touching (or independently of) an input element that is part of a device (e.g., device 100 and/or device 300) and is based on detected motion of a portion (e.g., the head, one or more arms, one or more hands, one or more fingers, and/or one or more legs) of the user's body through the air, including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, user inputs and/or input gestures used in the various examples and embodiments described herein include air gestures performed by movement of the user's finger(s) relative to other finger(s) or part(s) of the user's hand(s) for interacting with an extended reality (XR) environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air, including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., based on gaze) to determine the target of the user input (e.g., for direct inputs, as described below). Thus, in implementations involving air gestures, the input gesture is, for example, detected attention (e.g., based on gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., based on gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed reality environment, in accordance with some embodiments. For example, the pinch inputs and tap inputs described below are performed as air gestures. In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second) before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments, the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, the detection of a “ready state” configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units, and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements; one or more pressure-sensitive input elements; one or more buttons; one or more knobs; one or more dials; one or more joysticks; one or more hand or finger coverings that can detect a position or change in position of portions of a hand and/or fingers relative to each other, relative to the user's body, and/or relative to a physical environment of the user; and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

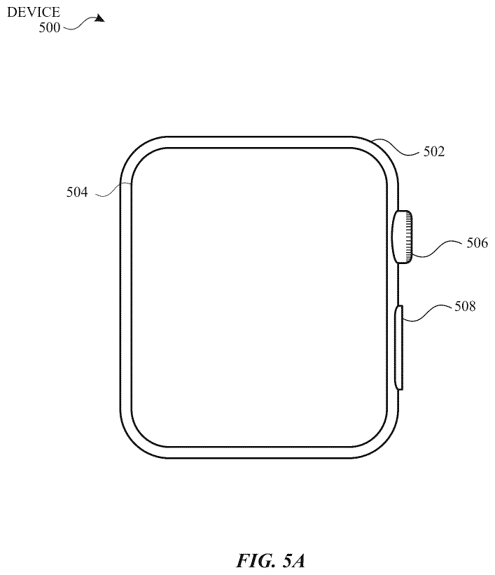

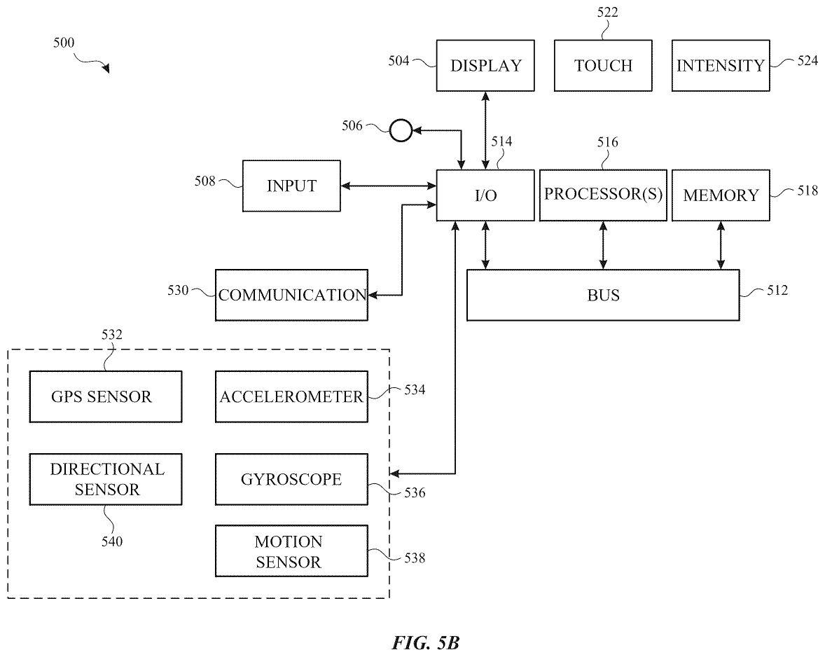

FIG. 5A illustrates exemplary personal electronic device 500. Device 500 includes body 502. In some embodiments, device 500 can include some or all of the features described with respect to devices 100 and 300 (e.g., FIGS. 1A-4C). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1100, 1300, 1500, and/or 1700 (FIGS. 7, 9, 11, 13, 15, and/or 1700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6H illustrate exemplary user interfaces based on a color temperature of ambient lighting, in accordance with some embodiments. The user interfaces in these figures are used to illustrate the processes described below, including the processes in FIG. 7.

FIG. 6A illustrates computer system 600, which includes one or more display generation components, such as display 602. Additionally, computer system 600 includes one or more input devices, such as button 604 and camera sensor 606. In FIG. 6A, computer system 600 is a tablet computer. In some embodiments, computer system 600 is a smartspeaker, a head-mounted device, a smartwatch, a smartphone, a laptop computer, and/or a desktop computer.

In FIG. 6A, computer system 600 displays user interface 600a on display 602. In some embodiments, computer system 600 displays user interface 600a in response to detecting an event corresponding to a request to display a respective user interface, as described with respect to FIG. 8A. In the example shown in FIG. 6A, user interface 600a includes element 610 (e.g., a complication, an application icon, a dynamic user interface element, and/or a selectable user interface element) and indication of time 612 with background 614.

In some embodiments, a complication is a user-selectable graphical user interface object that displays information from a corresponding application. For example, as shown in FIG. 6A, element 610 is a complication that indicates the date (e.g., Wednesday the 27th) and the current weather conditions (e.g., 65 degrees and partly cloudy). In some embodiments, computer system 600 displays a corresponding application in response to an input directed to element 610, such as input 650 (e.g., a tap input, air tap input, gaze dwell input, and/or other selection input). For example, in some embodiments, computer system 600 displays a weather application in response to input 650.

In some embodiments, indication of time 612 indicates the current time at the location of computer system 600. In some embodiments, a user of computer system 600 (e.g., user 690) can select a visual characteristic for indication of time 612. For example, a user can select a font, script, design, style, and/or symbol type (e.g., Arabic, Arabic Indic, and/or Roman numerals).

In some embodiments, computer system 600 displays the respective user interface with a metallic appearance. For example, in some embodiments, the respective user interface appears to be made of a reflective, metal material, such as aluminum, nickel, or brass. In some embodiments, the respective user interface appears reflective (e.g., has a simulated reflectivity). In some embodiments, different regions of the respective user interface have different degrees of reflectivity. In some embodiments, background 614 appears less reflective than element 610 and indication of time 612. For example, in some embodiments, background 614 has the appearance of a matte and/or dull finish. In some embodiments, element 610 and indication of time 612 have the appearance of a shiny and/or polished finish. In some embodiments, the degree of reflectivity for the various regions of the respective user interface varies throughout the day. For example, in the morning, element 610 and indication of time 612 appear shinier (e.g., have a higher degree of reflectivity) than in the evening. In some embodiments, the simulated reflectivity of the respective user interface, or a portion of the user interface, is more visibly perceptible at one time of day than at another time of day.

In some embodiments, the appearance of the respective user interface is based on the ambient lighting conditions in the environment surrounding computer system 600. In some embodiments, computer system 600 displays the respective user interface with an appearance based on one or more lighting parameters, such as color temperature, brightness, and/or lighting intensity. For example, in some embodiments, the appearance of the respective user interface is based on the color temperature of the ambient light in the environment surrounding computer system 600. In some embodiments, the appearance of the respective user interface is based on the brightness and/or light intensity of the ambient light in the environment surrounding the computer system. In some embodiments, the appearance of the respective user interface is based on a combination of color temperature and light intensity.

In some embodiments, computer system 600 detects the ambient light conditions (e.g., color temperature and/or light intensity) in the environment surrounding computer system 600 using one or more sensors. In some embodiments, computer system 600 detects and/or measures the ambient light conditions via camera sensor 606 and/or an ambient light sensor (ALS). In some embodiments, computer system 600 measures a value for the one or more lighting parameters. For example, a detected color temperature has a value measured in Kelvins, a detected brightness has a value in lumens, and/or a detected light intensity has a value in lux (e.g., lumens per square meter). In some embodiments, computer system 600 displays the respective user interface with a simulated reflection. In some embodiments, the simulated reflection is a reflection of an image or a portion of an image. In some embodiments, computer system 600 selects an image for the reflection based on the one or more lighting parameters. For example, in some embodiments, computer system 600 selects a different image for different combinations of color temperature and/or light intensity.

In some embodiments, computer system 600 selects an image based on the color temperature and light intensity, as discussed in more detail with respect to FIG. 6H. In some embodiments, the selected image is representative of the conditions in the environment surrounding computer system 600. In some embodiments, by displaying a simulated reflection of the selected image, computer system 600 gives the appearance of reflecting the environment surrounding computer system 600 but computer system 600 uses less resources than would be necessary to simulate a reflection of the actual environment.

In the example shown in FIG. 6A, the ambient lighting conditions include medium-intensity neutral light 692, which is an overhead light with a neutral color temperature and medium light intensity. As illustrated in FIG. 6A, computer system 600 displays user interface 600a with a simulated reflection of an image with medium brightness and neutral colors (e.g., greys and browns).

In some embodiments, the portions of the respective user interface with higher degrees of simulated reflectivity show more detail from the image than portions of the respective user interface with lower degrees of simulated reflectivity. For example, as shown in FIG. 6A, computer system 600 displays indication of time 612 with a clearer reflection of the selected image than in background 614. As illustrated in FIG. 6A, indication of time 612 includes simulated reflections 612a, which represent a clearer reflection of the selected image than the blurred reflection shown in background 614.

Various features and/or examples of computer system 600, user interface 600a, and/or other user interfaces described herein, are described herein using the example of a tablet computer, as shown in FIG. 6A. In some embodiments, the user interfaces displayed by computer system 600 are implemented on and/or displayed by HMD 6000, depicted in FIG. 6A1. In FIG. 6A1, HMD 6000 includes display generation component 6002, and user interface 600a is displayed as a virtual window or widget (such as world-locked or environment-locked object that is displayed with an appearance that maintains a fixed location in the world or environment as the viewpoint of the user moves) within a three-dimensional augmented reality or virtual reality environment. In some embodiments, user interface 600a is displayed within three-dimensional environment 6010 (e.g., a virtual passthrough environment or optical passthrough environment). In some embodiments in which computer system 600 is a head-mounted system (e.g., HMD 6000), computer system 600 optionally includes two displays (e.g., one for each eye of a user), with each display displaying respective various content, to enable a user of computer system 600 to perceive the various depths of the various content (e.g., physical objects and/or virtual objects) of the three-dimensional environments. For example, in some embodiments, display generation component 6002 displays content for a left eye of the user, and a separate display generation component displays content for a right eye of the user. In some embodiments, user inputs directed to computer system 600 are shown and/or described as particular types of inputs (e.g., touch inputs and/or button press inputs). In various embodiments, other types of user inputs are used. For example, in some embodiments, gaze inputs and/or air gesture inputs are used to interact with computer system 600, user interface 600a, and/or other user interfaces described herein.

In some embodiments, computer system 600 changes the appearance of the respective user interface based on a detected change in ambient lighting conditions. For example, in FIG. 6B, the ambient lighting conditions include high-intensity cool light 694, which is an overhead light with a cool color temperature and high light intensity. In this example, computer system 600 changes from displaying user interface 600a to displaying user interface 600b, which depicts a simulated reflection of an image with high brightness and cool colors (e.g., blues and purples).

In some embodiments, computer system 600 gradually changes the respective user interface from having one appearance to having another appearance. For example, computer system 600 gradually transitions from displaying user interface 600a to displaying user interface 600b. In some embodiments, computer system 600 displays an animation of the respective user interface transforming from the first appearance to the second appearance (e.g., gradually changing colors, brightness, and/or details). In some embodiments, the animation occurs over a period of time (e.g., 3 to 10 seconds).

In some embodiments, computer system 600 detects a presence of a user in the environment surrounding computer system 600. For example, in some embodiments, computer system 600 uses camera sensor 606 to detect whether a user is in the environment surrounding computer system 600. In some embodiments, computer system 600 determines (e.g., via camera sensor 606) the position of user 690 relative to computer system 600.

In some embodiments, computer system 600 displays a visual reaction to a user in the environment surrounding computer system 600. For example, in some embodiments, computer system 600 displays a simulated reflection of user 690. In some embodiments, the simulated reflection of user 690 is based on the position of user 690. For example, in FIG. 6C, user 690 is on the left side of computer system 600 and computer system 600 displays simulated reflections 612b on the left side of indication of time 612 in user interface 600c.

In some embodiments, the simulated reflection of user 690 is based on the appearance of user 690. For example, in some embodiments, the color of the simulated reflection corresponds to the color of clothing that user 690 is wearing. In some embodiments, the simulated reflection is based on a portion of user 690. For example, if user 690 moves his arm, the simulated reflection changes appearance based on the movement of the arm. In some embodiments, a simulated reflection appears differently for different users (e.g., based on different sizes, positions, and/or colors for different users). In some embodiments, the simulated reflection appears differently when multiple users are detected in the environment surrounding computer system 600. For example, in some embodiments, multiple users appear to be reflected in the respective user interface.

In some embodiments, computer system 600 changes the appearance of the visual reaction as the user moves in the environment surrounding computer system 600. For example, as shown in FIG. 6D, user 690 is on the right side of computer system 600 and simulated reflections 612b appear on the right side of indication of time 612 in user interface 600d. In some embodiments, computer system 600 displays a gradual change and/or an animation of the transformation when transitioning from the appearance in user interface 600c to the appearance in user interface 600d.

In some embodiments, computer system 600 determines whether attention of a user is directed to computer system 600. In some embodiments, attention of a user is determined based on gaze (e.g., direction of eyes), head position, and/or user position relative to computer system 600, as discussed in more detail with respect to FIG. 14B.

In some embodiments, computer system 600 does not change the appearance of the respective user interface while computer system 600 detects that the attention of a user is directed toward computer system 600. For example, in FIG. 6E, high-intensity cool light 694 is no longer on, so the ambient light conditions have changed from high-intensity, cool conditions to medium-intensity, cool conditions. However, in FIG. 6E, attention of user 690 is directed toward computer system 600, so computer system 600 does not change the appearance of user interface 600e (e.g., computer system 600 does not change appearance of user interface 600e even though the ambient light conditions changed).

In some embodiments, computer system 600 changes the appearance of the respective user interface based on a change in lighting conditions after computer system 600 detects that attention of a user is no longer directed toward computer system 600. For example, in FIG. 6F, user 690 has left the environment surrounding computer system 600, so the attention of user 690 is no longer directed to computer system 600. In FIG. 6F, computer system 600 changes the appearance of the respective user interface to the appearance shown in user interface 600f, which reflects an image with cool colors (e.g., blue and purple colors) and medium brightness corresponding to the change in ambient light conditions.

In some embodiments, computer system 600 changes the appearance of the respective user interface in accordance with a determination that a change in one or more lighting parameters exceeds a predetermined threshold. For example, if the change in light intensity exceeds a predetermined threshold, computer system 600 changes the appearance of the respective user interface from the appearance shown in user interface 600e to the appearance shown in user interface 600f.

In some embodiments, the predetermined threshold varies in order to prevent rapid switching between appearances (e.g., when the lighting conditions are near a threshold boundary). In some embodiments, the predetermined threshold is greater to change the appearance in one direction than in the other direction. For example, in some embodiments, the predetermined threshold for a change in light intensity must be greater to change to a brighter image (e.g., from user interface 600e to user interface 600f) than is required to change back to a darker image (e.g., from user interface 600f to user interface 600e).

In some embodiments, computer system 600 displays the respective user interface with a three-dimensional appearance. In some embodiments, element 610 and indication of time 612 appear to be raised on display 602. For example, in some embodiments, element 610 appears to protrude from background 614. In some embodiments, indication of time 612 has a three-dimensional scalloped appearance (e.g., the appearance of rounded ridges following the shape of the numbers in the indication of time).

In some embodiments, element 610 and indication of time 612 include simulated surfaces and/or sidewalls, as discussed in more detail with respect to FIG. 8B. In some embodiments, element 610 and indication of time 612 have the appearance of casting shadows, as shown in FIG. 6G and discussed in more detail with respect to FIG. 8B. For example, indication of time 612 appears to cast shadows 612c in user interface 600g. In some embodiments, the appearance of simulated surfaces and/or simulated shadows change based on the position of a user, as discussed in more detail with respect to FIGS. 8B through 8E.

In some embodiments, computer system 600 displays the respective user interface with simulated highlights, as illustrated in FIG. 6G. In some embodiments, computer system 600 displays elements of the respective user interface with a simulated sheen, as discussed in more detail with respect to FIGS. 10M1 through 10M3. In some embodiments, computer system 600 displays elements of the respective user interface with simulated specular highlights, as discussed in more detail with respect to FIGS. 10N1 and 10N2 and FIGS. 10O1 through 10O3. For example, indication of time 612 includes highlights 612d in user interface 600g. In some embodiments, the appearance of simulated highlights change based on the position of a user, as discussed in more detail with respect to FIGS. 10N1 and 10N2 and FIGS. 10O1 through 10O3.

In some embodiments, computer system 600 displays the respective user interface with coloring based on the selected image. In some embodiments, the coloring of the respective user interface corresponds to (e.g., coordinates with) a key color and/or gradient in the selected image. For example, the selected image in FIG. 6A primarily includes grey and brown colors, so computer system 600 displays user interface 600a with grey coloring. As another example, the selected image in FIG. 6B primarily includes blue and purple colors, so computer system 600 displays user interface 600b with blue coloring. As another example, the selected image in FIG. 6G includes red and yellow colors, so computer system 600 displays user interface 600g with yellow coloring.

In some embodiments, the respective user interface appears to be made of a metal material that corresponds to the color temperature of ambient light conditions. For example, in FIG. 6A, user interface 600a appears to be made of a neutral-toned metal, such as a whitish aluminum, corresponding to the neutral color temperature of the ambient light conditions. As another example, in FIG. 6B, user interface 600b appears to be made of a cool-toned metal, such as silvery nickel, corresponding to the cool color temperature of the ambient light conditions. In FIG. 6G, user interface 600g appears to be made of a warm-toned metal, such as brass, corresponding to the warm ambient light conditions.

FIG. 6H illustrates different combinations of environmental lighting parameters and corresponding images. The left side of FIG. 6H depicts a spectrum of color temperatures (e.g., ranging from cool to warm color) and a spectrum of light intensities (e.g., ranging from low to high) with the associated images for each combination. The right side of FIG. 6H represents the corresponding user interface for each combination, as displayed by computer system 600. As shown in FIG. 6H, in some embodiments, computer system 600 reflects only a portion of the image. In some embodiments, the image is a cube map (e.g., a collection of six square images that represent the reflections of an environment from different perspectives, which form the faces of an imaginary cube).

FIG. 7 is a flow diagram illustrating a method for displaying a user interface based on color temperature of ambient lighting using a computer system in accordance with some embodiments. Method 700 is performed at a computer system (e.g., 100, 300, 500, 600, a smartspeaker, a head-mounted device, a smartwatch, a smartphone, a tablet computer, a laptop computer, and/or a desktop computer) that is in communication with one or more display generation components (e.g., 602, a display controller, a display, a touch-sensitive display system, a touchscreen, a head-mounted display, and/or a monitor) and one or more input devices (e.g., 602, 604, 606, a touch-sensitive surface, a touchscreen display, a button, a keyboard, a mouse, a joystick, a camera sensor, a light sensor, a motion sensor, and/or a microphone). Some operations in method 700 are, optionally, combined, the orders of some operations are, optionally, changed, and some operations are, optionally, omitted.

As described below, method 700 provides an intuitive way for displaying a user interface based on color temperature of ambient lighting. The method reduces the cognitive burden on a user for displaying a user interface based on color temperature of ambient lighting, thereby creating a more efficient human-machine interface. For battery-operated computing devices, enabling a user to display a user interface based on color temperature of ambient lighting faster and more efficiently conserves power and increases the time between battery charges.

While displaying a user interface (e.g., 600a, a time user interface, a user interface that includes a digital and/or analog indication of time, a clock face, a wake screen, and/or a home screen) with a first appearance (e.g., a color, color tone, color scheme, a brightness, an image, and/or an animation), the computer system detects (702), via the one or more input devices, a change in an ambient lighting condition that includes one or more values for one or more lighting parameters (e.g., color temperature and/or brightness) of an environment surrounding the computer system from a first ambient lighting condition (e.g., 692) to a second ambient lighting condition (e.g., 694) that is different from the first ambient lighting condition, wherein the first ambient lighting condition includes a first color temperature of ambient light in the environment surrounding the computer system (e.g., at a first time).

In some embodiments, in response to detecting the change in the ambient lighting condition from the first ambient lighting condition to the second ambient lighting condition, in accordance with a determination that the second ambient lighting condition includes a second color temperature of ambient light in the environment surrounding the computer system that is different from the first color temperature, the computer system changes (704) the user interface to having a second appearance (e.g., 600b) that is based on the change in the color temperature to the second color temperature (e.g., at a second time). In some embodiments, the change in the appearance of the user interface is based on the change in the color temperature of the ambient lighting (e.g., a magnitude of the change in the appearance of the user interface is proportional to a magnitude of the change in the color temperature of the ambient lighting and/or a change in color of the appearance of the user interface is the same as a change in color of the ambient lighting). In some embodiments, if the second color temperature is cooler (e.g., having bluish colors and/or higher kelvin values) than the first color temperature, the second appearance has cooler colors than the first appearance. In some embodiments, if the second color temperature is warmer (e.g., having yellowish colors and/or lower kelvin values) than the first color temperature, the second appearance has warmer colors than the first appearance. In some embodiments, the second color temperature is a warmer color temperature than the first color temperature. In some embodiments, the second color temperature is a cooler color temperature than the first color temperature. In some embodiments, a color hue and/or color scheme in the second appearance corresponds to the second color temperature.

Changing the user interface to having a second appearance that is based on the change in the color temperature in response to detecting the change in the ambient lighting condition from the first ambient lighting condition to the second ambient lighting condition provides a user with feedback regarding a change in lighting conditions and regarding the color temperature of the ambient light, thereby providing the user with improved visual feedback. Changing the user interface to having a second appearance that is based on the change in the color temperature in response to detecting the change in the ambient lighting condition and in accordance with a determination that the second ambient lighting condition includes a second color temperature of ambient light enables the computer system to update the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

In some embodiments, in response to detecting the change in the ambient lighting condition from the first ambient lighting condition to the second ambient lighting condition (e.g., the change from the lighting condition shown in FIG. 6D to the lighting condition shown in FIG. 6F), in accordance with a determination that the second ambient lighting condition includes the first color temperature (e.g., the change in ambient lighting condition does not include a change in the color temperature of the ambient light in the environment surrounding the computer system, as illustrated by the change from the lighting condition shown in FIG. 6D to the lighting condition shown in FIG. 6F, which both include a cool color temperature), the computer system changes the user interface to having a third appearance that is based on a change in a lighting parameter other than color temperature (e.g., that is not based on the color temperature of the ambient light in the environment surrounding the computer system) (e.g., the appearance shown in user interface 600f in FIG. 6F). Changing the user interface to having a third appearance that is based on a change in a lighting parameter other than color temperature provides a user with feedback regarding a change in lighting conditions and regarding a lighting parameter, thereby providing the user with improved visual feedback. Changing the user interface to having a third appearance that is based on a change in a lighting parameter other than color temperature in response to detecting the change in the ambient lighting condition from the first ambient lighting condition to the second ambient lighting condition enables the computer system to update the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

In some embodiments, the computer system detects a change in ambient lighting condition from a third ambient lighting condition to a fourth ambient lighting condition that is different from the third ambient lighting condition (e.g., the change from the lighting condition shown in FIG. 6D to the lighting condition shown in FIG. 6F), wherein the third ambient lighting condition includes a first light intensity (e.g., brightness and/or lux (e.g., lumens per square meter)) of ambient light in the environment surrounding the computer system. In some embodiments, a change in ambient lighting condition includes a change in color temperature and a change in brightness. In some embodiments, the third ambient lighting condition is the same as the first ambient lighting condition and the fourth ambient lighting condition is the same as the second ambient lighting condition. In some embodiments, the third ambient lighting condition is different from the first ambient lighting condition and the fourth ambient lighting condition is different from the second ambient lighting condition. In some embodiments, in response to detecting the change in the ambient lighting condition from the third ambient lighting condition to the fourth ambient lighting condition, in accordance with a determination that the fourth ambient lighting condition includes a second light intensity of ambient light in the environment surrounding the computer system that is different from the first light intensity, the computer system changes the user interface to having a fourth appearance that is based on the change in the light intensity to the second light intensity (e.g., as illustrated by the change from the user interface shown in FIG. 6D to the user interface shown in FIG. 6F, based on the change from high light intensity to medium light intensity). In some embodiments, the fourth appearance is the same as the second appearance. In some embodiments, the fourth appearance is the same as the third appearance. In some embodiments, the fourth appearance is different from the second appearance or the third appearance. Changing the user interface to have a fourth appearance that is based on the change in the light intensity provides a user with feedback regarding a change in lighting conditions and regarding a light intensity in the environment surrounding the computer system, thereby providing the user with improved visual feedback. Changing the user interface to have a fourth appearance that is based on the change in the light intensity in response to detecting the change in the ambient lighting condition from the third ambient lighting condition to the fourth ambient lighting enables the computer system to update the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

In some embodiments, while displaying the user interface with the first appearance (e.g., the appearance shown in FIG. 6D), detecting, via the one or more input devices, attention (e.g., a direction of focus) of a user (e.g., 690) of the computer system. In some embodiments, in response to detecting the change in the ambient lighting condition from the first ambient lighting condition to the second ambient lighting condition, in accordance with a determination that the attention of the user is directed towards the computer system, forgoing changing the user interface to having the second appearance (e.g., maintain the first appearance, as illustrated in FIG. 6E). In some embodiments, in response to detecting the change in the ambient lighting condition from the first ambient lighting condition to the second ambient lighting condition, the computer system changes the user interface to having the second appearance that is based on the change in the color temperature to the second color temperature in accordance with a determination that the attention of the user is not directed towards the computer system. Forgoing changing the user interface to having the second appearance in accordance with a determination that the attention of the user is directed towards the computer system reduces potential interference with the one or more input devices and limits rapid changes to the user interface, thereby providing the user with improved visual feedback and an improved user experience.

In some embodiments, the attention of the user is based on gaze (e.g., eye direction and/or line of sight), head position (e.g., direction and/or orientation), and/or location (e.g., position and/or proximity) of the user relative to the computer system and/or to one or more input devices of the computer system. Basing the attention of the user on gaze, head position, and/or location of the user enables the computer system to determine attention of the user, thereby providing improved visual feedback based on the attention of the user.

In some embodiments, changing the user interface to having the second appearance includes displaying, via the one or more display generation components, an animation of the user interface gradually changing from the first appearance to the second appearance (e.g., a transition from the first appearance to the second appearance over a 0.5 to 10 second period with intermediate appearances between the first appearance and the second appearance) (e.g., a transition from the appearance shown in FIG. 6A to the appearance shown in FIG. 6B). In some embodiments, the computer system begins changing the user interface from having the first appearance to having the second appearance when the change in the ambient lighting condition meets and/or exceeds a lighting-condition threshold. Displaying an animation of the user interface gradually changing from the first appearance to the second appearance limits sudden and/or abrupt changes to the appearance of the user interface, thereby providing the user with improved visual feedback and an improved user experience.

In some embodiments, the change in the user interface from having the first appearance to having the second appearance is based on the change in ambient lighting condition meeting a first lighting-condition threshold (e.g., based on an amount of change in the ambient lighting condition or a current value of a lighting condition parameter such as brightness and/or color temperature threshold). In some embodiments, while displaying the user interface with the second appearance, the computer system detects, via the one or more input devices, a respective change in the one or more values for the ambient lighting condition. In some embodiments, in response to detecting the respective change in the one or more values for the ambient lighting condition: in accordance with a determination that the respective change exceeds a second lighting-condition threshold (e.g., a predetermined threshold and/or a minimum value for changing an appearance of the user interface to a prior appearance), the computer system changes the user interface from having the second appearance to having the first appearance, wherein the second lighting-condition threshold is different from (or, in some embodiments, greater than) the first lighting-condition threshold (e.g., the threshold for changing from the first appearance to the second appearance is different from the threshold for changing from the second appearance back to the first appearance). In some embodiments, the threshold for changing from the first appearance to the second appearance is greater than the threshold for changing from the second appearance to the first appearance. In some embodiments, the threshold for changing from the first appearance to the second appearance is less than the threshold for changing from the second appearance to the first appearance. In some embodiments, in response to detecting the respective change in the one or more values for the ambient lighting condition: in accordance with a determination that the respective change does not exceed the second lighting-condition threshold, the computer system forgoes changing the user interface to having the first appearance (and/or, in some embodiments, maintaining display of the user interface with the second appearance). In some embodiments, the second lighting-condition threshold is greater than the first lighting-condition threshold and a change from a first lighting condition to a second lighting condition exceeds the first lighting-condition threshold (e.g., resulting in the user interface changing from the first appearance to the second appearance) but a change from the second lighting condition to the first lighting condition does not exceed the second lighting-condition threshold (e.g., resulting in the user interface maintaining the second appearance). Changing the user interface from having the second appearance to having the first appearance in accordance with a determination that the respective change exceeds a return threshold provides a user with feedback regarding a change in ambient light, thereby providing the user with improved visual feedback. Changing the user interface in accordance with a determination that the respective change exceeds a return threshold limits rapid changes to the user interface, thereby providing the user with improved visual feedback and an improved user experience. Changing the user interface from having the second appearance to having the first appearance in accordance with a determination that the respective change exceeds a return threshold enables the computer system to update the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

In some embodiments, changing the user interface to having the second appearance includes changing an image (or, in some embodiments, a portion of an image) (e.g., the images shown in FIG. 6H, a cube map image, a photograph, graphic, and/or artwork) that is used to generate a simulated reflection in the user interface. In some embodiments, changing the image that is used to generate the simulated reflection in the user interface includes changing from a first image to a second image. In some embodiments, displaying the user interface having a first appearance includes displaying the user interface with the appearance of a simulated reflection of the first image and displaying the user interface having a second appearance includes displaying the user interface with the appearance of a simulated reflection of the second image. Changing an image that is used to generate a simulated reflection in the user interface in response to detecting the change in the ambient lighting condition provides a user with feedback regarding the change in ambient light, thereby providing the user with improved visual feedback. Changing an image that is used to generate a simulated reflection in the user interface in response to detecting the change in the ambient lighting condition enables the computer system to update the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

In some embodiments, the image that is used to generate the simulated reflection in the user interface corresponds to a respective color temperature and a respective light intensity of the ambient light in the environment surrounding the computer system (e.g., as shown by the correlation of images to color temperature and light intensity depicted in FIG. 6H). In some embodiments, the image that is used to generate the simulated reflection in the user interface is based on the ambient lighting condition in the environment surrounding the computer system. In some embodiments, the image that is used to generate the simulated reflection in the user interface corresponds to a color temperature threshold and/or a color temperature range. In some embodiments, the image that is used to generate the simulated reflection in the user interface corresponds to a light intensity threshold and/or a light intensity range. In some embodiments, the image that is used to generate the simulated reflection in the user interface simulates an actual reflection of the ambient lighting condition from the image. In some embodiments, the image that is used to generate the simulated reflection in the user interface simulates an actual reflection of the ambient lighting condition in the environment surrounding the computer system. Using an image that corresponds to the respective color temperature and the respective light intensity of the ambient light to generate a simulated reflection in the user interface provides a user with feedback regarding the color temperature and light intensity of the ambient light, thereby providing the user with improved visual feedback. Using an image that corresponds to the respective color temperature and the respective light intensity of the ambient light to generate a simulated reflection in the user interface in response to detecting the change in the ambient lighting condition enables the computer system to update the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

In some embodiments, the user interface includes: a first portion (e.g., 610, 612, and/or a foreground portion) of the user interface having a first degree of simulated reflectivity (e.g., a simulated ability to reflect light (e.g., such as the ambient light in the environment surrounding the computer system), to reflect light from a person and/or object (e.g., such as a user of the computer system located near the computer system), and/or to reflect an image (e.g., such as the image used to generate a simulated reflection in the user interface)), and a second portion (e.g., 614 and/or a background portion) of the user interface having a second degree (e.g., amount) of simulated reflectivity that is different from the first degree of simulated reflectivity. In some embodiments, the first portion of the user interface appears more matte than the second portion of the user interface. In some embodiments, the second portion of the user interface appears more matte than the first portion of the user interface. Displaying the user interface with simulated reflectivity enables the user to perceive ambient light conditions within the user interface, thereby providing the user with improved visual feedback. Displaying the user interface with a first degree of simulated reflectivity in a first portion of the user interface and a second degree of simulated reflectivity in a second portion of the user interface distinguishes between different portions of the user interface, thereby providing the user with improved visual feedback.

In some embodiments, at a first time (e.g., in the morning and/or during the daytime), the first portion of the user interface has the first degree of simulated reflectivity (and, in some embodiments, the second portion of the user interface has the second degree of simulated reflectivity), and at a second time that is different from the first time (e.g., in the afternoon and/or during the nighttime), the first portion of the user interface has a third degree of simulated reflectivity that is different from the first degree of simulated reflectivity (and, in some embodiments, the second portion of the user interface has a fourth degree of simulated reflectivity that is different from the second degree of simulated reflectivity). Displaying the user interface with a first degree of simulated reflectivity at a first time and a second degree of simulated reflectivity at a second time provides feedback regarding the time, thereby providing the user with improved visual feedback. Displaying the user interface with a first degree of simulated reflectivity at a first time and a second degree of simulated reflectivity at a second time adjusts the appearance of the user interface based on the time of day without requiring user input, thereby performing an operation when a set of conditions has been met without requiring further user input and reducing the number of inputs needed to perform an operation.

In some embodiments, a visual characteristic (e.g., style, font, script, and/or format) of the first portion of the user interface is user-selectable (e.g., via a set of one or more inputs, such as in a settings menu). Displaying the user interface with a visual characteristic of the first portion of the user interface that is user-selectable provides information to the user in a preferred format, thereby providing the user with improved visual feedback.

In some embodiments, the first portion of the user interface includes an indication of a current time (e.g., 612 and/or the current time in the time zone in which the computer system is located) and/or an indication of a current date (e.g., 610 and/or the current date at the location of the computer system). Displaying the user interface with an indication of a current time and/or date provides feedback regarding the current date and/or time, thereby providing the user with improved visual feedback. Displaying the user interface with an indication of a current time and/or date enables the user to view the indication of a current time and/or date without requiring the user to navigate to a different user interface to view the indication of a current time and/or date, thereby performing an operation when a set of conditions has been met without requiring further user input and reducing the number of inputs needed to perform an operation.

In some embodiments, the first portion of the user interface includes a complication (e.g., 610 and/or a user interface element that displays information from a corresponding application and can be selected to open the corresponding application). Displaying the user interface with a complication provides information regarding a corresponding application, thereby providing the user with improved visual feedback. Displaying the user interface with a complication provides the user with access to the complication without requiring the user to navigate to a different user interface to access the complication, thereby performing an operation when a set of conditions has been met without requiring further user input and reducing the number of inputs needed to perform an operation.

In some embodiments, more detail (e.g., visual elements) of the image that is used to generate a simulated reflection is visible in a portion of the user interface with higher simulated reflectivity (e.g. 612a) than in a portion of the user interface with lower simulated reflectivity (e.g., the background image seems to be more clearly reflected in indication of time 612 than in background 614). In some embodiments, the image that is used to generate the simulated reflection in the user interface is more clearly reflected in one portion of the user interface than in another portion of the user interface. In some embodiments, the image that is used to generate the simulated reflection in the user interface is clearer and/or more vibrant in a portion of the user interface with higher simulated reflectivity. In some embodiments, the image that is used to generate the simulated reflection in the user interface is less clear and/or more muted in a portion of the user interface with lower simulated reflectivity. In some embodiments, portions of the image with higher reflectivity show more detail from the image that is used to generate the simulated reflection and portions of the image with lower reflectivity show less detail from the image that is used to generate the simulated reflection. Displaying the user interface with more detail in a portion of the user interface with a higher degree of simulated reflectivity and less detail in a portion of the user interface with a lower degree of simulated reflectivity distinguishes between different portions of the user interface, thereby providing the user with improved visual feedback. Displaying the user interface with more detail in a portion of the user interface with a higher degree of simulated reflectivity and less detail in a portion of the user interface with a lower degree of simulated reflectivity automatically provides variation within the user interface without requiring the user to manually edit the user interface, thereby performing an operation when a set of conditions has been met without requiring further user input and reducing the number of inputs needed to perform an operation.

In some embodiments, the image that is used to generate a simulated reflection includes varying degrees of detail throughout the image (e.g., as illustrated by the images shown in FIG. 6H). In some embodiments, the image that is used to generate a simulated reflection includes a first portion (e.g., a foreground portion) with a first degree of detail (e.g., more detail, such as being clearer and/or more in focus) and a second portion (e.g., a background portion) with a second degree of detail (e.g., less detail, such as being blurred and/or out of focus) that is different from the first degree of detail. Displaying the user interface with a simulated reflection of an image with varying degrees of detail throughout the image results in varying degrees of detail throughout the user interface, thereby providing the user with improved visual feedback. Displaying the user interface with a simulated reflection of an image with varying degrees of detail throughout the image automatically provides variation within the user interface without requiring the user to manually edit the user interface, thereby performing an operation when a set of conditions has been met without requiring further user input and reducing the number of inputs needed to perform an operation.

In some embodiments, the computer system detects, via the one or more input devices, presence of a person (e.g., 690) (e.g., based on location, position, and/or proximity relative to the computer system). In some embodiments, in response to detecting the presence of the person, the computer system displays, via the one or more display generation components, the user interface with a visual reaction (e.g., 612b, 612c, 612d, 1016, 1018, 1210, and/or a dynamic element and/or an animation, such as the animations shown FIG. 14A, 14T, or 14U). In some embodiments, the visual reaction is based on the presence of the person (e.g., changes based on movement of the person). In some embodiments, in accordance with a determination that presence of a person is not detected, the computer system displays the user interface without including the visual reaction. Displaying the user interface with a visual reaction in response to detecting the presence of a person provides feedback regarding the presence of the person, thereby providing the user with improved visual feedback. Displaying the user interface with a visual reaction in response to detecting the presence of a person enables the computer system to update the appearance of the user interface to reflect the presence of the person and provide a more varied user experience without requiring additional inputs from the user to change the appearance of the user interface, thereby performing an operation when a set of conditions has been met without requiring further user input and reducing the number of inputs needed to perform an operation.

In some embodiments, the visual reaction changes as a portion of the body (e.g., head, arms, shoulders, fingers, and/or hands) of the person moves. In some embodiments, the visual reaction mirrors the movement of the person. In some embodiments, the visual reaction is a simulated reflection of the person (e.g., based on the position and/or appearance of the person, such as clothing color). Displaying the user interface with a visual reaction that changes as a portion of the body of the person moves provides feedback regarding detection of the movement of the person, thereby providing the user with improved visual feedback. Displaying the user interface with a visual reaction that changes as a portion of the body of the person moves automatically provides variation within the user interface without requiring the user to manually edit the user interface, thereby performing an operation when a set of conditions has been met without requiring further user input and reducing the number of inputs needed to perform an operation.

In some embodiments, the visual reaction includes simulated lighting (e.g., a simulation of the ambient lighting condition in the environment surrounding the computer system) that appears to be cast (e.g., as simulated highlights and/or shadows, such as 612c and 612d) onto the user interface. In some embodiments, the visual reaction is a simulation of reflected light (e.g., based on the ambient lighting condition and/or the position of the person). Displaying the user interface with a visual reaction that includes simulated lighting that appears to be cast onto the user interface provides feedback regarding the ambient lighting, thereby providing the user with improved visual feedback. Displaying the user interface with a visual reaction that includes simulated lighting that appears to be cast onto the user interface automatically provides variation within the user interface without requiring the user to manually edit the user interface, thereby performing an operation when a set of conditions has been met without requiring further user input and reducing the number of inputs needed to perform an operation.

In some embodiments, displaying the user interface with the visual reaction includes: in accordance with a determination that a first person (e.g., 690) is present (e.g., near the computer system and/or within range of the one or more input devices), the simulated lighting includes a first simulated lighting effect (e.g., a simulated shadow of the first person, as illustrated by 612b). In some embodiments, displaying the user interface with the visual reaction includes: in accordance with a determination that a second person that is different from the first person is present, the simulated lighting includes a second simulated lighting effect (e.g., a simulated shadow of the second person). In some embodiments, the first person and the second person are both present and the simulated lighting includes both the first simulated lighting effect and the second simulated lighting effect. Displaying the user interface with a first simulated lighting effect in accordance with a determination that a first person is present and displaying the user interface with a second simulated lighting effect in accordance with a determination that a second person is present provides feedback regarding the presence of the first and second person, thereby providing the user with improved visual feedback. Displaying the user interface with a first simulated lighting effect in accordance with a determination that a first person is present and displaying the user interface with a second simulated lighting effect in accordance with a determination that a second person is present enables the computer system to update the appearance of the user interface to reflect the presence of a respective person and provide a more varied user experience without requiring additional inputs from the user to change the appearance of the user interface, thereby performing an operation when a set of conditions has been met without requiring further user input and reducing the number of inputs needed to perform an operation.

In some embodiments, a color of the user interface is based on a principal (e.g., key, primary, and/or dominant) color of content that is used to generate an appearance of the user interface (e.g., content that is used to generate a simulated reflection on the user interface). In some embodiments, the content includes an image (e.g., a cube map image), an image and/or representation of the user, and/or a representation of the ambient lighting condition. Displaying the user interface with a color that is based on a principal color of content that is used to generate an appearance of the user interface provides feedback regarding the content that is used to generate an appearance and/or a simulated reflection in the user interface, thereby providing the user with improved visual feedback.

In some embodiments, after (or, in some embodiments, while) displaying the user interface having the second appearance that is based on the change in the color temperature to the second color temperature, the computer system detects, via the one or more input devices, a third ambient lighting condition, wherein the third ambient lighting condition includes a third color temperature (e.g., the color temperature shown in FIG. 6G) that is different from the first color temperature and the second color temperature. In some embodiments, in response to detecting the third ambient lighting condition, the computer system displays, via the one or more display generation components, the user interface having a third appearance based on the third color temperature (e.g., the computer system changes the appearance of the user interface in response to a change in the color temperature of the detected ambient lighting condition) (e.g., the appearance shown in FIG. 6G), wherein the third appearance is different from the first appearance and the second appearance. In some embodiments, the color tones and/or color scheme in the third appearance correspond to the third color temperature. In some embodiments, if the third color temperature is cooler (e.g., more blue tones and/or less red tones) than the second color temperature, the third appearance has cooler tones than the second appearance. In some embodiments, if the third color temperature is warmer (e.g., more red tones and/or less blue tones) than the second color temperature, the third appearance has warmer tones than the second appearance. Displaying the user interface having the third appearance based on the third color temperature in response to detecting the third ambient lighting condition provides feedback regarding the ambient lighting condition, thereby providing the user with improved visual feedback. Displaying the user interface having a third appearance based on the third color temperature in response to detecting the third ambient lighting condition enables the computer system to updated the appearance of the user interface to reflect the properties of the ambient lighting conditions and provide a more varied user experience without requiring additional inputs from the user to change the appearance of the user interface, thereby performing an operation when a set of conditions has been met without requiring further user input and reducing the number of inputs needed to perform an operation.

FIGS. 8A-8L illustrate exemplary user interfaces based on lighting angle, in accordance with some embodiments. The user interfaces in these figures are used to illustrate the processes described below, including the processes in FIG. 9.

FIG. 8A illustrates computer system 600 displaying, on display 602, user interface 800a (e.g., a home screen or an application launching user interface) that includes application icons for opening respective applications. In some embodiments, user interface 800a is a user interface of an application (e.g., a messaging application, an email application, a calendar application, or a workout application) or a menu user interface (e.g., a settings menu or other menu user interface). In FIG. 8A, computer system 600 detects an event corresponding to a request to display a respective user interface (e.g., a time user interface or other user interface).

In some embodiments, the event corresponding to the request to display the respective user interface includes receiving a set of one or more inputs. For example, in some embodiments, computer system 600 detects input 850a (e.g., press and/or other physical input) on button 604. In some embodiments, computer system 600 detects input 850b (e.g., a tap input, air tap input, gaze dwell input, and/or other selection input) directed to an application icon, such as clock icon 801 shown in FIG. 8A. In some embodiments, computer system 600 detects a set of one or more swipe inputs and/or other inputs directed to a different user interface, such as a menu user interface (e.g., a settings menu or other menu user interface), a user interface associated with notifications (e.g., a user interface that displays a summary of notifications), and/or a user interface of an application (e.g., a messaging application, an email application, a calendar application, or a workout application). In some embodiments, computer system 600 detects a set of one or more swipe inputs and/or other inputs directed to another respective user interface, such as user interface 600a in FIG. 6A, user interface 1000a in FIG. 10A, user interface 1200a in FIG. 12A, or user interface 1400a in FIG. 14B.

In some embodiments, the event corresponding to the request to display the respective user interface includes arrival of a user in the region near computer system 600. For example, in some embodiments, computer system 600 detects that user 890 recently (e.g., within a threshold duration, such as within the past five minutes) arrived in the region near computer system 600. In some embodiments, computer system 600 detects motion in the environment surrounding computer system 600 (e.g., via camera sensor 606 and/or another sensor). For example, in some embodiments, computer system 600 detects and/or determines that a user is in the region of computer system 600 (e.g., via camera sensor 606). In some embodiments, computer system 600 determines that a user is in the region near computer system 600 based on a device that is associated with the user being in the region near computer system 600 (e.g., based on detected proximity) and/or being connected to the same network as computer system 600.

In some embodiments, the event corresponding to the request to display the respective user interface includes a gesture (e.g., that is detected by camera sensor 606). In some embodiments, the event corresponding to the request to display the respective user interface includes a voice command (e.g., that is detected by a microphone sensor).

In some embodiments, in response to detecting the event corresponding to the request to display the respective user interface, computer system 600 displays the respective user interface, such as user interface 800b shown in FIG. 8B. In some embodiments, the respective user interface is a time user interface, a clock face, a wake screen, a lock screen, and/or a home screen. As illustrated in FIG. 8B, user interface 800b includes element 802 (e.g., a complication, such as a weather complication or a complication associated with another application) and indication of time 804. In some embodiments, indication of time 804 includes analog clock hands 806, including hour hand 806a, minute hand 806b, and second hand 806c.

In some embodiments, a complication is a user-selectable graphical user interface object that displays information from a corresponding application. For example, as shown in FIG. 8B, element 802 is a complication that indicates the date (e.g., Wednesday the 27th) and the current weather conditions (e.g., 65 degrees and partly cloudy). In some embodiments, computer system 600 displays a corresponding application in response to an input directed to element 802, such as input 852 (e.g., a tap input, air tap input, gaze dwell input, and/or other selection input). For example, in some embodiments, computer system 600 displays a weather application in response to input 852.

In some embodiments, computer system 600 displays elements of the respective user interface with simulated dimensionality, such as the appearance of protruding from display 602. For example, in some embodiments, clock hands 806 have the appearance of protruding from and/or extending out of display 602. In some embodiments, computer system 600 displays clock hands 806 with simulated dimensional features, such as simulated surfaces and/or side walls.

In some embodiments, the simulated dimensional features of clock hands 806 are based on the position of user 890. For example, in FIG. 8B, each of the clock hands 806 has the appearance of a visible side wall on the left side of clock hands 806 because user 890 is standing to the left of computer system 600 (e.g., for protruding elements, the left side wall is visible when user 890 is to the left of computer system 600).

In some embodiments, computer system 600 displays elements of the respective user interface with simulated lighting effects, such as simulated shadows. In some embodiments, computer system 600 displays clock hands 806 with simulated shadows based on ambient lighting conditions, a detected light source, a simulated light source, and/or a combination thereof.

In FIG. 8B, for example, computer system 600 detects medium light 892 centered above computer system 600. In some embodiments, computer system 600 displays clock hands 806 with simulated shadows that correspond to the position of medium light 892 (e.g., with shadows below the clock hands), as shown in user interface 800b.

In some embodiments, computer system 600 detects multiple light sources in the environment surrounding computer system 600. In some embodiments, computer system 600 selects a primary light source on which to base the display of the respective user interface. In some embodiments, computer system 600 selects the closest, brightest, and/or most intense light source as the primary light source.

In some embodiments, computer system 600 uses a default and/or simulated light source. For example, in some embodiments, computer system 600 uses a default and/or simulated light source when the ambient light is below a predetermined threshold.

In some embodiments, clock hands 806 have the appearance of being made of glass. For example, in some embodiments, computer system 600 displays clock hands 806 with a simulated glass appearance. In some embodiments, clock hands 806 include simulated translucency and/or simulated refraction, as discussed in more detail with respect to FIG. 10K and FIG. 10L.

In some embodiments, element 802 and clock hands 806 include simulated sheen, as discussed in more detail with respect to FIGS. 10M1-10M3. In some embodiments, element 802 and clock hands 806 include simulated specular highlights, as discussed in more detail with respect to FIGS. 10N1 and 10N2 and FIGS. 10O1-10O3. In some embodiments, computer system 600 displays element 802 and clock hands 806 with simulated parallax (e.g., an effect of having a different appearance and/or an observed displacement) based on the position of user 890.

In some embodiments, indication of time 804 includes hour numerals 808 corresponding to the hours of a twelve-hour clock. In some embodiments, indication of time 804 includes some (e.g., fewer than all) of the twelve possible hour numerals. For example, in FIG. 8B, indication of time 804 includes hour numerals 808c through 808i corresponding to the 3 o'clock through 9 o'clock hours.

In some embodiments, computer system 600 displays the current hour and a predetermined number of hours on either side of the current hour. For example, in FIG. 8B, computer system 600 displays the current hour numeral and the three hour numerals on each side of the current hour around the clock face. As illustrated in FIG. 6B, the time is 6:05 and computer system 600 displays hour numeral 808f (e.g., corresponding to the 6 o'clock hour), as well as hour numerals 808b through 808e (e.g., corresponding to the 3 o'clock, 4 o'clock, and 5 o'clock hours, respectively) and hour numerals 808g through 808i (e.g., corresponding to the 7 o'clock, 8 o'clock, and 9 o'clock hours, respectively).

In some embodiments, hour numerals 808 appear to be recessed into display 602, such as with the appearance of simulated engraving. In some embodiments, computer system 600 displays hour numerals 808 with simulated dimensional features, such as simulated surfaces and/or side walls. For example, in FIG. 8B, hour numerals 808 have the appearance of having a recessed surface and a visible side wall on the right side of the hour numeral.

In some embodiments, computer system 600 displays hour numerals 808 with simulated shadows based on ambient lighting conditions, a detected light source, a simulated light source, and/or a combination thereof. In FIG. 8B, for example, computer system 600 displays hour numerals 808 with simulated shadows that correspond to the position of medium light 892 (e.g., with shadows below the upper edges of the hour numerals).

In some embodiments, the appearance of the respective user interface changes based on a detected direction of ambient light. For example, in some embodiments, as the direction of a detected light source changes, computer system 600 modifies the appearance of the simulated shadows (e.g., to correspond to the change in position of the detected light).

Various features and/or examples of computer system 600, user interface 800b, and/or other user interfaces described herein, are described using the example of a tablet computer, as shown in FIGS. 8A-8B. In some embodiments, the user interfaces displayed by computer system 600 are implemented on and/or displayed by HMD 6000, depicted in FIG. 8B1. In FIG. 8B1, HMD 6000 includes display generation component 6002, and user interface 800b is displayed as a virtual window or widget (such as world-locked or environment-locked object that is displayed with an appearance that maintains a fixed location in the world or environment as the viewpoint of the user moves) within a three-dimensional augmented reality or virtual reality environment. In some embodiments, user interface 800b is displayed within three-dimensional environment 6010 (e.g., a virtual passthrough environment or optical passthrough environment). In some embodiments in which computer system 600 is a head-mounted system (e.g., HMD 6000), computer system 600 optionally includes two displays (e.g., one for each eye of a user), with each display displaying respective various content, to enable a user of computer system 600 to perceive the various depths of the various content (e.g., physical objects and/or virtual objects) of the three-dimensional environments. For example, in some embodiments, display generation component 6002 displays content for a left eye of the user, and a separate display generation component displays content for a right eye of the user. In some embodiments, user inputs directed to computer system 600 are shown and/or described as particular types of inputs (e.g., touch inputs and/or button press inputs). In various embodiments, other types of user inputs are used. For example, in some embodiments, gaze inputs and/or air gesture inputs are used to interact with computer system 600, user interface 800b, and/or other user interfaces described herein.

As illustrated in FIG. 8C, computer system 600 detects bright light 894 from the upper left. In some embodiments, computer system 600 displays clock hands 806 with simulated shadows that correspond to the position of bright light 894 (e.g., with shadows below and to the right of the clock hands), as shown in user interface 800c. Similarly, in some embodiments, computer system 600 displays hour numerals 808 with simulated shadows that correspond to the position of bright light 894 (e.g., with shadows below the upper left edges of the hour numerals), as shown in user interface 800c.

As illustrated in FIG. 8D, computer system 600 detects dim light 896 in the lower left. In some embodiments, computer system 600 displays clock hands with simulated shadows that correspond to the position of dim light 896 (e.g., with shadows above and to the right of the clock hands), as shown in user interface 800d. Similarly, in some embodiments, computer system 600 displays hour numerals 808 with simulated shadows that correspond to the position of dim light 896 (e.g., with shadows above the lower left edges of the hour numerals), as shown in user interface 800d.

In some embodiments, the appearance of the respective user interface changes based on a detected amplitude of ambient light. In some embodiments, as the amplitude and/or brightness of the detected light source changes, computer system 600 modifies the appearance of the simulated shadows (e.g., to correspond to the change in amplitude of the detected light). For example, in FIG. 8C, computer system 600 displays clock hands 806 and hour numerals 808 with harsher (e.g., more prominent) shadows corresponding to bright light 894 (e.g., as compared with the shadows corresponding to medium light 892 in FIG. 8B). As another example, in FIG. 8D, computer system 600 displays clock hands 806 and hour numerals 808 with softer (e.g., more subtle) shadows corresponding to dim light 896 (e.g., as compared with the shadows corresponding to medium light 892 in FIG. 8B and to bright light 894 in FIG. 8C).

In some embodiments, elements of the respective user interface have the appearance of variable simulated depths. For example, in some embodiments, hour numerals 808 have the appearance of having varying simulated depths. In some embodiments, the hour numeral corresponding to the hour of the current time appears to be the deepest hour numeral of the displayed hour numerals. As illustrated in FIG. 8D, the time is 7:00 and hour numeral 808g (e.g., corresponding to the 7 o'clock hour) has the appearance of being the deepest. In some embodiments, the simulated depth appears to vary within a single hour numeral (e.g., from one portion to another). For example, computer system 600 displays hour numeral 808d (e.g., corresponding to 4 o'clock) with no simulated depth at one side to a perceptible simulated depth on the other side, as shown in user interface 800d.

In some embodiments, elements of the respective user interface appear to gradually increase from no simulated depth to the deepest simulated depth. In some embodiments, as illustrated in FIG. 8D, the hour numerals appear to become progressively deeper moving from hour numeral 808d (e.g., corresponding to 4 o'clock) to hour numeral 808e (e.g., corresponding to 5 o'clock) to hour numeral 808f (e.g., corresponding to 6 o'clock) and from hour numeral 808j (e.g., corresponding to 10 o'clock) to hour numeral 808i (e.g., corresponding to 9 o'clock) to hour numeral 808h (e.g., corresponding to 8 o'clock), with hour humeral 808g (e.g., corresponding to 7 o'clock) appearing the deepest.

In some embodiments, the simulated engraving appears to have different depths at different times. In some embodiments, the depth of hour numerals 808 vary based on the position of hour hand 806a. In some embodiments, the change in simulated depth follows hour hand 806a. For example, as illustrated in FIG. 8C, hour numeral 808f (e.g., corresponding to 6 o'clock) appears deepest because the time is 6:10. In FIG. 8D, the time has changed to 7:00 and hour numeral 808g (e.g., corresponding to 7 o'clock) is deepest.

In some embodiments, as computer system 600 changes the depth of the simulated engraving, computer system 600 also changes which numbers are visible. For example, in FIG. 8C, hour numerals 808c through 808i (e.g., corresponding to the 3 o'clock through the 9 o'clock hours) are visible, with 808f (e.g., corresponding to 6 o'clock) being the middle (e.g., and deepest) number because the time is 6:10. In FIG. 8D, hour numerals 808d through 808j (e.g., corresponding to the 4 o'clock through 10 o'clock hours are visible), with 808g being the middle (e.g., and deepest) number, because the time is 7:00.

In some embodiments, the changes to the apparent depth and/or visible numbers are gradual. For example, in some embodiments, computer system 600 displays the transition from hour numeral 808f (e.g., corresponding to 6 o'clock) being deepest to hour numeral 808g (e.g., corresponding to 7 o'clock) being deepest over the course of an hour. In some embodiments, at the halfway point (e.g., 6:30), two hour numerals (e.g., hour numerals 808f and 808g) appear to have the same depth.

In some embodiments, computer system 600 displays hour numerals 808 with simulated parallax. In some embodiments, computer system 600 displays hour numerals 808 with simulated dimensional features that change based on the position of user 890. For example, in FIG. 8D, user 890 is standing to the left of computer system 600. As shown in user interface 800d, hour numerals 808 have a visible side wall on the right side of hour numerals 808 because user 890 is standing on the left side of computer system 600 (e.g., for recessed elements, the right side wall is visible when user 890 is to the left of computer system 600).

In FIG. 8E, user is standing to the right of computer system 600. As shown in user interface 800e, hour numerals 808 have a visible side wall on the left of hour numerals 808 because user 890 is standing on the right side of computer system 600 (e.g., for recessed elements, the left side wall is visible when user 890 is to the right of computer system 600). In some embodiments, the amount of visible side wall changes as user 890 moves further to one side. In some embodiments, user 890 can select from a variety of options for how a respective user interface is displayed. In some embodiments, computer system 600 displays a settings menu, as shown in user interface 800f, in response to a user input, such as press and hold input 854 shown in FIG. 8E.

In some embodiments, user 890 can select a style for how hour numerals 808 appear, such as hour hand depth, minute hand depth, and/or full depth styles. In some embodiments, when hour hand depth option 820 is selected, computer system 600 displays hour numerals 808 with a depth based on the position of hour hand 806a, as discussed above with respect to FIGS. 8D and 8E. In some embodiments, computer system 600 displays user interface 800g, as illustrated in FIG. 8G, in response to swipe input 856 shown in FIG. 8F. In some embodiments, when minute hand depth option 822 is selected, computer system 600 displays hour numerals 808 with a depth based on the position of minute hand 806b.

In some embodiments, computer system 600 displays user interface 800h, as illustrated in FIG. 8H, in response to swipe input 858 in FIG. 8G. In some embodiments, when full depth option 824 is selected, computer system 600 displays all twelve hour numerals 808 with a consistent depth for all numerals. In some embodiments, user 890 can select a style (e.g., cause computer system 600 to exit the menu and apply the style to the respective user interface) by providing an input directed to the style label, as illustrated by input 862 directed to full depth option 824 in FIG. 8H.

In some embodiments, user 890 can select a mode, such as dark mode, night mode, light mode, and/or auto mode. In some embodiments, computer system 600 displays the mode options in response to swipe input 860 in user interface 800h. In some embodiments, when auto mode is selected, computer system 600 detects the ambient light conditions and displays the respective user interface with an appearance (e.g., the appearance corresponding to light mode, dark mode, and/or night mode) based on an amount of detected ambient light. In some embodiments, when the light mode option is selected, computer system 600 displays the respective user interface with a light and/or bright appearance, as illustrated by user interfaces 800b through 800e.

In some embodiments, computer system 600 displays the dark mode option 828 in response to swipe input 864 in user interface 800i, as illustrated in FIG. 8I. In some embodiments, when in dark mode, computer system 600 displays the respective user interface with a dimmer and/or darker appearance than the light mode option, as illustrated by user interface 800j in FIG. 8J. In some embodiments, while in dark mode, clock hands 806 appear to emit and/or reflect light, as illustrated in user interface 800j. In some embodiments, clock hands 806 appear to emit a brighter and/or more intense light while in night mode (e.g., as compared with dark mode).

In some embodiments, user 890 can select a color scheme for the respective user interface. In some embodiments, computer system 600 displays the color options in response to swipe input 866 in user interface 800j in FIG. 8J. For example, computer system 600 displays purple color option 830 in user interface 800k shown in FIG. 8K. In some embodiments, user 890 can select a color (e.g., cause computer system 600 to exit the menu and apply the color to the respective user interface) by providing an input, such as input 868 directed to purple color option 830 shown in FIG. 8K.

In some embodiments, computer system 600 displays a different color option in response to an input directed to a color option, such as input 870 directed to color option 832. In some embodiments, computer system 600 displays a different color option in response to swipe input 872 in user interface 800k shown in FIG. 8K. For example, computer system 600 displays a different color option in user interface 800l, as shown in FIG. 8L.

In some embodiments, the color scheme for the respective user interface corresponds to the color of a housing and/or external physical element of computer system 600. In some embodiments, user 890 can select an option to display the respective user interface with a color scheme that corresponds to the color of a housing and/or external physical element of computer system 600. For example, as shown in FIG. 8L, computer system 600 displays user interface 800l with housing color option 834.

FIG. 9 is a flow diagram illustrating a method for displaying a user interface based on lighting angle using a computer system in accordance with some embodiments. Method 900 is performed at a computer system (e.g., 100, 300, 500, 600, a smartspeaker, a head-mounted device, a smartwatch, a smartphone, a tablet computer, a laptop computer, and/or a desktop computer) that is in communication with one or more display generation components (e.g., 602, a display controller, a display, a touch-sensitive display system, a touchscreen, a head-mounted display, and/or a monitor) and one or more input devices (e.g., 602, 604, 606, a touch-sensitive surface, a touchscreen display, a button, a keyboard, a mouse, a joystick, a camera sensor, a light sensor, a motion sensor, and/or a microphone). Some operations in method 700 are, optionally, combined, the orders of some operations are, optionally, changed, and some operations are, optionally, omitted.

As described below, method 900 provides an intuitive way for displaying a user interface based on lighting angle. The method reduces the cognitive burden on a user for displaying a user interface based on lighting angle, thereby creating a more efficient human-machine interface. For battery-operated computing devices, enabling a user to display a user interface based on lighting angle faster and more efficiently conserves power and increases the time between battery charges.

The computer system detects (902), via the one or more input devices, an event (e.g., 850a, 850b, a set of one or more inputs, gestures, and/or voice commands, movement of a user of the computer system, and/or the arrival of a user of the computer system at the location of the computer system) corresponding to a request to display a respective user interface (e.g., 800b, a time user interface, a user interface that includes a digital and/or analog indication of time, a clock face, a wake screen, and/or a home screen).

In some embodiments, in response to detecting the event, the computer system displays (904), via the one or more display generation components, the respective user interface having a respective appearance (e.g., simulated depth and/or dimensionality) based on a detected direction of ambient light, including: in accordance with a determination that the detected direction of ambient light is a first direction (e.g., 892), displaying (906), via the one or more display generation components, the respective user interface having a first appearance (e.g., 800b) (e.g., the respective appearance is the first appearance). In some embodiments, the computer system detects (e.g., via the one or more input devices) a direction of ambient light (e.g., a primary direction of light surrounding the computer system). In some embodiments, the computer system identifies a principal light source and detects a direction of the principal light source relative to the computer system.

In some embodiments, in response to detecting the event, the computer system displays (904), via the one or more display generation components, the respective user interface having a respective appearance (e.g., simulated depth and/or dimensionality) based on a detected direction of ambient light, including: in accordance with a determination that the detected direction of ambient light is a second direction (e.g., 894) that is different from the first direction, displaying (908), via the one or more display generation components, the respective user interface having a second appearance (e.g., 800c) that is different from the first appearance (e.g., the respective appearance is the second appearance). In some embodiments, the respective appearance includes simulated highlights and/or shadows that correspond to the detected direction of ambient light. In some embodiments, one or more features of the respective user interface appear to be raised and/or indented (e.g., recessed) based on virtual lighting effects that correspond to the detected direction of ambient light. In some embodiments, the respective user interface appears to be three-dimensional and the ambient light appears to be shining on the three-dimensional features.

Displaying the respective user interface having a respective appearance based on a detected direction of ambient light provides feedback regarding the detected direction of ambient light, thereby providing the user with improved visual feedback. Displaying the respective user interface having a respective appearance based on a detected direction of ambient light in response to detecting an event corresponding to a request to display a respective user interface enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, while displaying the respective user interface having the respective appearance based on the detected direction of ambient light, the computer system detects, via the one or more input devices, a change in direction of the ambient light (e.g., from the first direction to a third direction or from the second direction to a third direction). In some embodiments, in response to detecting the change in direction of the ambient light (e.g., 896), the computer system displays, via the one or more display generation components, the respective user interface having a third appearance (e.g., 800d) that is different from the respective appearance (e.g., change the appearance of the respective user interface). In some embodiments, the difference between the respective appearance and the third appearance (e.g., the magnitude of the change in appearance) is based on (e.g., directly proportional to) the magnitude of the change in direction of the ambient light. Displaying the respective user interface having a third appearance in response to detecting the change in direction of the ambient light provides feedback regarding the detected change in direction of the ambient light, thereby providing the user with improved visual feedback. Displaying the respective user interface having a third appearance in response to detecting the change in direction of the ambient light enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, while displaying the respective user interface having the respective appearance based on the detected direction of ambient light, the computer system detects, via the one or more input devices a change in amplitude (e.g., 896) (or, in some embodiments, magnitude of light intensity and/or brightness) of ambient light. In some embodiments, in response to detecting the change in amplitude of the ambient light, the computer system displays, via the one or more display generation components, the respective user interface having a fourth appearance (e.g., 800d) that is different from the respective appearance (e.g., change the appearance of the respective user interface). In some embodiments, the difference between the respective appearance and the fourth appearance (e.g., the magnitude of the change in the appearance) is based on (e.g., directly proportional to) the magnitude of the change in the amplitude of the ambient light. Displaying the respective user interface having a fourth appearance in response to detecting the change in amplitude of the ambient light provides feedback regarding the detected change in amplitude of the ambient light, thereby providing the user with improved visual feedback. Displaying the respective user interface having a fourth appearance in response to detecting the change in direction of the ambient light enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, the detected direction of the ambient light is based on (e.g., corresponds to) a detected direction of a primary light source (e.g., 892, the brightest light source, the strongest light source, and/or the nearest light source relative to the computer system). In some embodiments, the computer system selects the primary light source from among multiple light sources in the environment surrounding the computer system. In some embodiments, a direction of the primary light source is selected as the direction of ambient light impacting the appearance of the respective user interface. In some embodiments, an amplitude of the primary light source is selected as the amplitude of ambient light impacting the appearance of the respective user interface. Displaying the respective user interface having a respective appearance based on a detected direction of a primary light source provides feedback regarding the detected direction of the primary light source.

In some embodiments, displaying the respective user interface having the respective appearance includes: in accordance with a determination that a characteristic (e.g., direction, angle, amplitude, and/or confidence level regarding a lighting parameter) of the ambient light is below a predetermined threshold, displaying, via the one or more display generation components, the respective user interface having the respective appearance based on a default light source (e.g., a simulated light source, a default light direction, and/or a default amplitude of light). For example, the respective appearance corresponds to a default appearance that is based on the default light source. Displaying the respective user interface having the respective appearance based on a default light source in accordance with a determination that a characteristic of the ambient light is below a predetermined threshold provides feedback regarding whether the ambient light is below the predetermined threshold, thereby providing the user with improved visual feedback. Displaying the respective user interface having the respective appearance based on a default light source in accordance with a determination that a characteristic of the ambient light is below a predetermined threshold enables the computer system to provide a more varied user experience without requiring additional inputs from the user to change the appearance of the user interface, thereby performing an operation when a set of conditions has been met without requiring further user input and reducing the number of inputs needed to perform an operation.

In some embodiments, displaying the respective user interface having the respective appearance includes: in accordance with a determination that the characteristic of the ambient light is above the predetermined threshold, the computer system displays, via the one or more display generation components, the respective user interface having the respective appearance based on the default light source and the ambient light. For example, the respective appearance corresponds to a combination of the default appearance that is based on the default light source and an appearance that is based on the ambient light source. Displaying the respective user interface having the respective appearance based on the default light source and the ambient light in accordance with a determination that the characteristic of the ambient light is above the predetermined threshold provides feedback regarding whether the ambient light is above the predetermined threshold. Displaying the respective user interface having the respective appearance based on the default light source and the ambient light in accordance with a determination that the characteristic of the ambient light is above the predetermined threshold enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, displaying the respective user interface includes displaying, via the display generation component, the respective user interface with one or more visually recessed elements (e.g., 808) (e.g., one or more graphical elements that appear to be recessed relative to a surface of the respective user interface). For example, in some embodiments, the respective user interface includes simulated engraving (e.g., simulated engraved elements and/or elements having a visual appearance of engraving). In some embodiments, the respective user interface includes simulated dimensionality (e.g., depth). In some embodiments, simulated engraving is shown by simulated surfaces and/or side walls. Displaying the respective user interface with one or more visually recessed elements distinguishes between different elements in the respective user interface, thereby providing improved visual feedback.

In some embodiments, the respective user interface includes simulated shadows that are based on the detected direction of ambient light and the one or more visually recessed elements (e.g., as illustrated by the shadows in hour numerals 808). In some embodiments, the simulated shadows simulate features and/or elements of the respective user interface that simulate blocking ambient light. Displaying the respective user interface with simulated shadows that are based on the detected direction of ambient light provides feedback regarding the detected direction of ambient light, thereby providing the user with improved visual feedback. Displaying the respective user interface with simulated shadows that are based on the detected direction of ambient light enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, the simulated shadows change based on a location (e.g., position and/or proximity) of a detected person (e.g., 690) (e.g., with respect to the computer system and/or one or more input devices that are in communication with the computer system). In some embodiments, features (e.g., side walls) of simulated engraved elements appear differently based on the location of the detected person (e.g., different surfaces and/or sidewalls become visible and/or appear differently). In some embodiments, the computer system detects a change in location of the detected person. In some embodiments, in response to detecting the change in location of the detected person, the computer system changes the simulated shadows based on (e.g., in coordination with) the detected change in location of the detected person. Displaying the user interface with simulated shadows that change based on the location of the detected person provides feedback regarding the detected location of the person, thereby providing the user with improved visual feedback. Displaying the user interface with simulated shadows that change based on the location of the detected person enables the computer system to update the appearance of the user interface to reflect the presence of a person and provide a more varied user experience without requiring additional inputs from the user to change the appearance of the user interface, thereby performing an operation when a set of conditions has been met without requiring further user input and reducing the number of input needed to perform an operation.

In some embodiments, at a first time, the computer system displays, via the one or more display generation components, the respective user interface with the one or more visually recessed elements (or, in some embodiments, a portion of the one or more visually recessed elements relative to a surface of the respective user interface) having a first simulated depth (e.g., how far recessed and/or depressed the simulated engraving appears) (e.g., as illustrated by the depth of hour numerals 808 in FIG. 8C). In some embodiments, at a second time, the computer system displays, via the one or more display generation components, the respective user interface with the one or more visually recessed elements (or, in some embodiments, a portion of the one or more visually recessed elements relative to a surface of the respective user interface) having a second simulated depth that is different from the first simulated depth (e.g., as illustrated by the depth of hour numerals 808 in FIG. 8D). Displaying the respective user interface with one or more visually recessed elements having a first simulated depth at a first time and displaying the respective user interface with one or more visually recessed elements having a second simulated depth at a second time provides visual feedback regarding the time, thereby providing the user with improved visual feedback. Displaying the respective user interface with one or more visually recessed elements having a first simulated depth at a first time and displaying the respective user interface with one or more visually recessed elements having a second simulated depth at a second time adjusts the appearance of the user interface based on the time of day without requiring user input, thereby performing an operation when a set of conditions has been met without requiring further user input and reducing the number of inputs needed to perform an operation.

In some embodiments, the one or more visually recessed elements change (e.g., continuously, gradually, and/or steadily) over time (e.g., as time passes) from having the first simulated depth to having the second simulated depth (e.g., as illustrated by the changes in depth of hour numerals 808 from the depths shown in FIG. 8C to the depths shown in FIG. 8D). Displaying the respective user interface with one or more visually recessed elements that change over time from having the first simulated depth to having the second simulated depth provides feedback regarding the change in time, thereby providing the user with improved visual feedback. Displaying the respective user interface with one or more visually recessed elements that change over time adjusts the appearance of the user interface based on the time without requiring user input, thereby performing an operation when a set of conditions has been met without requiring further user input and reducing the number of inputs needed to perform an operation.

In some embodiments, the change in the one or more visually recessed elements from the first simulated depth to the second simulated depth corresponds to movement of one or more clock hands (e.g., 806, an hour, minute, and/or seconds hand). In some embodiments, simulated engraving precedes (e.g., extends in front of) and/or succeeds (e.g., extends behind) a clock hand. Displaying the respective user interface with a change in one or more visually recessed elements that correspond to movement of a clock hand provides feedback regarding the movement of the clock hand and the passing of time, thereby providing the user with improved visual feedback. Displaying the respective user interface with a change in one or more visually recessed elements that correspond to movement of a clock hand adjusts the appearance of the user interface based on movement of the clock hand without requiring user input, thereby performing an operation when a set of conditions has been met without requiring further user input and reducing the number of inputs needed to perform an operation.

In some embodiments, the one or more visually recessed elements include a first symbol (e.g., 808c, a character and/or a numeral on a watch face) and a second symbol (e.g., 808d), and wherein a simulated depth of the first symbol is different from a simulated depth of the second symbol. In some embodiments, the first symbol has a simulated depth that appears deeper than the second symbol. In some embodiments, the simulated depths of the first symbol and the second symbol vary within a respective symbol and the average simulated depth of the first symbol is different from the average simulated depth of the second symbol. Displaying the respective user interface with a first symbol and a second symbol with different simulated depths distinguishes between the first symbol and the second symbol, thereby providing the user with improved visual feedback.

In some embodiments, the one or more visually recessed elements include a respective symbol (e.g., 808c, a character and/or a numeral on a watch face) and a simulated depth of the respective symbol varies within the respective symbol. In some embodiments, one portion (e.g., section, side, and/or half) of the respective symbol appears deeper than another portion of the respective symbol. In some embodiments, the depth of the simulated engraving appears to gradually increase (e.g., from no simulated engraving and/or zero depth) in one portion of the respective symbol to greater depth in another portion of the respective symbol (e.g., from one side of the symbol to an opposite side of the symbol). Displaying the respective user interface with a respective symbol that has a simulated depth that varies within the respective symbol distinguishes the symbol from other elements of the user interface, thereby providing the user with improved visual feedback.

In some embodiments, displaying the respective user interface with the one or more visually recessed elements includes: in accordance with a determination that a first depth option (e.g. 824) has been selected (e.g., by a user of the computer system, such as through a settings menu), displaying, via the one or more display generation components, the one or more visually recessed elements with an appearance of having a fixed depth (e.g., a consistent depth for the simulated engraving, as shown in 800h). In some embodiments, displaying the respective user interface with the one or more visually recessed elements includes: in accordance with a determination that a second depth option (e.g., 820 or 822) has been selected (e.g., by a user of the computer system, such as through a settings menu), displaying, via the one or more display generation components, the one or more visually recessed elements with a variable depth (e.g., different and/or varying depths in different portions of the simulated engraving, as shown in 800f or 800g). Displaying the one or more visually recessed elements with an appearance of having a fixed depth in accordance with a determination that the first depth option has been selected and displaying the one or more visually recessed elements with a variable depth in accordance with a determination that the second depth option has been selected displays the one or more visually recessed elements in a preferred format, thereby providing the user with an improved user experience and improved visual feedback.

In some embodiments, displaying the respective user interface includes: in accordance with a determination that a first color (e.g., 830) has been selected (e.g., by a user of the computer system, such as through a settings menu), displaying, via the one or more display generation components, the respective user interface having the first color (e.g., for one or more elements of the respective user interface, such as a background, a foreground element, and/or an indication of time) (e.g., 800k). In some embodiments, displaying the respective user interface having the first color includes displaying the respective user interface with a simulated first color and/or with an appearance that the respective user interface is the first color. Displaying the respective user interface having the first color in accordance with a determination that the first color has been selected displays the user interface in a preferred format, thereby providing the user with an improved user experience and improved visual feedback.

In some embodiments, displaying the respective user interface includes: displaying the respective user interface having a second color that is based on (e.g., coordinating with, matching, and/or the same as) a color of a housing (e.g., an enclosure and/or physical component) of the computer system (e.g., 8001). In some embodiments, displaying the respective user interface having a second color includes displaying the respective user interface with a simulated color corresponding to the color of the housing and/or with the appearance of the respective user interface being the color of the housing. Displaying the respective user interface having a second color that is based on a color of the housing of the computer system provides feedback regarding the color of the housing, thereby providing the user with improved visual feedback.

In some embodiments, displaying the respective user interface includes: in accordance with a determination that a color option corresponding to a color of a housing of the computer system (e.g., 834) has been selected (e.g., by a user of the computer system, such as through a settings menu) while (e.g., in accordance with a determination that) the color of the housing is a third color, displaying, via the one or more display generation components, the respective user interface having the third color. In some embodiments, displaying the respective user interface includes: in accordance with a determination that a color option corresponding to a color of a housing of the computer system (e.g., 834) has been selected (e.g., by a user of the computer system, such as through a settings menu) while (e.g., in accordance with a determination that) the color of the housing is a fourth color that is different from the third color, displaying, via the one or more display generation components, the respective user interface having the fourth color. Displaying the respective user interface having the third color while the color of the housing is a third color and displaying the respective user interface having the fourth color while the color of the housing is a fourth color in accordance with a determination that a color option corresponding to a color of a housing of the computer system has been selected provides feedback regarding the color of the housing, thereby providing the user with improved visual feedback.

In some embodiments, displaying the respective user interface includes displaying (e.g., in the respective user interface), via the one or more display generation components, one or more clock hands (e.g., 808) (e.g., indicating the current time). Displaying the respective user interface including one or more clock hands provides an indication of time, thereby providing the user with improved visual feedback. Displaying the user interface with one or more clock hands enables the user to view an indication of time without requiring the user to navigate to a different user interface to view the indication of time, thereby performing an operation when a set of conditions has been met without requiring further user input and reducing the number of inputs needed to perform an operation.

In some embodiments, the one or more clock hands have an appearance of a simulated glass material that responds to (e.g., appears transparent and/or semi-transparent with respect to, reveals, and/or refracts) simulated content (e.g., 808, 1014, 1020, 1210, simulated engraving, a dynamic element, and/or an image) underlying (e.g., appearing beneath) the one or more clock hands in the user interface. In some embodiments, the one or more clock hands have variable thickness (e.g., different portions with different thicknesses), such as curved edges. In some embodiments, portions of the one or more clock hands with variable thickness appear to refract and/or reflect light differently than portions of the one or more clock hands with uniform thickness. Displaying the one or more clock hands having an appearance of simulated glass that responds to simulated content underlying the one or more clock hands in the user interface provides feedback regarding the content underlying the one or more clock hands, thereby providing the user with improved visual feedback.

In some embodiments, displaying the one or more clock hands includes: displaying, via the one or more display generation components, the one or more clock hands with simulated parallax (e.g., with an effect of having a different appearance and/or an observed displacement that changes) based on the position of a detected person (e.g., 890). In some embodiments, the appearance of the one or more clock hands respond to (e.g., change appearance based on) movement of a detected person (e.g., a change in position and/or proximity of the person with respect to the computer system). In some embodiments, the size and/or shape of the one or more clock hands appears to change based on movement of the detected person. In some embodiments, different portions and/or aspects (e.g., different surfaces and/or sides) of the one or more clock hands appear to change (e.g., become visible or hidden and/or change is size and/or depth) based on movement of the detected person. Displaying the one or more clock hands with simulated parallax based on the position of the detected person provides feedback regarding the detected position of the person, thereby providing the user with improved visual feedback. Displaying the one or more clock hands with simulated parallax based on the position of the detected person enables the computer system to update the appearance of the user interface to reflect the presence of a person and provide a more varied user experience without requiring additional inputs from the user to change the appearance of the user interface, thereby performing an operation when a set of conditions has been met without requiring further user input and reducing the number of input needed to perform an operation.

In some embodiments, displaying the one or more clock hands includes: displaying, via the one or more display generation components, the one or more clock hands with simulated shadows (or, in some embodiments, lighting effects) (e.g., the shadows shown below and to the right of clock hands 806 in FIG. 8B) based on the position of a detected person. In some embodiments, the appearance of simulated lighting cast on the one or more clock hands respond to (e.g., change appearance based on) movement of a detected person (e.g., a change in position and/or proximity of the person with respect to the computer system). In some embodiments, simulated shadows from the one or more clock hands change size (e.g., become larger or smaller), shade (e.g., become lighter or darker), and/or position (e.g., from one side to another side) based on movement of the detected person, movement of the one or more clock hands, a change in detected and/or simulated lighting (e.g., direction, brightness, and/or intensity of the simulated lighting), or a combination thereof. In some embodiments, highlights and/or reflections on the one or more clock hands appear to change (e.g., brightness, intensity, and/or position) based on movement of the detected person. Displaying the one or more clock hands with simulated shadows based on the position of the detected person provides feedback regarding the detected position of the person, thereby providing the user with improved visual feedback. Displaying the one or more clock hands with simulated shadows based on the position of the detected person enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, in accordance with a determination that the ambient light is greater than a first threshold level (or, in some embodiments, greater than or equal to), the computer system displays, via the one or more display generation components, the respective user interface having a first light-level-based appearance (e.g., a light mode and/or an appearance with a lighter and/or brighter background, such as the appearance shown in FIGS. 8B through 8E). In some embodiments, in accordance with a determination that the ambient light is less than the first threshold level (or, in some embodiments, less than or equal to), displaying, via the one or more display generation components, the respective user interface having second light-level-based appearance (e.g., a dark mode and/or an appearance with darker and/or dimmer background, such as the appearance shown in FIG. 8J). Displaying the respective user interface having a first light-level-based appearance in accordance with a determination that the ambient light is greater than a first threshold level and displaying the respective user interface having a second light-level-based appearance in accordance with a determination that the ambient light is less than a first threshold level provides feedback regarding whether the ambient light is above or below the first threshold level, thereby providing the user with improved visual feedback. Displaying the respective user interface having a first light-level-based appearance in accordance with a determination that the ambient light is greater than a first threshold level and displaying the respective user interface having a second light-level-based appearance in accordance with a determination that the ambient light is less than a first threshold level enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, displaying the respective user interface having the second light-level-based appearance includes displaying, via the one or more display generation components, one or more clock hands (e.g., 808) with the appearance of emitting (or, in some embodiments, reflecting) light (e.g., a simulated glow, as illustrated in user interface 800j of FIG. 8J), wherein the second light-level-based appearance includes an appearance of emitting (or, in some embodiments, reflecting) more light than in the first light-level-based appearance. In some embodiments, the first light level-based appearance includes displaying the one or more clock hands with the appearance of emitting less light (e.g., a dimmer simulated glow) than in the second light-level-based appearance. In some embodiments, the first light-level-based appearance includes displaying the one or more clock hands with the appearance of emitting no light (e.g., without a simulated glow). Displaying the respective user interface having the second light-level-based appearance with one or more clock hands with the appearance of emitting light provides feedback that the ambient light is below the first threshold level, thereby providing the user with improved visual feedback. Displaying the respective user interface with one or more clock hands with the appearance of emitting light when the ambient light is below the first threshold makes it easier for a user to see the one or more clock hands within the respective user interface, thereby providing the user with improved visual feedback. Displaying the respective user interface with one or more clock hands with the appearance of emitting light when the ambient light is below the first threshold enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

In some embodiments, in accordance with a determination that the ambient light is less than (or, in some embodiments, less than or equal to) a second threshold level that is different from the first threshold level, the computer system displays, via the one or more display generation components, the respective user interface having a third-light level-based appearance (e.g., a night mode and/or an appearance that includes a brighter simulated glow) that is different from the first light-level-based appearance and the second light-level-based appearance, wherein the third light-level-based appearance includes an appearance of emitting (or, in some embodiments, reflecting) more light than the second light-level-based appearance. Displaying the respective user interface having a third light-level-based appearance in accordance with a determination that the ambient light is less than the second threshold level provides feedback that the ambient light is less than the second threshold level, thereby providing the user with improved visual feedback. Displaying the respective user interface having a third light-level-based appearance in accordance with a determination that the ambient light is less than the second threshold level enables the computer system to update the appearance of the user interface to reflect the conditions of the ambient light and provide a more varied user experience without requiring additional inputs from the user to change the appearance of the user interface, thereby performing an operation when a set of conditions has been met without requiring further user input and reducing the number of inputs needed to perform an operation.

FIGS. 10A-10P2 illustrate exemplary user interfaces based on a position of a user, in accordance with some embodiments. The user interfaces in these figures are used to illustrate the processes described below, including the processes in FIG. 11.

In FIG. 10A, computer system 600 displays user interface 1000a on display 602. In some embodiments, computer system 600 displays a respective user interface, such as user interface 1000a, in response to detecting an event corresponding to a request to display the respective user interface (e.g., as described with respect to FIG. 8A). In the example shown in FIG. 10A, user interface 1000a includes element 1010 (e.g., a complication, an application icon, a dynamic user interface element, and/or a selectable user interface element) and indication of time 1012, which are displayed with background image 1014.

In some embodiments, a complication is a user-selectable graphical user interface object that displays information from a corresponding application. For example, as shown in FIG. 10A, element 1010 is a complication that indicates the date (e.g., Tuesday the 7th) and the current weather conditions (e.g., 72 degrees and sunny). In some embodiments, computer system 600 displays a corresponding application in response to an input directed to element 1010, such as input 1050 (e.g., a tap input, air tap input, gaze dwell input, and/or other selection input). For example, in some embodiments, computer system 600 displays a weather application in response to input 1050.

In some embodiments, computer system 600 identifies a subject in the displayed image. For example, in FIG. 10A, computer system 600 identifies subject 1014a in background image 1014. In some embodiments, computer system 600 segments (e.g., separates) the identified subject from the remainder of the image. For example, in FIG. 10A, computer system 600 separates subject 1014a from remainder 1014b. In some embodiments, computer system 600 displays indication of time 1012 with the appearance of being between subject 1014a and remainder 1014b. In some embodiments, subject 1014a appears to be in front of indication of time 1012. In some embodiments, remainder 1014b appears to be behind subject 1014a and indication of time 1012.

In some embodiments, computer system 600 displays one or more elements of the respective user interface with simulated dimensional features. For example, element 1010 and indication of time 1012 appear to protrude from user interface 1000a. In some embodiments, element 1010 and indication of time 1012 have simulated surfaces and/or sidewalls, as discussed in more detail with respect to FIG. 8B. In some embodiments, element 1010 and indication of time 1012 have the appearance of casting simulated shadows, as discussed in more detail with respect to FIG. 8B.

In some embodiments, computer system 600 displays one or more elements of the respective user interface with simulated material properties. In some embodiments, computer system 600 displays one or more elements of the respective user interface with an appearance of being made of glass. For example, in FIG. 10A, element 1010 and indication of time 1012 have a simulated glass-like appearance. In some embodiments, computer system 600 displays the glass-like elements of the respective user interface with the appearance of being transparent or semi-transparent (e.g., with respect to the displayed image and/or the remainder of the image). For example, in some embodiments, remainder 1014b seems to be visible or partially visible through indication of time 1012.

In some embodiments, the appearance of simulated glass includes simulated refraction, as discussed in more detail with respect to FIGS. 10K and 10L. In some embodiments, the glass-like appearance includes a simulated reflection of a user, as discussed in more detail with respect to FIG. 6C. In some embodiments, the glass-like appearance includes a simulated sheen (e.g., sheen 1016), as discussed in more detail with respect to FIGS. 10M1 through 10M3. In some embodiments, the appearance of simulated glass includes simulated specular highlights (e.g., highlights 1018), as discussed in more detail with respect to FIGS. 10N1 and 10N2 and FIGS. 10O1 through 10O3.

In some embodiments, the appearance of the simulated features is based on a simulated light source (e.g., a default light source). In some embodiments, the appearance of the simulated features is based on a detected light source, as discussed in more detail with respect to FIG. 6A. In some embodiments, the appearance of the simulated features is based on a combination of simulated light and detected light.

In some embodiments, computer system 600 detects the position of a user relative to computer system 600, as discussed in more detail with respect to FIG. 6C. In some embodiments, computer system 600 displays the respective user interface with a visual effect that changes based on the position of a user. For example, in some embodiments, computer system 600 animates the appearance of the simulated dimensional features and/or simulated material properties based on the movement of a user.

In some embodiments, computer system 600 displays user interface 1000a having an appearance based on a position of user 1090. For example, as illustrated in FIG. 10A, user 1090 is positioned to the right of computer system 600. As shown in FIG. 10A, computer system 600 displays the visual effect (e.g., the simulated sheen and simulated specular highlights) in a first manner, as shown in user interface 1000a, based on the position of user 1090 to the right of computer system 600.

Various features and/or examples of computer system 600, user interface 1000a, and/or other user interfaces described herein, are described using the example of a tablet computer, as shown in FIG. 10A. In some embodiments, the user interfaces displayed by computer system 600 are implemented on and/or displayed by HMD 6000, depicted in FIG. 10A1. In FIG. 10A1, HMD 6000 includes display generation component 6002, and user interface 1000a is displayed as a virtual window or widget (such as world-locked or environment-locked object that is displayed with an appearance that maintains a fixed location in the world or environment as the viewpoint of the user moves) within a three-dimensional augmented reality or virtual reality environment. In some embodiments, user interface 1000a is displayed within three-dimensional environment 6010 (e.g., a virtual passthrough environment or optical passthrough environment). In some embodiments in which computer system 600 is a head-mounted system (e.g., HMD 6000), computer system 600 optionally includes two displays (e.g., one for each eye of a user), with each display displaying respective various content, to enable a user of computer system 600 to perceive the various depths of the various content (e.g., physical objects and/or virtual objects) of the three-dimensional environments. For example, in some embodiments, display generation component 6002 displays content for a left eye of the user, and a separate display generation component displays content for a right eye of the user. In some embodiments, user inputs directed to computer system 600 are shown and/or described as particular types of inputs (e.g., touch inputs and/or button press inputs). In various embodiments, other types of user inputs are used. For example, in some embodiments, gaze inputs and/or air gesture inputs are used to interact with computer system 600, user interface 1000a, and/or other user interfaces described herein.

In some embodiments, in response to detecting a first change in position of user 1090, computer system 600 displays the respective user interface having a first updated appearance. For example, as illustrated in FIG. 10B, user 1090 is positioned to the left of computer system 600, as indicated by the diagram in FIG. 10B. As shown in FIG. 10B, computer system 600 displays the visual effect (e.g., the simulated sheen and specular highlights) in a first updated manner, as shown in user interface 1000b, based on the position of user 1090 to the left of computer system 600. As illustrated by FIGS. 10A and 10B, the simulated sheen (e.g., sheen 1016) and simulated specular highlights (e.g., highlights 1018) appear in different locations in user interface 1000a than in user interface 1000b based on the change in position of user 1090.

In some embodiments, in response to detecting a second change in position of user 1090 that is different from the first change, computer system 600 displays the respective user interface having a second updated appearance. For example, as illustrated in FIG. 10C, user 1090 is positioned in front of computer system 600, as indicated by the diagram in FIG. 10C. As shown in FIG. 10C, computer system 600 displays the visual effect (e.g., the simulated sheen and specular highlights) in a second updated manner, as shown in user interface 1000c, based on the position of user 1090 centered in front of computer system 600. As illustrated by FIGS. 10A and 10C, the simulated sheen (e.g., sheen 1016) and simulated specular highlights (e.g., highlights 1018) appear in different locations in user interface 1000a than in user interface 1000c based on the second change in position of user 1090.

In some embodiments, computer system 600 applies the visual effect (e.g., simulated dimensionality and/or simulated material properties) to one portion of the respective user interface without applying the visual effect to another portion of the respective user interface. For example, in FIGS. 10A through 10C, computer system 600 displays element 1010 and indication of time 1012 with visual effects that change based on the position of user 1090, and computer system 600 displays subject 1014a and remainder 1014b without visual effects that change based on the position of user 1090.

In some embodiments, computer system 600 animates the changes in visual effect. In some embodiments, the relationship between the changes in visual effect and the changes in the position of a user is non-linear. In some embodiments, computer system 600 applies easing curves (e.g., a transition method that makes changes appear more natural and/or less pronounced) to relate the appearance of the visual effect and the movement of the user. In some embodiments, computer system 600 applies simulated physics to relate the appearance of the visual effect and movement of the user. For example, in some embodiments computer system 600 applies simulated spring physics to relate changes in the appearance of the respective user interface to changes in the position of the user. In some embodiments, computer system 600 displays changes corresponding to movement of a user in a slower and/or smaller manner at the beginning and/or end of the movement than in the middle of the movement.

In some embodiments, after a period of time (e.g., 5 second, 15 seconds, or 30 seconds), computer system 600 displays the respective user interface with an updated image (e.g., computer system 600 replaces background image 1014 with a different background image, such as background image 1020). In some embodiments, computer system 600 fades out one or more elements of the respective user interface from the respective user interface before and/or while transitioning from one background image to another background image. For example, in FIG. 10D, computer system 600 displays element 1010 and indication of time 1012 fading from user interface 1000d. In FIG. 10E, background image 1014 (e.g., both subject 1014a and remainder 1014b) remain visible, while element 1010 and indication of time 1012 have fully faded and are not visible in user interface 1000e.

In some embodiments, computer system 600 transitions from one background image to another background image via crossfade. For example, when transitioning from display of user interface 1000e in FIG. 10E to user interface 1000f in FIG. 10F, computer system 600 fades out background image 1014 out while simultaneously fading in background image 1020.

In some embodiments, computer system 600 fades in one or more elements of the respective user interface during and/or after changing the background image. For example, in FIG. 10G, computer system 600 displays element 1010 and indication of time 1012 fading in and becoming visible in user interface 1000g. As discussed with respect to FIG. 10A, in some embodiments, computer system 600 identifies subject 1020a in background image 1020, segments subject 1020a from remainder 1020b, and displays indication of time with the appearance of being between subject 1020a and remainder 1020b.

In some embodiments, when a respective condition is met, computer system 600 ceases changing the respective user interface (e.g., ceases changing the background image and/or ceases changing the visual effect). In some embodiments, the condition relates to a position of user 1090. In some embodiments, the condition is met if user 1090 is more than a threshold distance from computer system 600 and/or user 1090 is outside of a range of computer system 600 (e.g., based on an angle and/or distance of user 1090 relative to computer system 600). In some embodiments, the condition is met when computer system 600 does not detect (e.g., via camera sensor 606) user 1090.

In some embodiments, the condition is met when computer system 600 detects (e.g., via camera sensor 606) more than one user (e.g., user 1090 and another person) in the region surrounding computer system 600. For example, as shown in FIG. 10J, user 1092 enters the region surrounding computer system 600, and computer system 600 detects both user 1090 and user 1092.

In some embodiments, when computer system 600 ceases changing the respective user interface, computer system 600 displays a default appearance (e.g., an appearance based on default and/or simulated conditions, as shown in user interface 1000j of FIG. 10J). In some embodiments, when computer system 600 ceases changing the respective user interface, computer system 600 gradually transitions from a current appearance to a default appearance. For example, computer system 600 does not immediately change the respective user interface when computer system 600 detects both user 1090 and user 1092 in FIG. 10I. In some embodiments, computer system 600 gradually transitions from displaying user interface 1000i in FIG. 10I to displaying user interface 1000j (e.g., computer system 600 animates the change over time, such as 3 seconds).

In some embodiments, computer system 600 resumes changing the respective user interface when the condition ceases to be met. For example, computer system 600 resumes changing the respective user interface when computer system 600 detects only user 1090 (e.g., does not detect user 1092) in the region surrounding computer system 600.

In some embodiments, the change to the respective user interface includes one or more visual effects that simulate the appearance of glass material. For example, in some embodiments, computer system 600 displays elements of the respective user interface, such as element 1010 and indication of time 1012, with the appearance of being made of glass. In some embodiments, the appearance of the background affects how computer system 600 displays element 1010 and indication of time 1012 due to simulated transparency, simulated translucency, and/or simulated refraction.

In some embodiments, the glass-like elements of the respective user interface appear transparent. For example, in some embodiments, underlying content seems to be visible through the glass-like elements. For example, in some embodiments, a portion of the background image is visible within element 1010 and indication of time 1012.

In some embodiments, the glass-like elements of the respective user interface appear translucent. For example, in some embodiments, the underlying content appears generally visible within the glass-like elements, but the underlying content is partially obscured. For example, in FIG. 10K, the shape and color of the brick in background image 1020 are generally visible within indication of time 1012, but the details of the bricks are not visible and/or are blurred. Similarly, in FIG. 10L, the shape and color of the shrubs in background image 1014 are generally visible within indication of time 1012, but the details of the leaves are not visible and/or are blurred. In some embodiments, the colors of the background image appear muted within the glass-like elements.

In some embodiments, computer system 600 displays the glass-like elements of the respective user interface with simulated refraction. For example, in some embodiments, the underlying content is generally visible within the glass-like elements, but the underlying content is partially distorted. In some embodiments, computer system 600 changes the scale when displaying the underlying content. For example, in FIG. 10K, the brick wall that is visible within indication of time 1012 is a smaller scale compared to in the rest of background image 1020 (e.g., as illustrated by offset 1022). Similarly, in FIG. 10L, the shrubs that are visible within indication of time 1012 are a smaller scale as compared to the rest of background image 1014 (e.g., as illustrated by offset 1022).

In some embodiments, different portions of the simulated glass material include different degrees of change in scale of the underlying content. For example, in some embodiments, indication of time 1012 has a greater degree of change than element 1010. In some embodiments, the degree of change in scale is related to the simulated depth of an element of the respective user interface. For example, in some embodiments, indication of time 1012 appears to protrude out from display 602 more than element 1010 and indication of time 1012 has a greater degree of change in scale than element 1010.

In some embodiments, computer system 600 generates the appearance of indication of time based on the appearance of the background image. In some embodiments, computer system 600 generates the appearance of indication of time based on the appearance of the remainder of the background image, without including the identified subject. In some embodiments, computer system 600 generates content to fill in the area in the remainder where the subject was removed from the original image. For example, as illustrated in FIG. 10L, computer system 600 generates content to fill where subject 1014a was removed from background image 1014. In some embodiments, computer system 600 uses a generative machine learning (ML) process (e.g., inpainting) to generate the content. In some embodiments, computer system 600 uses a deterministic process (e.g., cloning or sampling nearby content) to generate the content.

In some embodiments, computer system 600 displays the glass-like elements of the respective user interface with a visual effect (e.g., a simulated sheen) that corresponds to the position of a user. In some embodiments, computer system 600 displays a visual effect that translates as a user changes position. For example, in some embodiments, a simulated sheen (e.g., reflection of light) translates in the x-direction as user 1090 changes position in the x-direction, as illustrated in FIGS. 10M1 through 10M3.

For example, in FIG. 10M1, user is to the left of computer system 600 and simulated sheen 1016 is on the left of indication of time 1012 (e.g., as shown within dotted oval 1016a) in user interface 1000m1. In FIG. 10M2, user is centered in front of computer system 600 and simulated sheen 1016 is in the center of indication of time 1012 in user interface 1000m2. In FIG. 10M3, user 1090 is to the right of computer system 600 and simulated sheen 1016 is on the right of indication of time 1012 in user interface 1000m3.

In some embodiments, computer system 600 displays the glass-like elements of the respective user interface with a visual effect (e.g., a simulated specular highlight) that corresponds to the position of a user and the position of a light source. In some embodiments, computer system 600 displays a visual effect that changes in the x-direction and the y-direction as a user and/or a light source change position in the x-direction and the y-direction. In some embodiments, computer system 600 displays a simulated specular highlight (e.g., a highlight visible on a surface that is normal to a position halfway between the light source and the user) that changes in the x-direction and the y-direction based on the position of the light source and the user.

For example, as illustrated in FIGS. 10N1 and 10N2, highlights 1018 change in the y-direction as a light source changes position in the y-direction. FIG. 10N1 depicts light 1094 above user 1090. FIG. 10N1 indicates the horizontal edges on which specular highlights appear on indication of time 1012 (e.g., corresponding to cross section 1024), based on the positions of user 1090 and light 1094 shown. As shown in FIG. 10N1, highlights 1018 appear along the upper edges of indication of time 1012 based on the position of light 1094 being above user 1090.

FIG. 10N2 depicts light 1096 below user 1090. FIG. 10N2 indicates the horizontal edges on which specular highlights appear on indication of time 1012 (e.g., corresponding to cross section 1024), based on the positions of user 1090 and light 1094 shown. As shown in FIG. 10N2, highlights 1018 appear along the lower edges of indication of time 1012 based on the position of light 1096 being below user 1090.

As illustrated in FIGS. 10O1 through 10O3, highlights 1018 change in the x-direction as a user changes position in the x-direction. FIG. 10O1 depicts user 1090 to the left of light 1094. FIG. 10O1 indicates the vertical edges on which specular highlights appear on indication of time 1012 (e.g., corresponding to cross section 1026), based on the position of user 1090 to the left of light 1094 as shown. FIG. 10O2 depicts user 1090 aligned with light 1094. FIG. 1002 indicates the vertical edges on which specular highlights appear on indication of time 1012 (e.g., corresponding to cross section 1026) based on the position of user 1090 aligned with light 1094 as shown. FIG. 10O3 depicts user 1090 to the right of light 1094. FIG. 10O3 indicates the vertical edges on which specular highlights appear on indication of time 1012 (e.g., corresponding to cross section 1026) based on the position of user 1090 to the right of light 1094 as shown.

In some embodiments, computer system 600 displays elements of the respective user interface with simulated glass-like material overlaid on an animated background. For example, in some embodiments, the simulated glass-like material is overlaid on an animation of current weather conditions. For example, in FIGS. 10P1 and 10P2, indication of time 1012 is overlaid on an animation of falling rain 1028. As illustrated in FIGS. 10P1 and 10P2, the animation changes over time (e.g., the rain increases).

In some embodiments, the simulated glass-like material is overlaid on an animation that changes based on movement of a user. For example, in some embodiments, the simulated glass-like material is overlaid on a dynamic element that changes shape, size, and/or position based on changes in position of the user, as discussed in more detail with respect to FIGS. 12A through 12K.

FIG. 11 is a flow diagram illustrating a method for displaying a user interface based on a position of a user using a computer system in accordance with some embodiments. Method 1100 is performed at a computer system (e.g., 100, 300, 500, 600, a smart speaker, a head-mounted device, a smartwatch, a smartphone, a tablet computer, a laptop computer, and/or a desktop computer) that is in communication with one or more display generation components (e.g., 602, a display controller, a display, a touch-sensitive display system, a touchscreen, a head-mounted display, and/or a monitor) and one or more input devices (e.g., 602, 604, 606, a touch-sensitive surface, a touchscreen display, a button, a keyboard, a mouse, a joystick, a camera sensor, a light sensor, a motion sensor, and/or a microphone). Some operations in method 700 are, optionally, combined, the orders of some operations are, optionally, changed, and some operations are, optionally, omitted.

As described below, method 1100 provides an intuitive way for displaying a user interface based on a position of a user. The method reduces the cognitive burden on a user for displaying a user interface based on a position of a user, thereby creating a more efficient human-machine interface. For battery-operated computing devices, enabling a user to display a user interface based on a position of a user faster and more efficiently conserves power and increases the time between battery charges.

The computer system displays (1102), via the one or more display generation components, a user interface (e.g., 1000a, a time user interface, a user interface that includes a digital and/or analog indication of time, a clock face, a wake screen, and/or a home screen) with a visual effect (e.g., 1016, 1018, a simulated lighting effect and/or a simulated depth effect having a first value, magnitude, and/or characteristic) with a first appearance (e.g., the appearance shown in FIG. 10A). In some embodiments, the computer system detects (1104), via the one or more input devices, a change in position (e.g., location, orientation, and/or proximity) of a person (e.g., 1090 and/or a user of the computer system) relative to the one or more display generation components. In some embodiments, the change in position of the person includes the person moving side to side, up, down, closer to and/or further away from the computer system. In some embodiments, the change in position of the person includes the person moving out of range of the computer system (e.g., where the computer system can no longer detect the presence of the person).

In some embodiments, in response to detecting the change in the position of the person relative to the one or more display generation components, the computer system displays (1106), via the one or more display generation components, the user interface with a change in the visual effect, wherein: in accordance with a determination that the change in position of the person is a first change (e.g., a change from the position shown in FIG. 10A to the position shown in FIG. 10C), displaying (1108) the change in the visual effect includes displaying the visual effect with a first updated appearance (e.g., the appearance shown in FIG. 10C) that is different from the first appearance. In some embodiments, displaying the visual effect with a first updated appearance includes changing, animating, and/or moving an element of the user interface in a first manner.

In some embodiments, in response to detecting the change in the position of the person relative to the one or more display generation components, the computer system displays (1106), via the one or more display generation components, the user interface with a change in the visual effect (e.g., 1000c), wherein: in accordance with a determination that the change in position of the person is a second change (e.g., a change from the position shown in FIG. 10A to the position shown in FIG. 10B) that is different from the first change, displaying (1110) the change in the visual effect includes displaying the visual effect with a second updated appearance (e.g., the appearance shown in FIG. 10B) that is different from the first appearance and the first updated appearance. In some embodiments, displaying the visual effect with a second updated appearance includes changing, animating, and/or moving an element of the user interface in a second manner that is different from the first manner. In some embodiments, the change in appearance of the visual effect is based on an absolute location of the person (e.g., is based on a location to which the person moves). In some embodiments, the change in appearance of the visual effect is based on relative movement of the person (e.g., is based on how the person moves and/or the amount of movement). In some embodiments, the change in appearance of the visual effect is based on (e.g., corresponds to) the direction, orientation, and/or magnitude of change in position of the person. In some embodiments, an aspect of the visual effect changes (e.g., in position, color, and/or brightness) based on (e.g., in relation to) the change in position of the person. In some embodiments, an aspect of the visual effect becomes brighter, larger, and/or more prominent as the person changes position. In some embodiments, an aspect of the visual effect becomes dimmer, smaller, and/or less prominent as the person changes position. In some embodiments, if a change in position of the person is not detected, the computer system displays (e.g., maintains display of) the user interface without changing the visual effect (e.g., the computer system forgoes changing the visual effect).

Displaying the user interface with a first updated appearance in accordance with a determination that the change in position of the person is a first change and displaying the user interface with a second updated appearance in accordance with a determination that the change in position of the person is a second change provides feedback regarding the change in position of the person, thereby providing the user with improved visual feedback. Displaying the user interface with a first updated appearance in accordance with a determination that the change in position of the person is a first change and displaying the user interface with a second updated appearance in accordance with a determination that the change in position of the person is a second change enables the computer system to update the appearance of the use interface to reflect the change in position of the person without requiring additional inputs from the user to change the appearance of the user interface, thereby performing an operation when a set of conditions has been met without requiring further user input and reducing the number of inputs needed to perform an operation.

In some embodiments, the first change in position is to a first updated position (e.g., the position shown in FIG. 10C) (e.g., from an initial position, such as the position shown in FIG. 10A); the second change in position is to a second updated position (e.g., the position shown in FIG. 10B) (e.g., from the initial position) that is different from the first updated position; the first updated position is between an initial position and the second updated position (e.g., the position shown in FIG. 10C is between the positions shown in FIG. 10A and FIG. 10B); and a respective characteristic (e.g., 1016, 1018, a shape, size, color, position, and/or magnitude of an element) of the first updated appearance is between (e.g., along a spectrum and/or trajectory that includes) (e.g., the position of sheen 1016 shown in FIG. 10C is between the position of sheen 1016 shown in FIG. 10A and FIG. 10B) a respective characteristic of the first appearance and a respective characteristic of the second updated appearance. Displaying the user interface with a first updated appearance in accordance with a determination that the change in position of the person is to a first updated position and displaying the user interface with a second updated appearance in accordance with a determination that the change in position of the person is to a second updated position provides feedback regarding the change in position of the person, thereby providing the user with improved visual feedback. Displaying the user interface with a first updated appearance in accordance with a determination that the change in position of the person is to a first updated position and displaying the user interface with a second updated appearance in accordance with a determination that the change in position of the person is to a second updated position enables the computer system to update the appearance of the use interface to reflect the change in position of the person without requiring additional inputs from the user to change the appearance of the user interface, thereby performing an operation when a set of conditions has been met without requiring further user input and reducing the number of inputs needed to perform an operation.

In some embodiments, the visual effect includes a simulated reflection (e.g., 612b, 1016, and/or 1018) (e.g., of ambient light and/or simulated light). In some embodiments, the simulated reflection includes a simulated reflection of a person, object, and/or environment. In some embodiments, the simulated reflection includes a simulated reflection of light. In some embodiments, the simulated reflection gives the appearance of a shine and/or sheen on a simulated surface. In some embodiments, the visual effect includes a simulated highlight. In some embodiments, the visual effect includes an animation. Displaying the user interface with a visual effect that includes a simulated reflection enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the simulated reflection includes a simulated specular highlight (e.g., 1018, a simulated highlight visible on a simulated surface that appears to be normal to a position halfway between a light source (e.g., detected or simulated) and the person). In some embodiments, the visual effect includes a simulated reflection around a curved or angled edge of an element of the user interface. Displaying the user interface with a visual effect that includes a simulated specular highlight enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the simulated reflection includes a first component (e.g., 1016, a portion and/or feature) that translates in a first direction (e.g., horizontally and/or in an x-direction) as the position of the person changes in the first direction. In some embodiments, the first component of the simulated reflection is a simulated sheen and/or the appearance of a reflection on a simulated surface. In some embodiments, the amount of translation of the first component of the simulated reflection corresponds to a magnitude of movement (e.g., a magnitude of change in position) of the person. In some embodiments, the direction of translation of the first component of the simulated reflection is based on a direction of movement (e.g., a direction of change in position) of the person. Displaying the user interface with a simulated reflection that includes a first component that translates in a first direction as the position of the person changes in the first direction provides feedback regarding the position of the person, thereby providing the user with improved visual feedback. Displaying the user interface with a simulated reflection that includes a first component that translates in a first direction as the position of the person changes in the first direction enables the computer system to update the appearance of the user interface based on the position of the person and provide a more varied user experience without requiring additional inputs from the user to change the appearance of the user interface, thereby performing an operation when a set of conditions has been met without requiring further user input and reducing the number of inputs needed to perform an operation.

In some embodiments, the simulated reflection includes a second component (e.g., 1018, a portion and/or feature) that changes (e.g., translates) in the first direction and in a second direction (e.g., vertically and/or in a y-direction) that is different from the first direction as the position of the person changes in the first direction and in the second direction. In some embodiments, the second component of the simulated reflection includes a specular highlight. In some embodiments, the amount of translation of the second component of the simulated reflection in the first direction corresponds to a magnitude of movement (e.g., a magnitude of change in position) of the person in the first direction. In some embodiments, the amount of translation of the second component of the simulated reflection in the second direction corresponds to a magnitude of movement (e.g., a magnitude of change in position) of the person in the second direction. In some embodiments, the direction of translation of the second component of the simulated reflection in the first direction is based on a direction of movement (e.g., a direction of change in position) of the person in the first direction. In some embodiments, the direction of translation of the second component of the simulated reflection in the second direction is based on a direction of movement (e.g., a direction of change in position) of the person in the second direction. In some embodiments, translation of the second component in the first direction is independent from translation of the second component in the second direction. Displaying the user interface with a simulated reflection that includes a second component that changes in the first direction and the second direction as the position of the person changes in the first direction and the second direction provides feedback regarding the position of the person, thereby providing the user with improved visual feedback. Displaying the user interface with a simulated reflection that includes a second component that changes in the first direction and the second direction as the position of the person changes in the first direction and the second direction enables the computer system to update the appearance of the user interface based on the position of the person and provide a more varied user experience without requiring additional inputs from the user to change the appearance of the user interface, thereby performing an operation when a set of conditions has been met without requiring further user input and reducing the number of inputs needed to perform an operation.

In some embodiments, the simulated reflection that includes a second component (e.g., 1018, a portion and/or feature) that changes (e.g., translates) in the first direction and in the second direction is based on (e.g., moves in accordance with a change in) a position of a simulated light source (or, in some embodiments, a detected light source, such as 1094 and/or 1096). Displaying the user interface with a simulated reflection that includes a second component that changes in the first direction and the second direction as the position of the person changes in the first direction and the second direction as the position of a simulated light source changes enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, after displaying the user interface with the change in the visual effect, in response to (or, in some embodiments, in accordance with) a determination that a condition is met, the computer system ceases display of the change in the visual effect (e.g., the visual effect stops changing) (e.g., in FIG. 10J, a condition is met because two users are present and the computer system ceases displaying the change in sheen 1016 and highlights 1018). Ceasing display of the change in visual effect in response to a determination that a condition is met provides feedback regarding whether the condition is met, thereby providing the user with improved visual feedback. Ceasing display of the change in visual effect in response to a determination that a condition is met reduces the number of inputs required to cease display of the change in visual effect, thereby performing an operation when a set of conditions has been met without requiring further user input and reducing the number of inputs needed to perform an operation.

In some embodiments, the condition includes the person being outside a predetermined range (e.g., beyond a threshold distance (e.g., 6 feet), outside a predetermined angle, and/or outside the range of the one or more sensors). In some embodiments, the computer system ceases displaying the change in the visual effect and/or maintains the (e.g., static) appearance of the visual effect when the computer system detects that the person is outside the predetermined range. Ceasing display of the change in visual effect in response to a determination that the person is outside a predetermined range provides feedback regarding whether the person is outside the predetermined, thereby providing the user with improved visual feedback. Ceasing display of the change in visual effect in response to a determination that the person is outside a predetermined range reduces the number of inputs required to cease display of the change in visual effect, thereby performing an operation when a set of conditions has been met without requiring further user input and reducing the number of inputs needed to perform an operation. Ceasing display of the change in visual effect in response to a determination that the person is outside a predetermined range conserves power and increases the time between battery charges.

In some embodiments, the condition includes that more than one person (e.g., 1090 and 1092, the person and one or more additional people) is detected (e.g., simultaneously and/or concurrently) via the one or more input devices. In some embodiments, the computer system ceases displaying the change in the visual effect and/or maintains the (e.g., static) appearance of the visual effect when the computer system detects more than one person. Ceasing display of the change in visual effect in response to a determination that more than one person is detected provides feedback regarding the number of people detected, thereby providing the user with improved visual feedback. Ceasing display of the change in visual effect in response to a determination that more than one person is detected reduces the number of inputs required to cease display of the change in visual effect, thereby performing an operation when a set of conditions has been met without requiring further user input and reducing the number of inputs needed to perform an operation. Ceasing display of the change in visual effect in response to a determination that more than one person is detected conserves power and increases the time between battery charges.

In some embodiments, the condition includes a determination that the person is not looking at the computer system (e.g., based on face detection and/or gaze detection). In some embodiments, the condition includes a determination that the person was previously looking at the computer system and is no longer looking at the computer system. In some embodiments, the computer system ceases displaying the change in the visual effect and/or maintains the (e.g., static) appearance of the visual effect when the computer system determines that the person is not looking at the computer system. Ceasing display of the change in visual effect in response to a determination that the person is not looking at the computer system provides feedback indicating that the computer system does not detect that the person is looking at the computer system, thereby providing the user with improved visual feedback. Ceasing display of the change in visual effect in response to a determination that the person is not looking at the computer system provides feedback indicating that the computer system does not detect that the person is looking at the computer system reduces the number of inputs required to cease display of the change in visual effect, thereby performing an operation when a set of conditions has been met without requiring further user input and reducing the number of inputs needed to perform an operation. Ceasing display of the change in visual effect in response to a determination that the person is not looking at the computer system conserves power and increases the time between battery charges.

In some embodiments, ceasing display of the change in the visual effect includes gradually (e.g., slowly over a period of time) changing from displaying the change in the visual effect to forgoing displaying the change in visual effect (e.g., when user 1092 is detected in FIG. 10I, the computer system slowly transitions from the appearance shown in FIG. 10I to the appearance shown in FIG. 10J). In some embodiments, the computer system transitions display of the visual effect from a changing and/or dynamic state to a static state. Ceasing display of the change in the visual effect by gradually changing from displaying the change in the visual effect to forgoing displaying the change in the visual effect limits sudden and/or abrupt changes to the appearance of the user interface, thereby providing the user with improved visual feedback and an improved user experience.

In some embodiments, ceasing display of the change in the visual effect includes displaying the visual effect in a default state (e.g., the state and/or appearance shown in FIG. 10J, a predetermined and/or optimized state). In some embodiments, the default state is based on a simulated ambient light. In some embodiments, the default state is based on a simulated ambient light that is not centered with respect to the computer system and/or one or more of the one or more display generation components. Displaying the visual effect in a default state in response to a determination that a condition is met provides feedback regarding whether the condition is met, thereby providing the user with improved visual feedback. Displaying the visual effect in a default state in response to a determination that a condition is met reduces the number of inputs required to display the visual effect in the default state, thereby performing an operation when a set of conditions has been met without requiring further user input and reducing the number of inputs needed to perform an operation.

In some embodiments, after ceasing display of the change in the visual effect, in accordance with a determination that the condition ceases to be met (e.g., is not met), the computer system displays (e.g., resumes display of) the change in the visual effect (e.g., the changes shown in FIGS. 10A through 10C). Resuming display of the change in visual effect in response to a determination that the condition is not met provides feedback regarding whether the condition is met, thereby providing the user with improved visual feedback. Resuming display of the change in visual effect in response to a determination that a condition is not met reduces the number of inputs required to resume displaying the visual effect, thereby performing an operation when a set of conditions has been met without requiring further user input and reducing the number of inputs needed to perform an operation.

In some embodiments, the user interface with the visual effect includes an element (e.g., a foreground element, such as 802, 806, 1010, 1012, 1202, 1204, 1214, a numeral, a watch hand, an icon, text, and/or graphics) that appears partially transparent (e.g., has the appearance of revealing simulated content under the element) relative to a background element (e.g., 1014, 1020, 1028, 1206, 1210, a photo, graphic, and/or visual effect that appears to be in the background of the user interface). Displaying the user interface with an element that appears partially transparent relative to a background element provides feedback regarding the content underlying the element, thereby providing the user with improved visual feedback.

In some embodiments, the user interface with the visual effect includes background content that is animated (e.g., that is dynamic, moving, and/or changing, such as falling rain 1028 changing from the appearance shown in FIG. 10P1 to the appearance shown in FIG. 10P2 and/or dynamic element 1210 changing from the appearance shown in FIG. 12D to the appearance shown in FIG. 12E). In some embodiments, the background content includes weather-based content, wherein the background content is animated with current weather conditions, such as an animation of rain falling and/or clouds rolling by. Displaying the user interface with background content that is animated provides a more varied user experience without requiring additional inputs from the user to change the appearance of the user interface, thereby performing an operation when a set of conditions has been met without requiring further user input and reducing the number of inputs needed to perform an operation.

In some embodiments, the background content is animated (e.g., dynamic, moving, and/or changing, such as sheen 1016 and/or highlights 1018 changing) based on a respective change in position of the person relative to the one or more display generation components. In some embodiments, the background content includes a dynamic element that changes based on movement of the person. For example, in some embodiments, in accordance with a determination that the person moved in a first manner (e.g., at a first speed, in a first direction, to a first position, and/or with a first portion of the person's body), the computer system displays a first animation of the background content and, in accordance with a determination that the person moved in a second manner that is different from the first manner (e.g., at a second speed, in a second direction, to a second position, and/or with a second portion of the person's body), the computer system displays a second animation of the background content that is different from the first animation of the background content. Displaying the user interface with background content that is animated based on a respective change in position of the person relative to the one or more display generation components enables the computer system to update the appearance of the user interface to reflect the position of the person and provide a more varied user experience without requiring additional inputs from the user to change the appearance of the user interface, thereby performing an operation when a set of conditions has been met without requiring further user input and reducing the number of inputs needed to perform an operation.

In some embodiments, displaying the user interface includes: displaying, via the one or more display generation components, a simulated material (e.g., simulated glass material, such as the simulated material shown for indication of time 1012) that is overlaid on a background (e.g., 1014, 1020, an image and/or a graphic), wherein: the visual effect is applied to the simulated material; and the appearance of the background affects the appearance of the simulated material (e.g., the simulated glass material reveals the background, as illustrated by the appearance of background image 1020 within indication of time 1012 in FIG. 10K and by the appearance of background image 1014 within indication of time 1012 in FIG. 10L). Displaying the user interface with the visual effect applied to a simulated material enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation. Displaying the user interface with an appearance of the background that affects the appearance of the simulated material enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the appearance of the simulated material is based on a blurred version of the background (e.g., as illustrated by the absence of brick lines within indication of time 1012 in FIG. 10K and by the absence of leaves within indication of time 1012 in FIG. 10L). In some embodiments, simulated glass material is semi-transparent and/or partially opaque and the background content revealed by the simulated glass material appears to be blurred. Displaying the user interface with the appearance of simulated material based on a blurred version of the background enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the appearance of the simulated material is based on a version of the background with a modified scale (e.g., a version of the background that has a different size than an actual size of the background, as illustrated by the appearance of background image 1020 within indication of time 1012 in FIG. 10K and by the appearance of background image 1014 within indication of time 1012 in FIG. 10L). In some embodiments, the simulated material appears to distort the appearance of the background. In some embodiments, the appearance of the simulated material is based on simulated refraction. Displaying the user interface with the appearance of simulated material based on a version of the background with a modified scale enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, in accordance with a determination that the user interface is a first user interface (e.g., 1000a), the simulated material has an appearance that is based on a version of the background with a first modified scale (e.g., the appearance of a first amount of distortion and/or refraction). In some embodiments, in accordance with a determination that the user interface is a second user interface (e.g., 1000p1) that is different from the first user interface, the simulated material has an appearance that is based on a version of the background with a second modified scale (e.g., the appearance of a second amount of distortion and/or refraction) that is different from the first modified scale. Displaying the simulated material with an appearance that is based on a version of the background with a first modified scale in accordance with a determination that the user interface is a first user interface and displaying the simulated material with an appearance that is based on a version of the background with a second modified scale in accordance with a determination that the user interface is a second user interface enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, a first portion of the simulated material (e.g., 1012) includes an appearance of the simulated material that is based on a version of the background with a third modified scale (e.g., the appearance of a third amount of distortion and/or refraction). In some embodiments, a second portion of the simulated material (e.g., 1010) includes an appearance of the simulated material that is based on a version of the background with a fourth modified scale (e.g., the appearance of a fourth amount of distortion and/or refraction) that is different from the third modified scale. In some embodiments, the simulated material includes different portions that have different degrees of change in scale of the underlying content (e.g., different degrees of simulated refraction). In some embodiments, the different portions include simulated surfaces, edges, and/or curves. In some embodiments, one portion of a simulated curve includes a different scale than another portion of the simulated curve. Displaying the first portion of the simulated material with an appearance that is based on a version of the background with a third modified scale and displaying the second portion of the simulated material with an appearance that is based on a version of the background with a fourth modified scale enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the computer system identifies a subject (e.g., 1014a, 1016a, and/or a primary person and/or object of interest and/or a focal point) of the background. In some embodiments, the computer system creates a modified version of the background (e.g., the version of background image 1014 shown in FIG. 10L) that does not include the subject (e.g., creating the modified version of the background includes removing (e.g., segmenting) the subject from the background). In some embodiments, the computer system displays the simulated material with an appearance that is based on the modified version of the background that does not include the subject (e.g., the appearance of indication of time 1012 in FIG. 10L is based on the version of background image 1014 shown in FIG. 10L). Displaying the simulated material with an appearance that is based on a modified version of the background that does not include a subject provides feedback regarding the subject identified by the computer system, thereby providing improved visual feedback.

In some embodiments, the subject is overlaid on (e.g., segmented on top of) at least a portion of the simulated material (e.g., 1012). In some embodiments, a first layer includes the background with the subject removed, a second layer includes the simulated material (e.g., with an appearance based on the background with the subject removed), and a third layer includes the subject. Displaying the subject on the simulated material allows the user to fully see the subject within the user interface, thereby providing the user with improved visual feedback.

In some embodiments, creating the modified version of the background includes automatically generating (e.g., using generative content optionally generated by a generative ML process, such as inpainting, or by a deterministic process, such as cloning or sampling nearby content) a portion of the background where the subject was removed (e.g., the portion of background image 1014 shown in FIG. 10L where subject 1014a is shown in FIG. 10A). Automatically generating a portion of the background where the subject was removed enables the computer system to update the appearance of the user interface to reflect the background and provide a more varied user experience without requiring additional inputs from the user to change the appearance of the user interface, thereby performing an operation when a set of conditions has been met without requiring further user input and reducing the number of inputs needed to perform an operation.

In some embodiments, the visual effect is applied to a foreground element (e.g., 1010, 1012, status information, and/or an indication of time) and wherein the visual effect is not applied to the background element. In some embodiments, the simulated material includes a simulated sheen and/or simulated specular highlights and the background element and/or subject do not include a simulated sheen and/or simulated specular highlights. Displaying the user interface with the visual effect applied to the foreground element and without the visual effect applied to the background element distinguishes between the foreground element and the background element, thereby providing improved visual feedback.

In some embodiments, the computer system displays a first user interface (e.g., 1000c) that includes the visual effect applied to a foreground element (e.g., 1010, 1012, status information, and/or an indication of date and/or time). In some embodiments, the computer system transitions display of the first user interface to display of a second user interface (e.g., 1000h) that includes the visual effect, wherein transitioning from the first user interface to the second user interface includes: ceasing to display the foreground element (e.g., as shown in FIG. 10E); replacing display of (e.g., with a crossfade) a background of the first user interface with display of a background of the second user interface (e.g., as shown in FIG. 10F); and resuming display of the foreground element (e.g., displaying the second user interface that includes the visual effect applied to the foreground element) (e.g., as shown in FIG. 10H). Transitioning display of the first user interface to display of a second user interface by ceasing to display the foreground element, replacing display of the background of the first user interface with display of the background of the second user interface, and resuming display of the foreground element enables the computer system to change the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the change (e.g., amount of change) in the visual effect is non-linear with respect to the change (e.g., amount of change) in position of the person (e.g., the change in the position of the person from the position shown in FIG. 10A to the position shown in FIG. 10B occurs at a constant speed, but the change from the appearance shown in FIG. 10A to the appearance shown in FIG. 10B occurs more slowly at first and then increases). In some embodiments, the change in visual effect uses an easing curve and/or simulated physics to connect movement of the person to changes in the visual effect. In some embodiments, the change in visual effect is based on simulated spring physics. In some embodiments, a first portion of the change in visual effect (e.g., over a first interval of time) is related to a corresponding first portion of the change in position of the person in a first manner (e.g., with a first relationship) and a second portion of the change in visual effect (e.g., over a second interval of time) that is different from the first portion of the change in visual effect is related to a corresponding second portion of the change in position of the person in a second manner (e.g., with a second relationship). In some embodiments, the change in visual effect relative to the change in position of the person is different for a first portion of the movement than for a second portion of the movement. Displaying the user interface with a visual effect that is non-linear with respect to the change in position of the person enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the visual effect includes a color region (e.g., 1210) that responds to (e.g., moves, changes in size, changes in color, changes in brightness, and/or changes in shape based on) movement of the person. Displaying the user interface with a visual effect that includes a color region that responds to movement of the person provides feedback regarding detected movement of the person, thereby providing improved visual feedback. Displaying the user interface with a visual effect that includes a color region that responds to movement of the person enables the computer system to update the appearance of the user interface to reflect movement of the person and provide a more varied user experience without requiring additional inputs from the user to change the appearance of the user interface, thereby performing an operation when a set of conditions has been met without requiring further user input and reducing the number of inputs needed to perform an operation.

FIGS. 12A-12K illustrate exemplary user interfaces that respond to the presence of a user, in accordance with some embodiments. The user interfaces in these figures are used to illustrate the processes described below, including the processes in FIG. 13.

In FIG. 12A, computer system 600 displays user interface 1200a on display 602. In some embodiments, computer system 600 displays user interface 1200a in response to detecting an event corresponding to a request to display a respective user interface (e.g., as described with respect to FIG. 8A). In the example shown in FIG. 12A, user interface 1200a includes status information, such as indication of time 1202 and element 1204 (e.g., a complication, an application icon, a dynamic user interface element, and/or a selectable user interface element), displayed over background 1206.

In some embodiments, a complication is a user-selectable graphical user interface object that displays information from a corresponding application. For example, as shown in FIG. 12A, element 1204 is a complication that indicates the date (e.g., Tuesday the 7th) and the current weather conditions (e.g., 72 degrees and sunny). In some embodiments, computer system 600 displays a corresponding application in response to an input directed to element 1204, such as input 1250 (e.g., a tap input, air tap input, gaze dwell input, and/or other input). For example, in some embodiments, computer system 600 displays a weather application in response to input 1250.

In some embodiments, computer system 600 displays a respective user interface with an element that changes over time. For example, as shown in FIG. 12A, computer system 600 displays background 1206, which changes over time. In some embodiments, the changes to background 1206 are random or pseudo-random. In some embodiments, background 1206 changes with simulated inertia and/or simulated fluid dynamics, giving the appearance of a fluid flowing throughout the respective user interface.

Various features and/or examples of computer system 600, user interface 1200a, and/or other user interfaces described herein, are described using the example of a tablet computer, as shown in FIG. 12A. In some embodiments, the user interfaces displayed by computer system 600 are implemented on and/or displayed by HMD 6000, depicted in FIG. 12A1. In FIG. 12A1, HMD 6000 includes display generation component 6002, and user interface 1200a is displayed as a virtual window or widget (such as world-locked or environment-locked object that is displayed with an appearance that maintains a fixed location in the world or environment as the viewpoint of the user moves) within a three-dimensional augmented reality or virtual reality environment. In some embodiments, user interface 1200a is displayed within three-dimensional environment 6010 (e.g., a virtual passthrough environment or optical passthrough environment). In some embodiments in which computer system 600 is a head-mounted system (e.g., HMD 6000), computer system 600 optionally includes two displays (e.g., one for each eye of a user), with each display displaying respective various content, to enable a user of computer system 600 to perceive the various depths of the various content (e.g., physical objects and/or virtual objects) of the three-dimensional environments. For example, in some embodiments, display generation component 6002 displays content for a left eye of the user, and a separate display generation component displays content for a right eye of the user. In some embodiments, user inputs directed to computer system 600 are shown and/or described as particular types of inputs (e.g., touch inputs and/or button press inputs). In various embodiments, other types of user inputs are used. For example, in some embodiments, gaze inputs and/or air gesture inputs are used to interact with computer system 600, user interface 1200a, and/or other user interfaces described herein.

In some embodiments, background 1206 changes color and/or appearance over time. For example, in FIG. 12A, background 1206 is a muted green color (e.g., as indicated by the dotted pattern corresponding to muted green, shown in the scale on the right side of FIG. 12A). As illustrated in FIG. 12A, background 1206 includes background variations 1206a, which are areas of darker green color (e.g., as indicated by the closely spaced dotted pattern, corresponding to a darker shade of muted green) in user interface 1200a. Over time, computer system 600 changes the appearance of the respective user interface, and as a result, background variations 1206a appear in different locations in user interface 1200b, as shown in FIG. 12B.

In some embodiments, background 1206 and background variations 1206a appear to be the same type of fluid (e.g., background 1206 and background variations 1206a appear to blend together). In some embodiments, background 1206 and background variations 1206a appear to have distinct fluid properties (e.g., such as the properties of oil and water). In some embodiments, background variations 1206a appear to be suspended within background 1206. In some embodiments, the interaction between background 1206 and background variations 1206a mimics a lava lamp, with background variations 1206a appearing to float to the top of the respective user interface and subsequently sink to the bottom of the respective user interface.

In some embodiments, computer system 600 displays indication of time 1202 and element 1204 with simulated dimensionality. For example, in some embodiments, indication of time 1202 and element 1204 appear to protrude from display 602. In some embodiments, indication of time 1202 and element 1204 include simulated surfaces and/or sidewalls, as discussed in more detail with respect to FIG. 8B. In some embodiments, indication of time 1202 and element 1204 have the appearance of casting simulated shadows, as discussed in more detail with respect to FIG. 8B.

In some embodiments, the status information has the appearance of being made of glass. For example, in some embodiments, computer system 600 displays indication of time 1202 and element 1204 with a simulated glass appearance. In some embodiments, indication of time 1202 and element 1204 include simulated translucency and/or simulated refraction, as discussed in more detail with respect to FIG. 10K and FIG. 10L.

In some embodiments, the simulated refraction varies across the status information. For example, in some embodiments, the amount of simulated refraction corresponds to the simulated dimensionality and/or a simulated depth of the status information (e.g., a deeper simulated depth corresponds to greater simulated refraction). In some embodiments, the simulated refraction varies within the status information. For example, in some embodiments, indication of time 1202 has variable depth and/or curved features, such as rounded corners, and the amount of simulated refraction varies accordingly.

In some embodiments, indication of time 1202 and element 1204 include simulated sheen, as discussed in more detail with respect to FIGS. 10M1 through 10M3. In some embodiments, indication of time 1202 and element 1204 include simulated specular highlights, as discussed in more detail with respect to FIGS. 10N1 and 10N2 and FIGS. 10O1 through 10O3.

In some embodiments, the appearance of the respective user interface changes based on the presence of a user. In some embodiments, computer system 600 detects a user in the environment surrounding the computer system, as discussed in more detail with respect to FIG. 6C. In some embodiments, the simulated glass material changes appearance based on a detected change in position of a user. For example, the simulated sheen and/or specular highlights change based on the position of the person, as discussed in more detail with respect to FIGS. 10M1 through 10M3, FIGS. 10N1 and 10N2, and FIGS. 10O1 through 10O3.

In some embodiments, computer system 600 displays dynamic element 1210, as shown in FIG. 12C, that changes based on the presence of a user. In some embodiments, dynamic element 1210 appears to be a fluid. In some embodiments, dynamic element 1210 includes more saturated (e.g., brighter and/or more intense) colors than background 1206. For example, as illustrated in FIG. 12C, dynamic element 1210 includes various shades of saturated green (e.g., corresponding to the circle pattern).

In some embodiments, dynamic element 1210 appears to influence background 1206 with simulated fluid dynamics. For example, in some embodiments, dynamic element 1210 appears to be poured into background 1206. In some embodiments, dynamic element 1210 appears to displace background 1206 (e.g., background 1206 and/or background variations 1206a move away from the location at which dynamic element 1210 appears). In some embodiments, dynamic element 1210 appears to become part of background 1206 (e.g., dynamic element 1210 blends with background 1206 and/or the colors of dynamic element 1210 fade into the colors of background 1206). In some embodiments, dynamic element 1210 appears distinct from background 1206 (e.g., like oil in water).

In some embodiments, computer system 600 displays the dynamic element in response to detecting the presence of a user in the environment surrounding computer system 600. For example, in FIG. 12C, user 1290 approaches computer system 600 from the left. In this example, computer system 600 displays dynamic element 1210 in the left side of user interface 1200c based on the position of user 1290 to the left of computer system 600, as illustrated in FIG. 12C.

In some embodiments, as user 1290 moves, dynamic element 1210 moves. For example, as illustrated in FIG. 12D, user 1290 is centered in front of computer system 600. In this example, computer system 600 displays dynamic element 1210 centered in user interface 1200d based on the position of user 1290 centered in front of computer system 600, as shown in FIG. 12D.

In some embodiments, elements of the respective user interface change colors over time. For example, in some embodiments, background 1206 and/or dynamic element 1210 change colors over time. For example, dynamic element 1210 is starting to turn blue in FIG. 12D (e.g., as indicated by the triangle pattern in the center of dynamic element 1210, corresponding to saturated blue color).

In some embodiments, background 1206 and dynamic element 1210 change colors independently from movement of user 1290. For example, user 1290 remains in the same position in FIG. 12E as in FIG. 12D (e.g., centered in front of computer system 600). As shown in FIG. 12E, although user 1290 remains stationary, background 1206 changes from muted greens (e.g., as indicated by the dotted pattern corresponding to muted greens) to muted blues (e.g., as indicated by the diagonal hashed pattern corresponding to muted blues). Similarly, although user 1290 remained stationary, dynamic element 1210 changes from saturated greens (e.g., indicated by the patterns of circles corresponding to saturated greens) and saturated blues (e.g., indicated by the patterns of triangles corresponding to saturated blues) to saturated blues and saturated purples (e.g., indicated by the pattern of squares corresponding to saturated purples).

In some embodiments, computer system 600 cycles through a set of colors over time. In some embodiments, the set of colors includes the colors of the rainbow (e.g., red, orange, yellow, green, blue, and purple). In some embodiments, the set of colors includes a subset of colors (e.g., green, blue, purple, and red). In some embodiments, computer system 600 changes colors in a particular order (e.g., from red to orange to yellow, and so forth). In some embodiments, computer system 600 changes colors in a random or pseudo-random order (e.g., from red to green to purple).

As shown in FIG. 12E, computer system 600 displays dynamic element 1210 centered in user interface 1200e based on the position of user 1290 centered in front of computer system 600. In some embodiments, when user 1290 is stationary, the general shape and position of dynamic element 1210 do not change (e.g., the general shape and position of dynamic element 1210 remain the same). In some embodiments, although the general shape and position of dynamic element 1210 do not change, the precise shape of dynamic element 1210 varies due to simulated inertia, simulated fluid dynamics, and/or random or pseudo-random changes, as illustrated by the change from FIG. 12D to FIG. 12E.

In some embodiments, the size of dynamic element 1210 changes based on the position of a user relative to computer system 600. For example, in some embodiments, computer system 600 displays dynamic element 1210 larger when user 1290 is closer to computer system 600 and smaller when user 1290 is further from computer system 600. In some embodiments, computer system 600 displays dynamic element increasing in size as user 1290 moves toward computer system 600. For example, in FIG. 12F, user 1290 moves closer to computer system 600, as compared with the position of user 1290 in FIG. 12E. As illustrated in FIG. 12F, computer system 600 displays dynamic element 1210 larger in user interface 1200f (e.g., than in user interface 1200e of FIG. 12E) based on user 1290 being closer to computer system 600.

In some embodiments, different portions of the user interface correspond to different portions of user 1290. For example, in some embodiments dynamic element 1210 corresponds to the head and/or torso of user 1290. In some embodiments, background 1206 corresponds (e.g., in part) to the hands of user 1290. For example, as shown in FIG. 12G, user 1290 raises his hands. As illustrated in FIG. 12G, dynamic element 1210 is compressed from the sides in user interface 1200g in response to user 1290 raising his hands in front of computer system 600.

In some embodiments, as user 1290 continues to move his hands, computer system 600 continues to change how dynamic element appears. For example, as illustrated in FIG. 12H, dynamic element 1210 is further compressed in user interface 1200h as user 1290 brings his hands down. In some embodiments, computer system 600 displays the respective user interface with the appearance of color being removed (e.g., being sucked away) from dynamic element 1210 based on the position of the hands of user 1290.

In some embodiments, computer system 600 displays additional dynamic elements corresponding to portions of user 1290. In the example shown in FIG. 12I, dynamic element 1210 corresponds to the head and/or torso of user 1290 and dynamic elements 1212a and 1212b correspond to each hand of user 1290. In some embodiments, dynamic elements 1212a and 1212b appear to displace dynamic element 1210, as shown in user interface 1200i of FIG. 12I.

In some embodiments, additional dynamic elements 1212a and 1212b move as user 1290 moves. For example, as illustrated in FIG. 12J, as user 1290 moves his hands down, dynamic elements 1212a and 1212b move down in user interface 1200j and dynamic elements 1212a and 1212b further compress dynamic element 1210.

In some embodiments, computer system 600 displays status information that includes startup, enrollment, and/or device boot status information. For example, as illustrated in FIG. 12K, computer system 600 displays user interface 1200k with information 1214. In some embodiments, information 1214 greets a user. In some embodiments, the status information provides progress information, such as percent completion and/or a number of steps completed. In some embodiments, the status information includes instructions and/or user prompts during a startup and/or enrollment process. In some embodiments, computer system 600 displays information 1214 with simulated glass appearance, as discussed above. In some embodiments, computer system 600 displays user interface 1200k with dynamic element 1210 that responds to movement of user 1290, as discussed above.

FIG. 13 is a flow diagram illustrating a method for displaying a user interface based on the presence of a user using a computer system in accordance with some embodiments. Method 1300 is performed at a computer system (e.g., 100, 300, 500, 600, a smartspeaker, a head-mounted device, a smartwatch, a smartphone, a tablet computer, a laptop computer, and/or a desktop computer) that is in communication with one or more display generation components (e.g., 602, a display controller, a display, a touch-sensitive display system, a touchscreen, a head-mounted display, and/or a monitor) and one or more input devices (e.g., 602, 604, 606, a touch-sensitive surface, a touchscreen display, a button, a keyboard, a mouse, a joystick, a camera sensor, a light sensor, a motion sensor, and/or a microphone). Some operations in method 700 are, optionally, combined, the orders of some operations are, optionally, changed, and some operations are, optionally, omitted.

As described below, method 1300 provides an intuitive way for displaying a user interface based on the presence of a user. The method reduces the cognitive burden on a user for displaying a user interface based on the presence of a user, thereby creating a more efficient human-machine interface. For battery-operated computing devices, enabling a user to display a user interface based on the presence of a user faster and more efficiently conserves power and increases the time between battery charges.

The computer system displays (1302), via the one or more display generation components, a (e.g., randomly or pseudo-randomly changing) user interface (e.g., 1200c, a time user interface, a user interface that includes a digital and/or analog indication of time, a clock face, a wake screen, and/or a home screen) that includes status information (e.g., 1202, 1204, information about the computer system, information indicating a status of a setup process for the computer system, weather information, time, and/or date information). In some embodiments, the user interface includes one or more elements and/or visual effects that change over time, such as by changing position, orientation, size, shape, color, and/or magnitude. In some embodiments, the one or more elements and/or visual effects change gradually, randomly, and/or pseudo-randomly over time.

While displaying (1304) the user interface that includes the status information: in accordance with (or, in some embodiments, in response to) a determination that presence of a person (e.g., 1290) is detected (e.g., in response to a detection that a person is present), the computer system displays (1306) (e.g., in the user interface), via the one or more display generation components, a dynamic element (e.g., 1210, an element that changes color, shape and/or size and/or that has an animated visual effect) concurrently with the status information, wherein the dynamic element responds to (e.g., changes in accordance with and/or in response to) movement (e.g., detected movement) of the person (e.g., 1290). In some embodiments, the computer system detects (e.g., via the one or more input devices) whether a person is present (e.g., near the computer system and/or within range of the one or more input devices).

While displaying (1304) the user interface that includes the status information: in accordance with (or, in some embodiments, in response to) a determination that presence of a person is not detected (e.g., in response to a detection that a person is not present and/or in response to an absence of a detection that a person is present), the computer system displays (1308), via the display generation component, the user interface that includes the status information without displaying the dynamic element (e.g., 1200b) (e.g., the computer system forgoes displaying the dynamic element).

Displaying a dynamic element concurrently with status information provides feedback regarding the status information, thereby providing the user with improved visual feedback. Displaying the dynamic element concurrently with status information enables the user to view the status information without requiring the user to navigate to a different user interface to view the status information, thereby performing an operation when a set of conditions has been met without requiring further user input and reducing the number of inputs needed to perform an operation. Displaying the user interface with a dynamic element that responds to movement of the person in accordance with a determination that presence of the person is detected and displaying the user interface without including a dynamic element in accordance with a determination that presence of the person is not detected provides feedback regarding whether presence of the person is detected, thereby providing the user with improved visual feedback. Displaying the user interface with a dynamic element that responds to movement of the person in accordance with a determination that presence of the person is detected and displaying the user interface without including a dynamic element in accordance with a determination that presence of the person is not detected provides feedback regarding the detected presence of a person enables the computer system to update the appearance to reflect whether a person is present and provide a more varied user experience without requiring additional inputs from the user to change the appearance of the user interface, thereby performing an operation when a set of conditions has been met without requiring further user input and reducing the number of inputs needed to perform an operation.

In some embodiments, the dynamic element moves based on (e.g., in coordination with and/or proportionally to) movement of the person (e.g., as illustrated by the change in dynamic element 1210 from the position shown in FIG. 12C to the position shown in FIG. 12D). In some embodiments, the computer system detects and/or determines a position (e.g., location, orientation, and/or body position) of the person relative to the computer system. In some embodiments, the appearance (e.g., size, shape, position, color, and/or rate of change) of the dynamic element corresponds to movement of the person. In some embodiments, the position of the dynamic element (or, in some embodiments, a portion thereof) changes based on movement of the person (e.g., the position of the dynamic element corresponds to a change in position of the person). In some embodiments, a color of the dynamic element changes based on movement of the person. Displaying the user interface with a dynamic element that moves based on movement of the person provides feedback regarding whether movement of the person is detected, thereby providing the user with improved visual feedback. Displaying the user interface with a dynamic element that moves based on movement of the person enables the computer system to update the appearance to reflect movement of the person and provide a more varied user experience without requiring additional inputs from the user to change the appearance of the user interface, thereby performing an operation when a set of conditions has been met without requiring further user input and reducing the number of inputs needed to perform an operation.

In some embodiments, a size of the dynamic element changes based on a distance of the person relative to the user interface (e.g., based on a distance of the person relative to the one or more display generation components and/or relative to the one or more input devices) (e.g., as illustrated by the change in dynamic element 1210 from the size shown in FIG. 12E to the size shown in FIG. 12F). In some embodiments, the size of the dynamic element changes based on movement of the person relative to the one or more display generation components and/or the computer system. In some embodiments, the size of the dynamic element increases as a person moves closer to the user interface, the one or more display generation components and/or the computer system and the size of a portion of the dynamic element decreases as the person moves further away from the user interface, one or more display generation components and/or the computer system. Displaying the user interface with a dynamic element that changes based on a distance of the person relative to the one or more display generation components provides feedback regarding the detected distance of the person relative to the one or more display generation components, thereby providing the user with improved visual feedback. Displaying the user interface with a dynamic element that changes based on a distance of the person relative to the one or more display generation components enables the computer system to update the appearance to reflect the distance of the person relative to the one or more display generation components and provide a more varied user experience without requiring additional inputs from the user to change the appearance of the user interface, thereby performing an operation when a set of conditions has been met without requiring further user input and reducing the number of inputs needed to perform an operation.

In some embodiments, the dynamic element changes over time (e.g., from a first point in time to a second point in time) with random or pseudorandom changes (e.g., in shape, size, position, color, and/or pattern) independently from (e.g., without regard to) a position (e.g., location and/or pose) of the person (e.g., relative to the user interface, the computer system, the one or more display generation components, or one or more input devices of the computer system) (e.g., as illustrated by the change in dynamic element 1210 from the shape and colors shown in FIG. 12D to the shape and colors shown in FIG. 12E). In some embodiments, the dynamic element has the appearance of a fluid that is continually changing (e.g., in part due to the simulated influence of a background element with random or pseudorandom changes). Displaying the user interface with a dynamic element that changes over time provides feedback regarding the change in time, thereby providing the user with improved visual feedback. Displaying the user interface with a dynamic element that changes over time adjusts the appearance of the user interface based on the time without requiring user input, thereby performing an operation when a set of conditions has been met without requiring further user input and reducing the number of inputs needed to perform an operation.

In some embodiments, a shape of the dynamic element changes (e.g., with a simulated physical property, such as simulated inertia and/or simulated fluid dynamics) over time (e.g., as illustrated by the change in dynamic element 1210 from the shape shown in FIG. 12D to the shape shown in FIG. 12E). In some embodiments, the dynamic element maintains a general shape and/or size over time (e.g., in the absence of movement of the person) while shifting slightly. Displaying the user interface with a dynamic element that changes shape over time provides feedback regarding the change in time, thereby providing the user with improved visual feedback. Displaying the user interface with a dynamic element that changes shape over time adjusts the appearance of the user interface based on the time without requiring user input, thereby performing an operation when a set of conditions has been met without requiring further user input and reducing the number of inputs needed to perform an operation.

In some embodiments, a color of the dynamic element changes (e.g., with a simulated physical property, such as a simulated inertia and/or simulated fluid dynamics) over time (e.g., as illustrated by the change in dynamic element 1210 from the colors shown in FIG. 12D to the colors shown in FIG. 12E). In some embodiments, the dynamic element cycles through a variety of colors and/or patterns over time (e.g., gradually and/or continually). Displaying the user interface with a dynamic element that changes color over time provides feedback regarding the change in time, thereby providing the user with improved visual feedback. Displaying the user interface with a dynamic element that changes color over time adjusts the appearance of the user interface based on the time without requiring user input, thereby performing an operation when a set of conditions has been met without requiring further user input and reducing the number of inputs needed to perform an operation.

In some embodiments, the user interface includes a background element (e.g., in addition to the dynamic element) with an appearance that changes over time without regard to whether presence of the person is detected (e.g., regardless of whether or not the presence of a person is detected). Displaying the user interface with a background element that has an appearance that changes over time provides feedback regarding the change in time, thereby providing the user with improved visual feedback. Displaying the user interface with a background element that has an appearance that changes over time adjusts the appearance of the user interface based on the time without requiring user input, thereby performing an operation when a set of conditions has been met without requiring further user input and reducing the number of inputs needed to perform an operation.

In some embodiments, the background element changes over time with random or pseudorandom changes (e.g., in shape, size, position, color, and/or pattern) (e.g., as illustrated by the change in background variations 1206a from the locations shown in FIG. 12D to the locations shown in FIG. 12E). In some embodiments, the background element has the appearance of a fluid that is continually changing. Displaying the user interface with a background element that changes over time provides feedback regarding the change in time, thereby providing the user with improved visual feedback. Displaying the user interface with a background element that changes over time adjusts the appearance of the user interface based on the time without requiring user input, thereby performing an operation when a set of conditions has been met without requiring further user input and reducing the number of inputs needed to perform an operation.

In some embodiments, a change to the dynamic element causes a change in the background element (e.g., the user interface has the appearance that the dynamic element influences the background element) (e.g., as illustrated by the change in apparent displacement of background variations 1206a due to dynamic element 1210 in FIG. 12C). For example, in response to a change in the dynamic element, the computer system changes the background element. In some embodiments, a change in the background element causes a change in the dynamic element. Displaying the user interface with a dynamic element that causes a change in the background element enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the dynamic element interacts with the background element with simulated fluid dynamics (e.g., with the appearance of fluid and/or material flowing) (e.g., as illustrated by the changes to background variations 1206a and to dynamic element 1210 from the shapes and positions shown in FIG. 12C to the shapes and positions shown in FIG. 12D). Displaying the user interface with a dynamic element that interacts with the background element with simulated fluid dynamics enables the computer system to update the appearance of the user interface and provide a more varied user experience without requiring additional inputs from the user to change the appearance of the user interface, thereby performing an operation when a set of conditions has been met without requiring further user input and reducing the number of inputs needed to perform an operation.

In some embodiments, the background element includes a different set of one or more colors (e.g., a more subdued, less bright, and/or less saturated color palette) than the dynamic element (e.g., the colors of background 1206 and background variations 1206a are lighter and/or more subdued than the colors of dynamic element 1210). In some embodiments, the boundary of the dynamic element fades into the background element (e.g., with a gradient). Displaying the user interface with a background element that includes a different set of one or more colors than the dynamic element distinguishes between the background element and the dynamic element, thereby providing the user with improved visual feedback.

In some embodiments, an appearance of the dynamic element is affected (e.g., in shape and/or size) by two or more portions (e.g., a head, face, and/or one or more hands or limbs) of the person (e.g., dynamic element 1210 is affected by movement of the hands of user 1290 in FIGS. 12G through 12J). In some embodiments, the appearance of the dynamic element is based on and/or changes in response to movement of multiple different portions of the person's body. Displaying the user interface with a dynamic element that has an appearance that is affected by two or more portions of the person provides feedback regarding the different portions of the person, thereby providing the user with improved visual feedback. Displaying the user interface with a dynamic element that has an appearance that is affected by two or more portions of the person enables the computer system to update the appearance of the user interface based on the two or more portions of the person and provide a more varied user experience without requiring additional inputs from the user to change the appearance of the user interface, thereby performing an operation when a set of conditions has been met without requiring further user input and reducing the number of inputs needed to perform an operation.

In some embodiments, a first portion of the person (e.g., a head and/or torso, such as the torso of user 1290) affects the appearance of the dynamic element in a first manner (e.g., based on movement of the first portion of the person). In some embodiments, a second portion of the person (e.g., a hand and/or limb, such as the hand of user 1290) affects the appearance of the dynamic element in a second manner (e.g., based on movement of the second portion of the person). In some embodiments, the first manner is different from the second manner. Displaying the user interface with a dynamic element that is affected by movement of a first portion of the person in a first manner and by movement of a second portion of the person in a second manner provides feedback regarding movement of different portions of the person, thereby providing the user with improved visual feedback. Displaying the user interface with a dynamic element that is affected by movement of a first portion of the person in a first manner and by movement of a second portion of the person in a second manner enables the computer system to update the appearance of the user interface based on movement of the portions of the person and provide a more varied user experience without requiring additional inputs from the user to change the appearance of the user interface, thereby performing an operation when a set of conditions has been met without requiring further user input and reducing the number of inputs needed to perform an operation.

In some embodiments, the first manner includes spreading color (e.g., adding color and/or changing color). In some embodiments, the color, shape, and/or size of the dynamic element spreads and/or increases based on (e.g., in the areas representing) movement of the first portion of the person. In some embodiments, the second manner includes containing color (e.g., removing color and/or limiting the expansion of color). In some embodiments, the color, shape, and/or size of the dynamic element is contained and/or decreased based on (e.g., in the areas representing movement of the second portion of the person). Displaying the user interface with a dynamic element that is affected by movement of a first portion of the person by spreading color and by movement of a second portion of the person by containing color provides feedback regarding movement of different portions of the person, thereby providing the user with improved visual feedback. Displaying the user interface with a dynamic element that is affected by movement of a first portion of the person by spreading color and by movement of a second portion of the person by containing color enables the computer system to update the appearance of the user interface based on movement of the portions of the person and provide a more varied user experience without requiring additional inputs from the user to change the appearance of the user interface, thereby performing an operation when a set of conditions has been met without requiring further user input and reducing the number of inputs needed to perform an operation.

In some embodiments, the status information is overlaid on (e.g., is displayed with the appearance of being on top of and/or overlapping) the dynamic element (e.g., as shown in FIG. 12C). In some embodiments, the status information is displayed with the appearance of having a material with one or more simulated optical properties (e.g., 1218, the appearance of one or more interactions with detected and/or simulated light). Displaying the user interface with status information that is overlaid on the dynamic element provides feedback regarding the status information, thereby providing improved visual feedback. Displaying the user interface with status information that is overlaid on the dynamic element provides status information without requiring the user to navigate to a different user interface to access the status information, thereby performing an operation when a set of conditions has been met without requiring further user input and reducing the number of inputs needed to perform an operation. Displaying the user interface with status information that has the appearance of having material with one or more simulated optical properties distinguishes between the status information and other portions of the user interface, thereby providing the user with improved visual feedback.

In some embodiments, the one or more simulated optical properties include simulated translucency (e.g., the appearance of revealing or partially revealing simulated content that appears to be displayed beneath the status information) (e.g., as shown and discussed with respect to FIGS. 10K and 10L). Displaying the user interface with status information that has the appearance of simulated translucency distinguishes between the status information and other portions of the user interface, thereby providing the user with improved visual feedback.

In some embodiments, the one or more simulated optical properties include simulated refraction (e.g., the appearance of distorting simulated content that appears to be displayed beneath the status information) (e.g., as shown and discussed with respect to FIGS. 10K and 10L). Displaying the user interface with status information that has the appearance of simulated refraction distinguishes between the status information and other portions of the user interface, thereby providing the user with improved visual feedback.

In some embodiments, the simulated refraction varies spatially across the status information (e.g., the simulated refraction appears different in one portion of the status information than in another portion of the status information). For example, in some embodiments, displaying the status information with the appearance of having simulated refraction includes displaying a first portion of the status information with a first degree of simulated refraction and displaying a second portion of the status information with a second degree of simulated refraction that is different from the first degree of simulated refraction (e.g., with an appearance that light is being deflected differently in the first portion of the status information than in the second portion of the status information) (e.g., discussed with respect to FIGS. 10K and 10L). Displaying the user interface with status information that has the appearance of simulated refraction varies spatially across the status information distinguishes between the status information and other portions of the user interface, thereby providing the user with improved visual feedback.

In some embodiments, the appearance of the dynamic element changes based on movement of the person in a first manner (e.g., by changing size, shape, position, and/or color based on movement of the person, as shown by the changes from the appearance shown in FIG. 12C to the appearance shown in FIG. 12D). In some embodiments, the appearance of the status information changes based on movement of the person in a second manner that is different from the first manner (e.g., by changing a simulated visual effect, such as a simulated optical property, as shown and discussed with respect to FIGS. 10M1 through 10O3). Displaying the user interface with a dynamic element that changes appearance based on movement of the person in a first manner provides feedback regarding movement of the person, thereby providing improved visual feedback. Displaying the user interface with a dynamic element that changes appearance based on movement of the person in a first manner enables the computer system to update the appearance of the user interface to reflect movement of the person and provide a more varied user experience without requiring additional inputs from the user to change the appearance of the user interface, thereby performing an operation when a set of conditions has been met without requiring further user input and reducing the number of inputs needed to perform an operation.

In some embodiments, the status information includes a time and/or date (e.g., 1202, 1204, and/or the current time and/or date at the location of the computer system). Displaying the user interface with status information that includes a date and/or time provides feedback regarding the date and/or time, thereby providing the user with improved visual feedback. Displaying the user interface with status information that includes a date and/or time enables the user to view the time and/or date without requiring the user to navigate to a different user interface to view the time and/or date, thereby performing an operation when a set of conditions has been met without requiring further user input and reducing the number of inputs needed to perform an operation.

In some embodiments, the status information includes startup, enrollment, or device boot status information (e.g., 1214, status information, and/or instructions). For example, in some embodiments, the status information includes a welcome message, a progress indicator (e.g., indicating percent completion and/or a number of steps completed), and/or one or more prompts (e.g., instructions for a user). Displaying the user interface with status information that includes startup, enrollment, or device boot status information provides feedback regarding the startup, enrollment, or device boot status information, thereby providing the user with improved visual feedback. Displaying the user interface with status information that includes startup, enrollment, or device boot status information enables the user to view the startup, enrollment, or device boot status information without requiring the user to navigate to a different user interface to view the startup, enrollment, or device boot status information, thereby performing an operation when a set of conditions has been met without requiring further user input and reducing the number of inputs needed to perform an operation.

FIGS. 14A-14U illustrate exemplary user interfaces with an animation based on presence of a user, in accordance with some embodiments. The user interfaces in these figures are used to illustrate the processes described below, including the processes in FIG. 15.

In some embodiments, computer system 600 displays an animation of a character in response to detecting the presence and/or attention of a user in a region of the physical environment near computer system 600. In some embodiments, the animation consists of several portions. For example, FIG. 14A illustrates a timeline of an animation with five portions (e.g., portions A, B, C, D, and E).

In some embodiments, computer system 600 displays a portion of the animation once and proceeds to display the next portion. In some embodiments, computer system 600 displays a portion of the animation more than once (e.g., a portion of the animation is looped and/or repeated before displaying the next portion). For example, in some embodiments, computer system 600 repeats portions B and D, as illustrated in FIG. 14A, for example if the attention of a user is directed away from computer system 600.

In FIG. 14B, computer system 600 displays user interface 1400a on display 602. In some embodiments, computer system 600 displays user interface 1400a in response to detecting an event corresponding to a request to display a respective user interface, as described with respect to FIG. 8A. In the example shown in FIG. 14B, computer system 600 displays contextual information in user interface 1400a, including day indication 1402, date indication 1404, and element 1406 (e.g., a complication).

In some embodiments, day indication 1402 is a user-selectable graphical object that displays the current day of the week. For example, as shown in FIG. 14B, day indication 1402 indicates that the current day of the week is Sunday. In some embodiments, computer system 600 displays a calendar application in response to input 1450 (e.g., a tap input, air tap input, gaze dwell input, and/or other selection input) directed to day indication 1402, as shown in FIG. 14S. In some embodiments, date indication 1404 is an indication of the current date. For example, as shown in FIG. 14B, date indication 1404 indicates that the current date is the 5th. In some embodiments, date indication 1404 is not selectable to display a corresponding application.

In some embodiments, a complication is a user-selectable graphical user interface object that displays information from a corresponding application. For example, as shown in FIG. 14B, element 1406 is a complication that indicates the current time. In some embodiments, computer system 600 displays a corresponding application in response to an input directed to element 1406, such as input 1452 (e.g., a tap input, air tap input, gaze dwell input, and/or other selection input). For example, in some embodiments, computer system 600 displays a clock application in response to input 1452.

Various features and/or examples of computer system 600, user interface 1400a, and/or other user interfaces described herein, are described using the example of a tablet computer, as shown in FIGS. 14A-14B. In some embodiments, the user interfaces displayed by computer system 600 are implemented on and/or displayed by HMD 6000, depicted in FIG. 14B1. In FIG. 14B1, HMD 6000 includes display generation component 6002, and user interface 1400a is displayed as a virtual window or widget (such as world-locked or environment-locked object that is displayed with an appearance that maintains a fixed location in the world or environment as the viewpoint of the user moves) within a three-dimensional augmented reality or virtual reality environment. In some embodiments, user interface 1400a is displayed within three-dimensional environment 6010 (e.g., a virtual passthrough environment or optical passthrough environment). In some embodiments in which computer system 600 is a head-mounted system (e.g., HMD 6000), computer system 600 optionally includes two displays (e.g., one for each eye of a user), with each display displaying respective various content, to enable a user of computer system 600 to perceive the various depths of the various content (e.g., physical objects and/or virtual objects) of the three-dimensional environments. For example, in some embodiments, display generation component 6002 displays content for a left eye of the user, and a separate display generation component displays content for a right eye of the user. In some embodiments, user inputs directed to computer system 600 are shown and/or described as particular types of inputs (e.g., touch inputs and/or button press inputs). In various embodiments, other types of user inputs are used. For example, in some embodiments, gaze inputs and/or air gesture inputs are used to interact with computer system 600, user interface 1400a, and/or other user interfaces described herein.

Returning to FIG. 14B, in some embodiments, computer system 600 detects, using camera sensor 606, attention of a user. In some embodiments, computer system 600 determines whether the attention of a user is directed to computer system 600 based on gaze, head position, and/or user position relative to computer system 600. In some embodiments, computer system 600 detects the overall position and/or orientation of user 1490 relative to computer system 600 and determines whether user 1490 is directed toward computer system 600. In some embodiments, computer system 600 detects the position and/or orientation of the head of user 1490 and determines whether the head is directed toward computer system 600.

In some embodiments, computer system 600 detects the direction of the eyes of user 1490 and determines whether the gaze is directed toward computer system 600. For example, in FIG. 14B, computer system 600 determines that the gaze of user 1490 is not directed toward computer system 600 (e.g., as indicated by the dotted line extending from user 1490 away from computer system 600).

In some embodiments, while displaying user interface 1400a, computer system 600 determines that the attention of user 1490 is directed toward computer system 600. For example, in FIG. 14C, computer system 600 determines that the gaze of user 1490 is directed toward computer system 600 (e.g., as indicated by the dotted line extending from user 1490 to computer system 600). In some embodiments, computer system 600 determines that the attention of user 1490 is directed toward computer system 600 based on the direction and/or orientation of a portion of the user, such as, e.g., the head, shoulders, arm(s), hand(s), and/or finger(s) of user 1490. For example, in some embodiments, computer system 600 determines that the attention of user 1490 is directed toward computer system 600 because user 1490 is pointing at computer system 600 and/or the head of user 1490 is facing towards computer system 600, display 602, and/or camera sensor 606. In some embodiments, computer system 600 determines that the attention of user 1490 is directed toward computer system 600 because user 1490 is interacting with computer system 600, e.g., by providing an input that is detected by computer system 600 (e.g., a tap input, air tap input, voice input, gaze dwell input, and/or other input).

In some embodiments, computer system 600 initiates display of a multi-portion animation in response to determining that attention of the user is directed toward computer system 600. For example, while displaying user interface 1400a, computer system 600 detects that the attention of user 1490 is directed toward computer system 600 and computer system 600 displays the first portion of the animation, as shown in FIG. 14C. In some embodiments, computer system 600 determines that the attention of user 1490 has been maintained for a threshold amount of time (e.g., 1 second, 3 seconds, 5 seconds, or 10 seconds) before initiating display of the animation.

In some embodiments, computer system 600 initiates display of the animation in response to an input. For example, in some embodiments, computer system 600 initiates the animation shown in FIG. 14C in response to input 1454 directed to user interface 1400a (e.g., shown in FIG. 14B). In some embodiments, computer system 600 initiates display of the animation in response to detecting the presence of user 1490 in the region near computer system 600 (e.g., whether or not the attention of user 1490 is directed toward computer system 600). In some embodiments, computer system 600 initiates display of the animation in response to detecting the presence of a second user (e.g., another person in addition to user 1490) in the region near computer system 600.

In some embodiments, the animation includes an anthropomorphic character. In some embodiments, when computer system 600 displays the animation, computer system 600 displays a character that was not previously displayed, such as lizard 1410. In some embodiments, when computer system 600 displays the animation, computer system 600 displays one or more auxiliary items, such as background objects, additional characters, and/or props, such as ladder 1411.

In some embodiments, the first portion of the animation (e.g., portion A) is an introductory animation. In some embodiments, during the introductory animation, a character enters into the respective user interface. For example, in FIGS. 14C and 14D, lizard 1410 enters into user interface 1400b. As illustrated in FIG. 14C, computer system 600 displays ladder 1411 dropping down into user interface 1400b and lizard 1410 descending ladder 1411. As illustrated in FIG. 14D, computer system 600 displays lizard 1410 walking to the edge of date indication 1404 and ladder 1411 retracting from user interface 1400c.

In some embodiments, after displaying the first portion of the animation (e.g., portion A), computer system 600 displays a second portion of the animation (e.g., portion B). In some embodiments, the second portion of the animation is a looping animation (e.g., an animation that may be repeated more than once). For example, in FIGS. 14E and 14F, computer system 600 displays lizard 1410 swinging his tail back and forth. In FIG. 14E, lizard 1410 swings his tail forward, as shown in user interface 1400d. In FIG. 14F, lizard 1410 swings his tail backward, as shown in user interface 1400e.

In some embodiments, in accordance with a determination that the attention of user 1490 is not directed toward computer system 600 (e.g., at the time the second portion of the animation ends), computer system 600 repeats the second portion of the animation. For example, as shown in FIG. 14F, computer system 600 detects that the attention of user 1490 is directed away from computer system 600. As depicted in FIGS. 14G and 14H, computer system 600 repeats the animation of lizard 1410 swinging his tail back and forth because computer system 600 determined that the attention of user 1490 was directed away from computer system 600 in FIG. 14F. In FIG. 14G, lizard 1410 swings his tail forward, as shown in user interface 1400f. In FIG. 14H, lizard 1410 swings his tail backward, as shown in user interface 1400g.

In some embodiments, in accordance with a determination that the attention of user 1490 is directed toward computer system 600 (e.g., at the time the second portion of the animation ends), computer system 600 proceeds to display a subsequent portion of the animation. For example, as shown in FIG. 14H, computer system 600 detects that the attention of user 1490 is once again directed toward computer system 600 and computer system 600 displays a third portion of the animation (e.g., portion C).

In some embodiments, even if computer system 600 determines that the attention of user 1490 is not directed to computer system 600 (e.g., at the time the portion of the animation ends), computer system 600 displays a subsequent portion of the animation when a condition is met. For example, in some embodiments, computer system 600 displays the subsequent portion of the animation after computer system 600 displayed a respective portion of the animation a maximum number of times (e.g., three times). For example, in some embodiments, after computer system 600 displays lizard 1410 swinging his tail back and forth three times, computer system 600 displays a subsequent portion of the animation.

As another example, in some embodiments, computer system 600 displays a respective portion of the animation for a maximum total amount of time (e.g., 3 seconds, 6 seconds, or 10 seconds). For example, in some embodiments, after computer system 600 displays lizard 1410 swinging his tail back and forth for 6 seconds, computer system 600 displays a subsequent portion of the animation.

In some embodiments, computer system 600 displays a subsequent animation if computer system 600 detects that the attention of user 1490 has been directed away from computer system 600 and subsequently returned to computer system 600 (e.g., user 1490 looked away and then back) within a threshold period of time (e.g., 1 second, 3 seconds, or 5 seconds). In some embodiments, computer system 600 proceeds to display a subsequent animation if the attention and/or presence of user 1490 has ended for a threshold amount of time.

In some embodiments, after displaying the final instance of the second portion of the animation (e.g., portion B), computer system 600 displays the third portion of the animation (e.g., portion C). In some embodiments, the third portion of the animation is the primary action of the animation. For example, as illustrated in FIGS. 14I through 14N, computer system 600 displays lizard 1410 diving off date indication 1404 and into water 1412 below.

In FIG. 14I, lizard 1410 steps backward on date indication 1404, as shown in user interface 1400h. In FIG. 14J, lizard 1410 takes a running start, as shown in user interface 1400i. In FIG. 14K, lizard 1410 leaps off date indication 1404, as shown in user interface 1400j. In FIG. 14L, lizard 1410 is diving, as shown in user interface 1400k. In FIG. 14M, the dive results in a splash of water 1412, as shown in user interface 1400i. In FIG. 14N, water 1412 is spraying date indication 1404, as shown in user interface 1400m.

In some embodiments, a respective portion of the animation continues, even if attention of user 1490 is not detected. For example, as shown in FIG. 14J, attention of user 1490 is directed away from computer system 600 and computer system 600 proceeds with displaying the third portion of the animation (e.g., portion C). In some embodiments, a respective portion of the animation is not repeated, even if attention of user 1490 is detected. For example, in some embodiments, the third portion of the animation (e.g., portion C) is not repeated.

In some embodiments, after displaying the third portion of the animation, computer system 600 displays a fourth portion of the animation (e.g., portion D). In some embodiments, the fourth portion of the animation is a looping animation. For example, as shown in FIGS. 14O and 14P, computer system 600 displays water 1412 dripping from date indication 1404. In FIG. 14O, water 1412 gathers on date indication 1404, as shown in user interface 1400n. In FIG. 14P, a drop of water 1412 drips from date indication 1404, as shown in user interface 1400o.

In some embodiments, if computer system 600 determines that the attention of user 1490 is not directed towards computer system 600 (e.g., as discussed above with respect to the second portion of the animation), computer system 600 repeats display of the fourth portion of the animation. For example, computer system 600 may repeat the animation of water 1412 dripping from date indication 1404 depicted in FIGS. 14O and 14P.

In some embodiments, if computer system 600 determines that the attention of user 1490 is directed towards computer system 600, computer system 600 displays a fifth portion of the animation (e.g., portion E). In some embodiments, if computer system 600 determines that respective criteria are met (e.g., as discussed above with respect to the second portion of the animation), computer system 600 displays the fifth portion of the animation (e.g., portion E). In the example shown, computer system 600 displays the ending loop animation one time, as shown in FIGS. 14O and 14P, because computer system 600 determines that the attention of user 1490 is directed toward computer system 600 at the end of the first instance of the fourth portion of the animation.

In some embodiments, the fifth portion of the animation corresponds to an ending animation. For example, as illustrated in FIGS. 14Q and 14R, computer system 600 displays an animation of water 1412 clearing up. In FIG. 14Q, water 1412 drips away, as shown in user interface 1400p. In FIG. 14R, the remainder of water 1412 drips away, as shown in user interface 1400q. In some embodiments, after displaying the ending animation, computer system 600 ceases displaying an animation. In some embodiments, after displaying the ending animation, computer system 600 displays user interface 1400a shown in FIG. 14B.

In some embodiments, computer system 600 displays an application user interface in response to detecting a corresponding user input. For example, as shown in FIG. 14R, computer system 600 displays the calendar application shown in user interface 1400q in response to input 1450 (e.g., a tap input, air tap input, gaze dwell input, and/or other selection input) directed to day indication 1402 shown in FIG. 14B.

In some embodiments, computer system 600 displays a variety of types of animations. In some embodiments, computer system 600 displays an animation corresponding to an event with a variable date. For example, in some embodiments, computer system 600 displays an animation corresponding to a sports final and/or championship game, an awards ceremony, and/or a holiday that does not fall on the same date every season and/or year.

In the example shown in FIG. 14T, computer system 600 displays an animation corresponding to a championship basketball game, which does not have a fixed date. In the introductory animation, represented by user interface 1400t1, lizard 1410 enters user interface 1400t1 from the left, dribbling basketball 1414, and basketball hoop 1416 drops down from above. In the introductory loop animation, represented by user interface 1400t2, lizard 1410 dribbles basketball 1414 in place. In the primary action animation, represented by user interface 1400t3, lizard shoots and rebounds basketball 1414, then dribbles behind and to the right of date indication 1404. In the ending loop animation, represented by user interface 1400t4, lizard once again dribbles basketball 1414 in place. Finally, in the ending animation, represented by user interface 1400t5, lizard exits user interface 1400t5 while dribbling basketball 1414.

In some embodiments, a character introduces and/or removes an auxiliary item during the animation. For example, as described with respect to FIG. 14T, lizard 1410 dribbles basketball 1414 into view in user interface 1400t1 and lizard 1410 removes basketball 1414 from view in user interface 1400t5. In some embodiments, when computer system 600 ceases displaying an animation, computer system 600 ceases displaying characters and/or auxiliary items.

In some embodiments, portions of the respective user interface appear to have depth and/or layers. For example, in FIG. 14T, lizard 1410 appears to move in front of and behind date indication 1404 during the animation. For example, lizard 1410 rebounds basketball 1414 and dribbles basketball 1414 behind date indication 1404, as shown by the change from user interface 1400t3 to user interface 1400t4. As another example, lizard 1410 dribbles basketball 1414 in front of date indication 1404 when exiting from user interface 1400t5.

In some embodiments, computer system 600 displays an animation corresponding to current, forecasted, and/or upcoming weather conditions. For example, in some embodiments, computer system 600 displays an animation that includes sun 1418 and suggests that it is sunny outside, as shown in FIG. 14U. In the introductory animation shown in FIG. 14U, represented by user interface 1400u1, sun 1418 fades into view and lizard 1410 enters user interface 1400u1 wearing sunglasses.

In some embodiments, a respective portion of the animation is a holding animation (e.g., no action occurs). For example, in some embodiments, the second portion of the animation (e.g. portion B) is a holding animation. As shown in FIG. 14U, user interface 1400u2 represents a holding animation, in which lizard 1410 remains stationary in user interface 1400u2. In some embodiments, the holding animation loops and/or repeats, as discussed above with respect to FIGS. 14E through 14H. In some embodiments, the holding animation lasts for a predetermined duration (e.g., 0.5, 1, 2, or 5 seconds). In some embodiments, the predetermined duration is repeated when the animation repeats (e.g., the total time is 4 seconds when a 2-second holding animation is repeated for a second time and the total time is 6 second when a 2-second holding animation is repeated for a third time).

In some embodiments, a respective animation includes an additional character. For example, as illustrated in FIG. 14U, the animation includes bird 1420. In the primary action animation, represented by user interface 1400u3, bird 1420 flies in carrying cookie 1422. In this example, bird 1420 gives cookie 1422 to lizard 1410, who eats cookie 1422, and bird 1420 flies away. In the loop animation, represented by user interface 1400u4, lizard 1410 licks his lips. In the ending animation, represented by user interface 1400u4, lizard 1410 exits from user interface 1400u5.

In some embodiments, computer system 600 displays an animation based on a user arriving home. In some embodiments, computer system 600 displays an animation based on a user arriving home withing a predetermined threshold (e.g., recently, such as within the past 1, 2, 5, 10, 30, or 60 minutes). For example, in some embodiments, a character walks in, takes of his shoes, and unpacks his bag based on user 1490 recently arriving home.

In some embodiments, computer system 600 displays an animation based on loud sounds detected in the region near computer system 600. For example, in some embodiments, the character walks in and looks around (e.g., like he is looking for the source of the sound), makes a shushing motion, and then covers his ears and walks away.

In some embodiments, computer system 600 displays an animation based on a device mode (e.g., silent mode and/or do not disturb mode). In some embodiments, the behavior of the character corresponds with the device mode (e.g., character appears focused on a task when computer system 600 is in do not disturb mode). For example, in some embodiments, a character walks in with a stack of books, sits down with the books and reads them (e.g., casting each aside when done), and walks away when all the books have been read.

FIG. 15 is a flow diagram illustrating a method for displaying a user interface with an animation based on presence of a user using a computer system in accordance with some embodiments. Method 1500 is performed at a computer system (e.g., 100, 300, 500, 600, a smartspeaker, a head-mounted device, a smartwatch, a smartphone, a tablet computer, a laptop computer, and/or a desktop computer) that is in communication with one or more display generation components (e.g., 602, a display controller, a display, a touch-sensitive display system, a touchscreen, a head-mounted display, and/or a monitor) and one or more input devices (e.g., 602, 604, 606, a touch-sensitive surface, a touchscreen display, a button, a keyboard, a mouse, a joystick, a camera sensor, a light sensor, a motion sensor, and/or a microphone). Some operations in method 1500 are, optionally, combined, the orders of some operations are, optionally, changed, and some operations are, optionally, omitted.

As described below, method 1500 provides an intuitive way for displaying a user interface with an animation based on presence of a user. The method reduces the cognitive burden on a user for displaying a user interface with an animation based on presence of a user, thereby creating a more efficient human-machine interface. For battery-operated computing devices, enabling a user to display a user interface with an animation based on presence of a user faster and more efficiently conserves power and increases the time between battery charges.

The computer system displays (1502), via the one or more display generation components, a user interface (e.g., 1400a, a time user interface, a user interface that includes a digital and/or analog indication of time, a clock face, a wake screen, and/or a home screen) that includes contextual information (e.g., 1402, 1404, 1406, information that is based on a context, such as time, date, weather, location, a state of the computer system, and/or a user of the computer system; information that changes when a context changes; and/or information that is different for different contexts). In some embodiments, contextual information is displayed while a person is not detected in a respective region of a physical environment near the one or more display generation components. In some embodiments, the computer system operates in a low power state in which the computer system displays a user interface (e.g., a low power user interface) without displaying the contextual information. In some embodiments, a low power state is a state in which the computer system has a lower brightness, a display has a slower refresh rate, a lower power processor is in use, a processor is in a lower power state, and/or one or more additional sensors are taking less frequent sensor measurements compared to a higher power state in which the computer system has a higher brightness, a display has a faster refresh rate, a higher power processor is in use, a processor is in a higher power state, and/or one or more additional sensors are taking more frequent sensor measurements. In some embodiments, the computer system operates in a low power state in which the computer system does not display a user interface (e.g., the one or more display generation components are off).

In some embodiments, while displaying the user interface that includes contextual information (or, in some embodiments, while the computer system is in a low power state, is displaying a low power user interface, is displaying a user interface that does not include contextual information, and/or is not displaying a user interface), the computer system detects (1504), via the one or more input devices, a change in presence of a person (e.g., 1490) in a respective region of a physical environment near (e.g., proximate to, within a threshold distance of, and/or within a detection range of) the one or more display generation components (e.g., a change in position of a person, a change in distance between a person and the computer system, and/or a change in whether a person is within a threshold distance of the computer system). In some embodiments, detecting a change in presence of a person includes detecting that a person was not present (e.g., was outside a range of the one or more input devices and/or beyond a threshold distance from the computer system) and detecting that the person becomes present (e.g., becomes within the range of the one or more input devices and/or within a threshold distance of the computer system). In some embodiments, the change in presence of a person includes a person moving closer to the computer system or farther away from the computer system. In some embodiments, the change in presence of a person includes an additional person becoming present (e.g., a first person was present and a second person comes into range of the computer system).

In some embodiments, in response to detecting the change in presence of the person in the respective region of the physical environment near the one or more display generation components, the computer system displays (1506), via the one or more display generation components, in the user interface, an animation of an anthropomorphic character (e.g., 1410) that is displayed concurrently with at least a portion of the contextual information (e.g., an animal character, a cartoon character, a fictional character, and/or a non-alphanumeric character). In some embodiments, the animation of the anthropomorphic character includes movement of the anthropomorphic character over time. In some embodiments, the animation of the anthropomorphic character includes the anthropomorphic character interacting with the contextual information. In some embodiments, the animation of the anthropomorphic character includes the anthropomorphic character interacting with one or more objects (e.g., props). In some embodiments, the animation of the anthropomorphic character includes the anthropomorphic character interacting with one or more other animated characters. In some embodiments, if a change in presence of a person is not detected, the computer system displays the user interface without displaying the animation of the anthropomorphic character (e.g., the computer system forgoes displaying the animation of the anthropomorphic character).

Displaying an animation of an anthropomorphic character in response to detecting the change in presence of the person in the region of the physical environment near the one or more display generation components provides feedback regarding detection of the change in presence of the person, thereby providing the user with improved visual feedback. Displaying an animation of an anthropomorphic character, in the user interface, in response to detecting the change in presence of the person enables the computer system to update the appearance of the user interface based on the presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the contextual information includes an indication of a date (e.g., 1402, 1404, and/or the current date at the location of the computer system). Displaying the user interface that includes an indication of a date provides feedback regarding the date, thereby providing the user with improved visual feedback. Displaying the user interface with an indication of a date enables the user to view the indication of the date without requiring the user to navigate to a different user interface to view the indication of the date, thereby performing an operation when a set of conditions has been met without requiring further user input and reducing the number of inputs needed to perform an operation.

In some embodiments, the contextual information includes an indication of time (e.g., 1406 and/or the current time at the location of the computer system). Displaying the user interface that includes an indication of time provides feedback regarding the time, thereby providing the user with improved visual feedback. Displaying the user interface with an indication of time enables the user to view the indication of time without requiring the user to navigate to a different user interface to view the indication of the time, thereby performing an operation when a set of conditions has been met without requiring further user input and reducing the number of inputs needed to perform an operation.

In some embodiments, detecting the change in presence of the person in the respective region of the physical environment near the one or more display generation components includes detecting the start of presence of the person in (e.g., entry of the person into) the respective region of the physical environment near the one or more display generation components. Displaying an animation of an anthropomorphic character in response to detecting the start of presence of the person in the respective region of the physical environment near the one or more display generation components enables the computer system to update the appearance of the user interface based on the presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, displaying the animation of the anthropomorphic character includes initiating display of the anthropomorphic character (e.g., the anthropomorphic character is not displayed in the user interface at the time of detecting the change in presence of the person) (e.g., as illustrated by the change from FIG. 14B, which does not include lizard 1410, to FIG. 14C, which includes lizard 1410). In some embodiments, prior to the start of the animation of the anthropomorphic character is not displayed in the user interface. In some embodiments, displaying the animation of the anthropomorphic character includes displaying an animation of the anthropomorphic character entering into the user interface (e.g., walking into the user interface and/or into view). In some embodiments, displaying the animation of the anthropomorphic character includes displaying one or more auxiliary items (e.g., one or more props, additional characters, and/or background components) that were not previously displayed in the user interface. Initiating display of the anthropomorphic character in the user interface in response to detecting the change in presence of the person enables the computer system to update the appearance of the user interface based on the presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the computer system detects (e.g., while displaying the animation of the anthropomorphic character), via the one or more input devices, an end of presence (e.g., an absence and/or lack of presence) of the person in the respective region of the physical environment near the one or more display generation components. In some embodiments, in response to detecting the end of presence of the person in the respective region of the physical environment near the one or more display generation components, the computer system ceases display of, in the user interface, the animation of the anthropomorphic character (e.g., after user 1490 leaves the respective region of the physical environment near the one or more display generation components, the computer system displays user interface 1400a shown in FIG. 14B). In some embodiments, the animation of the anthropomorphic character pauses and/or does not proceed in response to detecting the end of presence of the person. In some embodiments, the computer system displays an ending portion of the animation of the anthropomorphic character in response to detecting the end of presence of the person. Ceasing display of the animation of the anthropomorphic character in response to detecting the end of presence of the person enables the computer system to update the appearance of the user interface based on the lack of presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, ceasing display of the animation of the anthropomorphic character includes ceasing display of the anthropomorphic character (e.g., user interface 1400a, shown in FIG. 14B, does not include lizard 1410). In some embodiments, ceasing display of, in the user interface, the anthropomorphic character includes displaying an animation of the anthropomorphic character leaving and/or exiting the user interface (e.g., walking off the user interface and/or out of view). Ceasing display of the anthropomorphic character in response to detecting the end of presence of the person enables the computer system to update the appearance of the user interface based on the lack of presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, ceasing display of the animation of the anthropomorphic character includes ceasing display of one or more auxiliary items (e.g., one or more props, additional characters, and/or background components other than the anthropomorphic character) (e.g., user interface 1400a, shown in FIG. 14B, does not include ladder 1411). Ceasing display of one or more auxiliary items in response to detecting the end of presence of the person enables the computer system to update the appearance of the user interface based on the lack of presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, ceasing display of the animation of the anthropomorphic character includes displaying an animation of the anthropomorphic character removing, from the user interface, one or more of the one or more auxiliary items (e.g., an animation of the anthropomorphic character carrying one of more of the auxiliary items out of view, as illustrated by lizard 1410 leaving user interface 1400t5 with basketball 1414). Displaying an animation of the anthropomorphic character removing one or more of the one or more auxiliary items from the user interface in response to detecting the end of presence of the person enables the computer system to update the appearance of the user interface based on the lack of presence of the person and provide a more varied user experience without requiring additional inputs from the user to update the appearance of the user interface, thereby performing an operation when a set of conditions has been met without requiring further user input and reducing the number of inputs needed to perform an operation.

In some embodiments, while displaying the anthropomorphic character (e.g., during an active or static portion of the animation of the anthropomorphic character), the computer system detects, via the one or more input devices, a first change in attention (e.g., based on gaze and/or head position, such as the change in gaze depicted from the direction shown in FIG. 14G away from the computer system to the direction shown in FIG. 14H towards the computer system) of the person. In some embodiments, in response to detecting the first change in the attention of the person, the computer system displays, via the one or more display generation components, a change (e.g., a transition from one portion to another) in the animation of the anthropomorphic character (e.g., a change in animation from portion B to portion C). For example, in some embodiments, the anthropomorphic character changes from performing a first action, such as tapping a foot and/or wagging a tail, to performing a set of one or more second actions, such as running, jumping, and/or diving. In some embodiments, the anthropomorphic character changes from performing a first action, such a tapping a foot and/or wagging a tail, to exiting from the user interface and/or removing items from the user interface. Displaying a change in the animation of the anthropomorphic character in response to detecting a first change in attention of the person enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation.

In some embodiments, while displaying the anthropomorphic character and before detecting the first change in the attention of the person, the computer system repeats (e.g., looping, replaying, and/or continually repeating) display of a first portion of the animation (e.g., a holding animation) of the anthropomorphic character (e.g., as illustrated by the repetition of the animation in FIGS. 14E through 14H). For example, in some embodiments, the anthropomorphic character taps a foot and/or wags a tail during the first portion of the animation. Repeating the display of the first portion of the animation of the anthropomorphic character before detecting the first change in the attention of the person enables the computer system to delay displaying a subsequent portion of the animation of the anthropomorphic character when attention of the person has not been detected, thereby providing the user with improved visual feedback.

In some embodiments, displaying the animation of the anthropomorphic character includes displaying, via the one or more display generation components, a second portion of the animation (e.g., a primary animation and/or a holding animation, such as the animation shown in FIGS. 14O and 14P) of the anthropomorphic character. In some embodiments, after displaying the second portion of the animation of the anthropomorphic character: in accordance with a determination that the attention (e.g., based on gaze and/or head direction) of the person is detected as being directed to the user interface, the computer system displays, via the one or more display generation components, a third portion (e.g., an ending portion, such as the animation shown in FIGS. 14Q and 14R) of the animation of the anthropomorphic character that is different from the second portion of the animation of the anthropomorphic character. For example, in some embodiments, the anthropomorphic character performs a set of one or more actions, such as running, jumping, and/or diving, during the third portion of the animation. In some embodiments, the anthropomorphic character exits the user interface during the third portion of the animation. In some embodiments, after displaying the second portion of the animation of the anthropomorphic character: in accordance with a determination that the attention of the person is not detected as being directed to the user interface, the computer system forgoes display of the third portion of the animation of the anthropomorphic character (e.g., the computer system forgoes displaying the animation shown in FIGS. 14Q and 14R and/or repeats displaying the animation shown in FIGS. 14O and 14P). Displaying a third portion of the animation of the anthropomorphic character in accordance with a determination that the attention of the person is detected enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation. Forgoing display of the third portion of the animation of the anthropomorphic character in accordance with a determination that the attention of the person is not detected enables the computer system to delay displaying the third portion of the animation of the anthropomorphic character when attention of the person has not been detected, thereby providing the user with improved visual feedback.

In some embodiments, after displaying the second portion of the anthropomorphic character: in accordance with a determination that the attention (e.g., based on gaze and/or head direction) of the person is not detected as being directed to the user interface (e.g., as illustrated by the direction of the gaze of user 1490 in FIG. 14F), the computer system displays, via the one or more display generation components, a fourth portion of the animation (e.g., a holding animation) of the anthropomorphic character (e.g., the animation shown in FIGS. 14F and 14G). In some embodiments, the fourth portion of the animation of the anthropomorphic character is the second portion of the animation of the anthropomorphic character (e.g., the second portion of the animation is repeated in accordance with a determination that attention of the person is not detected). For example, in some embodiments, the anthropomorphic character taps a foot and/or wags a tail during the fourth portion of the animation. In some embodiments, the anthropomorphic character remains stationary during the fourth portion of the animation. Displaying a fourth portion of the animation of the anthropomorphic character in accordance with a determination that the attention of the person is not detected enables the computer system to delay displaying the third portion of the animation of the anthropomorphic character when attention of the person has not been detected, thereby providing the user with improved visual feedback.

In some embodiments, after (or, in some embodiments, while) displaying the fourth portion of the animation of the anthropomorphic animation, the computer system detects, via the one or more input devices, the attention of the person being directed to the user interface (e.g., as illustrated by the direction of the gaze of user 1490 in FIG. 14H). In some embodiments, in response to detecting the attention of the person after displaying the fourth portion of the animation, the computer system displays, via the one or more display generation components, the third portion of the animation of the anthropomorphic character (e.g., the animation shown in FIGS. 14I through 14N). For example, in some embodiments, the anthropomorphic character exits the user interface and/or removes items from the user interface during the third portion of the animation. Displaying the third portion of the animation of the anthropomorphic character in response to detecting the attention of the person after displaying the fourth portion of the animation enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the computer system detects (e.g., while displaying the anthropomorphic character), via the one or more input devices, a second change in the attention of the person. In some embodiments, after detecting the second change in the attention of the person: in accordance with a determination that respective criteria are met, changing display (e.g., from one portion to another portion) of the animation of the anthropomorphic character (e.g., from the portion of the animation shown in FIGS. 14O and 14P to the portion of the animation shown in FIGS. 14Q and 14R). For example, in some embodiments, the anthropomorphic character changes from performing a first action, such as tapping a foot and/or wagging a tail, to performing a set of one or more second actions, such as running, jumping, and/or diving. In some embodiments, the anthropomorphic character changes from performing a first action, such a tapping a foot and/or wagging a tail, to exiting from the user interface and/or removing items from the user interface. In some embodiments, after detecting the second change in the attention of the person: in accordance with a determination that the respective criteria are not met, forgoing changing (e.g., maintain current) display of the animation of the anthropomorphic character (e.g., forgoing displaying the portion of the animation shown in FIGS. 14Q and 14R and/or repeating displaying the animation shown in FIGS. 14O and 14P). Changing display of the animation of the anthropomorphic character in accordance with a determination that respective criteria are met and forgoing changing display of the animation of the anthropomorphic character in accordance with a determination that the respective criteria are not met provides feedback regarding whether the respective criteria are met, thereby providing the user with improved visual feedback. Changing display of the animation of the anthropomorphic character in accordance with a determination that respective criteria are met enables the computer system to update the appearance of the user interface based on the respective criteria and provide a more varied user experience without requiring additional inputs from the user to update the appearance of the user interface, thereby performing an operation when a set of conditions has been met without requiring further user input and reducing the number of inputs needed to perform an operation.

In some embodiments, the respective criteria include that a second person (e.g., an additional person and/or a person other than user 1490) has been detected. Changing and forgoing changing display of the animation of the anthropomorphic character in accordance with a determination regarding detection of a second person provides feedback regarding detection of the second person, thereby providing the user with improved visual feedback. Changing display of the animation of the anthropomorphic character in accordance with a determination regarding detection of the second person enables the computer system to update the appearance of the user interface based on the detected attention of the second person and provide a more varied user experience without requiring additional inputs from the user to update the appearance of the user interface, thereby performing an operation when a set of conditions has been met without requiring further user input and reducing the number of inputs needed to perform an operation.

In some embodiments, the respective criteria include that the attention (e.g., based on gaze and/or head direction) of the person is not directed toward the user interface (e.g., ceased to be directed toward the user interface or the computer system) for a threshold duration of time (e.g., that attention of the person directed toward the user interface has ended and that the threshold duration of time has elapsed since the attention of the person directed toward the user interface has ended). Changing and forgoing changing display of the animation of the anthropomorphic character in accordance with a determination regarding detection that the attention of the person has ended provides feedback regarding detection that the attention of the person has ended, thereby providing the user with improved visual feedback. Changing display of the animation of the anthropomorphic character in accordance with a determination regarding detection that the attention of the person has ended enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the respective criteria include that the attention (e.g., based on gaze and/or head direction) of the person has been maintained directed toward the user interface (e.g., directed toward the computer system) for a threshold amount of time (e.g., 2 seconds, 5 seconds, or 10 seconds). Changing and forgoing changing display of the animation of the anthropomorphic character in accordance with a determination regarding detection that the attention of the person has been maintained provides feedback regarding detection that the attention of the person has been maintained, thereby providing the user with improved visual feedback. Changing display of the animation of the anthropomorphic character in accordance with a determination regarding detection that the attention of the person has been maintained enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the respective criteria include that the attention (e.g., based on gaze and/or head direction) of the person has not been directed to the user interface (e.g., directed to the computer system) for a threshold amount of time (e.g., 0.5, 1, 2, 3, 5, 10, 15, or 30 seconds). For example, in some embodiments, the respective criteria include that the attention of the person has not been detected for the threshold amount of time (e.g., regardless of whether the attention of the person has previously been detected). Changing and forgoing changing display of the animation of the anthropomorphic character in accordance with a determination regarding detection that the attention of the person has not been maintained for a threshold amount of time provides feedback regarding detection that the attention of the person has not been maintained for a threshold amount of time, thereby providing the user with improved visual feedback. Changing display of the animation of the anthropomorphic character in accordance with a determination regarding detection that the attention of the person has not been maintained for a threshold amount of time enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the respective criteria include that the attention (e.g., based on gaze and/or head direction) of the person has been directed away from the user interface (e.g., as illustrated by the direction of gaze of user 1490 away from the computer system in FIG. 14O) (e.g., for at least a first threshold amount of time, and optionally, for less than a second threshold amount of time) and subsequently directed (e.g., returned) toward the user interface (e.g., as illustrated by the direction of gaze of user 1490 towards the computer system in FIG. 14P). In some embodiments, the respective criteria include detection that the person looked away (e.g., based on eye gaze and/or head direction) from the computer system and back towards the computer system. Changing and forgoing changing display of the animation of the anthropomorphic character in accordance with a determination regarding detection that the attention of the person has been directed away from the computer system and subsequently directed toward the computer system provides feedback regarding detection that the attention of the person has been directed away from the computer system and subsequently directed toward the computer system, thereby providing the user with improved visual feedback. Changing display of the animation of the anthropomorphic character in accordance with a determination regarding detection that the attention of the person has been directed away from the computer system and subsequently directed toward the computer system enables the computer system to update the appearance of the user interface based on the detected attention of the person and provide a more varied user experience without requiring additional inputs from the user to update the appearance of the user interface, thereby performing an operation when a set of conditions has been met without requiring further user input and reducing the number of inputs needed to perform an operation.

In some embodiments, the animation of the anthropomorphic character is based on a local context of the computer system (e.g., a context of the respective region of the physical environment near the one or more display generation components and/or at the GPS location of the computer system) (e.g., as illustrated in FIG. 14U, the animation relates to sunny weather because the computer system detected that the weather is sunny at the location of the computer system). For example, in some embodiments, displaying the animation of the anthropomorphic character includes: in accordance with a determination of a first local context, displaying the animation of the anthropomorphic character in a first manner (e.g., with a first set of characteristics); and in accordance with a determination of a second local context that is different from the first local context, displaying the animation of the anthropomorphic character in a second manner that is different from the first manner (e.g., with a second set of characteristics that is different from the first set of characteristics). Displaying an animation of the anthropomorphic character that is based on a local context of the computer system provides feedback regarding the local context of the computer system, thereby providing the user with improved visual feedback. Displaying an animation of the anthropomorphic character based on a local context of the computer system adjusts the appearance of the user interface based on the local context without requiring user input, thereby performing an operation when a set of conditions has been met without requiring further user input and reducing the number of inputs needed to perform an operation.

In some embodiments, the local context of the computer system includes arrival of the person at the location of the computer system (e.g., at the home of the person at which the computer system is located and/or arrival within of the person within respective region of the physical environment near the one or more display generation components). In some embodiments, the local context of the computer system includes arrival of the person at the location of the computer system within a threshold time period (e.g., recently, such as within the past minute, 5 minutes, or 10 minutes). Displaying an animation of the anthropomorphic character that is based on arrival of the person at the location of the computer system provides feedback regarding a detected arrival of the person at the location of the computer system, thereby providing the user with improved visual feedback. Displaying an animation of the anthropomorphic character based on arrival of the person at the location of the computer system adjusts the appearance of the user interface based on the arrival of the person without requiring user input, thereby performing an operation when a set of conditions has been met without requiring further user input and reducing the number of inputs needed to perform an operation.

In some embodiments, the local context of the computer system includes detected sound above a predetermined threshold (e.g., loud sounds) within the respective region of the physical environment near the one or more display generation components. In some embodiments, the local context of the computer system includes the detected sound being above a predetermined threshold within a threshold time period (e.g., recently, such as within the past 5 seconds, 30 seconds, or 1 minute). Displaying an animation of the anthropomorphic character that is based on detected sound above a predetermined threshold provides feedback regarding the detected sound, thereby providing the user with improved visual feedback. Displaying an animation of the anthropomorphic character based on detected sound adjusts the appearance of the user interface based on the detected sound without requiring user input, thereby performing an operation when a set of conditions has been met without requiring further user input and reducing the number of inputs needed to perform an operation.

In some embodiments, the local context of the computer system includes current weather conditions (e.g., hot, cold, snowy, cloudy, sunny, rainy, and/or windy) at the location of the computer system (e.g., based on GPS location) (e.g., as illustrated in FIG. 14U, the animation relates to sunny weather because the computer system detected that the weather is sunny at the location of the computer system). In some embodiments, the local context of the computer system includes a current and/or near future weather forecast. Displaying an animation of the anthropomorphic character that is based on current weather conditions provides feedback regarding the current weather conditions, thereby providing the user with improved visual feedback. Displaying an animation of the anthropomorphic character based on current weather conditions adjusts the appearance of the user interface based on the weather without requiring user input, thereby performing an operation when a set of conditions has been met without requiring further user input and reducing the number of inputs needed to perform an operation.

In some embodiments, the animation of the anthropomorphic character is based on (e.g., corresponds to and/or coordinates with) a current mode of operation of the computer system (e.g., do not disturb mode, a low power mode, a low light mode, and/or silent mode). For example, in some embodiments, displaying the animation of the anthropomorphic character includes: in accordance with a determination that the computer system is operating in a first mode of operation, displaying the animation of the anthropomorphic character in a first manner (e.g., with a first set of characteristics); and in accordance with a determination that the computer system is operating in a second mode of operation that is different from the first mode of operation, displaying the animation of the anthropomorphic character in a second manner that is different from the first manner (e.g., with a second set of characteristics that is different from the first set of characteristics). Displaying an animation of the anthropomorphic character that is based on a current mode of operation of the computer system provides feedback regarding the current device mode of the computer system, thereby providing the user with improved visual feedback. Displaying an animation of the anthropomorphic character based on a current mode of operation of the computer system adjusts the appearance of the user interface based on the mode of operation without requiring user input, thereby performing an operation when a set of conditions has been met without requiring further user input and reducing the number of inputs needed to perform an operation.

In some embodiments, displaying the animation of the anthropomorphic character includes displaying an animation that corresponds to an event that has a variable date (e.g., a sports final and/or championship game, an awards ceremony, and/or a holiday that does not fall on the same date every year), including: in accordance with a determination that a current date is a first date that corresponds to the event, displaying the animation that corresponds to the event. For example, as illustrated in FIG. 14U, in some embodiments, the event that has a variable date is a championship basketball game, for which the date varies (e.g., the championship basketball game could be scheduled on any day of the week and the date is different from year to year and/or season to season). For example, if the date of the championship basketball game is the 15th and the current date is the 15th, the computer system displays an animation that corresponds to the championship basketball game. In some embodiments, in accordance with a determination that the current date is a second date, different from the first date, that corresponds to the event, displaying the animation that corresponds to the event (e.g., display the same animation for the event even though the event occurs on a different date). For example, if the date of the championship basketball game is the 16th and the current date is the 16th, the computer system displays the animation that corresponds to the championship basketball game. In some embodiments, in accordance with a determination that the current date that does not correspond to the event, the computer system forgoes displaying the animation that corresponds to the event. Displaying an animation of the anthropomorphic character that is based on an event with a variable date provides feedback regarding the event with the variable date, thereby providing the user with improved visual feedback.

In some embodiments, the computer system detects, via the one or more input devices, an interaction with (e.g., a tap input, air tap input, gaze dwell input and/or other interaction directed to) the one or more display generation components. In some embodiments, in response to detecting the interaction with the one or more display generation components (e.g., input 1454), the computer system displays, via the one or more display generation components, the animation of the anthropomorphic character (or, in some embodiments, a different animation of the same anthropomorphic character or a different animation of a different anthropomorphic character). For example, in some embodiments, the anthropomorphic character enters into the user interface in response to detecting the interaction with the one or more display generation components. Displaying the animation of the anthropomorphic character in response to detecting the interaction with one of the one or more display generation components reduces the number of inputs required to display the animation of the anthropomorphic character, thereby performing an operation when a set of conditions has been met without requiring further user input and reducing the number of inputs needed to perform an operation.

In some embodiments, the computer system displays, via the one or more display generation components, an indication of a current day (e.g., 1402 and/or the current date and/or day of the week). In some embodiments, the computer system detects, via the one or more input devices, an interaction with (e.g., a tap input, air tap input, gaze dwell input, and/or other selection input directed to) the indication of the current day. In some embodiments, in response to detecting the interaction with the indication of the day, the computer system displays, via the one or more display generation components, a user interface of a calendar application (e.g., the user interface shown in FIG. 14S and/or an application user interface that includes information, such as appointments, meetings, birthdays, holidays, and/or events, for a particular date and/or a set of dates). Displaying a user interface of a calendar application in response to detecting the interaction with the indication of the current day provides the user with access to the calendar application without requiring the user to navigate to a different user interface to access the calendar, thereby performing an operation when a set of conditions has been met without requiring further user input and reducing the number of inputs needed to perform an operation.

In some embodiments, displaying the animation of the anthropomorphic character includes: displaying a first set of one or more elements (e.g., an anthropomorphic character or a portion thereof and/or one or more auxiliary items, such as props) of the animation of the anthropomorphic character with the appearance of being in front of the contextual information (e.g., as shown by lizard 1410 dribbling in front of date indication 1404 in user interface 1400t2 of FIG. 14T). For example, in some embodiments, the anthropomorphic character appears to walk in front of, sit on, and/or stand on the contextual information. In some embodiments, displaying the animation of the anthropomorphic character includes: displaying a second set of one or more elements (e.g., an anthropomorphic character or a portion thereof and/or one or more auxiliary items, such as background items) of the animation of the anthropomorphic character with the appearance of being behind the contextual information (e.g., as shown by lizard 1410 walking behind date indication 1404 in user interface 1400t4 of FIG. 14T). In some embodiments, the anthropomorphic character appears to move in front of and behind the contextual information during the animation of the anthropomorphic character. For example, in some embodiments, the anthropomorphic character appears to walk around and/or behind the contextual information. Displaying the animation of the anthropomorphic character with a first set of one or more elements with the appearance of being in front of the contextual information and a second set of one or more elements with the appearance of being behind the contextual information gives the appearance of depth to the contextual information, thereby providing the user with improved visual feedback.

FIGS. 16A-16L illustrate exemplary user interfaces for providing time user interfaces, in accordance with some embodiments. The user interfaces in these figures are used to illustrate the processes described below, including the processes in FIG. 17.

FIG. 16A illustrates computer system 1600, which is a smart watch with touch-sensitive display 1602, rotatable and depressible input mechanism 1604a, and button 1604b. FIG. 16A depicts computer system 1600 being worn on the wrist of a user. At FIG. 16A, computer system 1600 displays, via touch-sensitive display 1602, user interface 1610. In the depicted embodiments, user interface 1610 is a time user interface (e.g., a watch face user interface) that includes indication of time 1612 overlaid on background 1614. Indication of time 1612 provides an indication of a respective time (e.g., a current time). Background 1614, as will be described in greater detail below, is an animated background that displays movement of two or more colors. In some embodiments, background 1614 includes animated color gradient 1615. In some embodiments, animated color gradient 1615 is a fluid simulation (e.g., simulation of physical fluid) that simulates movement of colored fluid (e.g., within another fluid). In some embodiments, animated background 1614 includes source point 1616. In some embodiments, source point 1616 is not displayed by touch-sensitive display 1602 and/or is not visible within background 1614, but acts as a simulated fluid source and/or injection point from which the simulated colored fluid that creates animated color gradient 1615 is added and/or injected into background 1614. In some embodiments, when the simulated colored fluid is added to background 1614, it is added and/or displayed in a first color. Furthermore, in some embodiments, as time passes, the simulated colored fluid decays and/or changes over time into a second color different from the first color. Accordingly, over time, as the simulated colored fluid is added from source point 1616 into background 1614, newly added simulated colored fluid is displayed in the first color (e.g., represented as darker color in area 1615a in FIG. 16A), while older simulated colored fluid is displayed in the second color (e.g., represented as lighter color in area 1615b in FIG. 16A). In some embodiments, the change from the first color to the second color occurs gradually, such that animated color gradient 1615 has a gradient of a plurality of colors between the first color and the second color (e.g., two, three, four, five or more colors between the first color and the second color). Additionally, in some embodiments, after being displayed in the second color, simulated colored fluid that has been displayed in background 1614 for a threshold duration of time (e.g., simulated colored fluid for which a threshold duration of time has elapsed since being added into background 1614 from source point 1616) ceases to be displayed within background 1614. In this way, new simulated color fluid is being injected into background 1614 in the first color from source point 1616, while older simulated color fluid is gradually changing from the first color to the second color and then ceasing to be displayed.

In some embodiments, in addition to source point 1616 adding new simulated colored fluid to background 1616 to cause movement and/or animation of animated color gradient 1615, background 1614 also includes one or more target points 1618a-1618c. In some embodiments, similar to source point 1616, target points 1618a-1618c are not displayed by touch-sensitive display 1602 and/or displayed within background 1614, but are non-displayed elements that affect movement of and/or animation of animated color gradient 1615. For example, in some embodiments, target points 1618a-1618c act as points of attraction (e.g., regions of gravity and/or greater gravity) that attract animated color gradient 1615 and pull the simulated fluid of animated color gradient 1615 toward target points 1618a-1618c. In some embodiments, and as will be described in greater detail below, source point 1616 and/or target points 1618a-1618c move automatically and/or in response to user input.

In some embodiments, indication of time 1612 is displayed as a simulated glass material (e.g., or other simulated transparent material) through which background 1614 (e.g., animation of background 1614 and/or animated color gradient 1615) is at least partially visible. In some embodiments, indication of time 1612 is displayed with simulated refractive and/or reflective properties that distort background 1614 in regions and/or areas occupied by indication of time 1612. Additionally, in some embodiments, indication of time 1612 is displayed with simulated reflective properties that appear to reflect light off of a simulated curved surface of indication of time 1612. In some embodiments, the simulated light reflections shown on indication of time 1612 move based on detected movement of computer system 1612, to simulate changes in light reflection that would occur with a physical curved, reflective material.

At FIG. 16A, the user is not moving computer system 1600 and/or computer system 1600 does not detect movement, and touch-sensitive display 1602 is positioned parallel to the ground (e.g., perpendicular to gravity). In some embodiments, source point 1616 moves automatically within background 1614. For example, in some embodiments, source point 1616 moves in a clockwise direction, as indicated by arrow 1611. At FIG. 16B, computer system 1600 moves source point 1616 in a clockwise direction to a new position relative to its position in FIG. 16A. In FIG. 16B, as source point 1616 moves to a different position, it can be seen that the movement of source point 1616 causes movement of and/or animation of animated color gradient 1615.

Various features and/or examples of computer system 1600, user interface 1610, and/or other user interfaces described herein, are described using the example of a smart watch, as shown in FIGS. 16A-16B. In some embodiments, the user interfaces displayed by computer system 1600 are implemented on and/or displayed by HMD 6000, depicted in FIG. 16B1. In FIG. 16B1, HMD 6000 includes display generation component 6002, and user interface 1610 is displayed as a virtual window or widget (such as world-locked or environment-locked object that is displayed with an appearance that maintains a fixed location in the world or environment as the viewpoint of the user moves) within a three-dimensional augmented reality or virtual reality environment. In some embodiments, user interface 1610 is displayed within three-dimensional environment 6010 (e.g., a virtual passthrough environment or optical passthrough environment). In some embodiments, in which computer system 1600 is a head-mounted system (e.g., HMD 6000), computer system 1600 optionally includes two displays (e.g., one for each eye of a user), with each display displaying respective various content, to enable a user of computer system 1600 to perceive the various depths of the various content (e.g., physical objects and/or virtual objects) of the three-dimensional environments. For example, in some embodiments, display generation component 6002 displays content for a left eye of the user, and a separate display generation component displays content for a right eye of the user. In some embodiments, user inputs directed to computer system 1600 are shown and/or described as particular types of inputs (e.g., movement inputs, touch inputs, and/or button press inputs). In various embodiments, other types of user inputs are used. For example, in some embodiments, other types of movement inputs, gaze inputs, and/or air gesture inputs are used to interact with computer system 1600, user interface 1600, and/or other user interfaces described herein.

At FIG. 16B, computer system 1600 detects movement 1620 of computer system 1600. At FIG. 16C, as a result of movement 1620, touch-sensitive display 1602 is no longer parallel to ground (e.g., is no longer perpendicular to gravity), and is now tilted such that a top edge of computer system 1600 is now pointed upwards (e.g., away from the ground and/or away from the direction of gravity) and a bottom edge of computer system 1600 is now pointed downwards (e.g., towards the ground and/or towards the direction of gravity). In some embodiments, source point 1616 moves away from the direction of gravity, and target points 1618a-1618c move in the direction of gravity. At FIG. 16C, in response to detecting movement 1620, computer system 1600 moves source point 1616 upwards (e.g., away from the direction of gravity), and moves target points 1616a-1616c downwards (e.g., towards the direction of gravity). As discussed above, in some embodiments, source point 1616 and target points 1618a-1618c are not displayed and/or visible elements. However, movement by source point 1616 and target points 1618a-1618c do have a visible effect on movement and/or animation of animated color gradient 1615 (e.g., moving more of the first color towards the top of touch-sensitive display 1602 as source point 1616 moves upward, and pulling some of animated color gradient 1615 downwards as target points 1618a-1618c move downward). In some embodiments, in response to detecting movement 1620, computer system 1600 also displays movement of simulated reflections on indication of time 1612 (e.g., moving reflections towards the tops of the numbers in indication of time 1612). At FIG. 16C, computer system 1600 detects movement 1622 of computer system 1600.

At FIG. 16D, as a result of movement 1622, computer system 1600 is now tilted in the opposite direction of FIG. 16C, such that the bottom of computer system 1600 is now pointed upwards (e.g., away from the direction of gravity and/or away from the ground) and the top of computer system 1600 is now pointed downwards (e.g., towards the direction of gravity and/or towards the ground). At FIG. 16D, in response to detecting movement 1622, computer system 1600 moves source point 1616 downwards and moves target points 1618a-1618c upwards. Movement 1622 causes changes to the movement of and/or animation of animated color gradient 1615. For example, in FIG. 16D, more of the first color is shown proximate to the lower edge of touch-sensitive display 1602 (e.g., as source point 1616 moves downward), and portions of animated color gradient 1615 are pulled upwards as target points 1618a-1618c move upwards. In some embodiments, in response to detecting movement 1622, computer system 1600 also displays movement of simulated reflections on indication of time 1612 (e.g., moving reflections towards the bottoms of the numbers in indication of time 1612). At FIG. 16D, computer system 1600 detects movement 1624 of computer system 1600 that is consistent with a wrist down gesture by the user (e.g., consistent with movement indicative of the user no longer looking at computer system 1600 and/or consistent with movement of the arm of the user away from the face of the user and/or to a resting position at the side of the user).

In some embodiments, in response to detecting movement 1624, computer system 1600 transitions computer system 1600 from a higher power state to a low power state. In some embodiments, computer system 1600 transitions from the higher power state to the low power state based on low power state criteria being satisfied. In some embodiments, low power state criteria are satisfied, and computer system 1600 transitions from the higher power state to the low power state, when a particular movement is detected (e.g., movement 1624). In some embodiments, low power state criteria are satisfied, and computer system 1600 transitions from the higher power state to the low power state, when user input has not been detected on computer system 1600 for a threshold duration of time. At FIG. 16E, in response to detecting movement 1624 and/or in response to computer system 1600 transitioning from the higher power state to the low power state (and/or, in some embodiments, in response to determining that low power state criteria are satisfied), computer system 1600 displays a low power version of user interface 1610. As seen in FIG. 16E, in some embodiments, in the low power version of user interface 1610, portions of background 1614 that are outside of indication of time 1612 are no longer displayed and/or are masked (e.g., by a solid color, by a dark color, and/or by black). As such, the animation of background 1614 is no longer visible outside of indication of time 1612, but remains visible within and/or through indication of time 1612. This can be done, for example, to darken touch-sensitive display 1602 and/or reduce the brightness of visual output by touch-sensitive display 1602, which reduces power consumption, while still maintaining visibility of indication of time 1612. The right side of FIG. 16E depicts the entirety of background 1614 to demonstrate that portions of background 1614 that are outside of indication of time 1612 have been masked and/or obscured on touch-sensitive display 1602. In some embodiments, indication of time 1612 is displayed at a smaller size in the low power version of user interface 1610 (e.g., FIG. 16E) than in the higher power version of user interface 1610 (e.g., FIGS. 16A-16D).

In some embodiments, when low power state criteria are satisfied and/or when computer system 1600 transitions to the low power state, computer system 1600 changes the colors in animated color gradient 1615. For example, as discussed above, in some embodiments, animated color gradient 1615 in FIGS. 16A-16D (e.g., while computer system 1600 is operating in the higher power state) includes a first color, a second color, and one or more colors between the first color and the second color. In some embodiments, when low power state criteria are satisfied and/or when computer system 1600 transitions to the low power state, computer system 1600 removes the first color from animated color gradient 1615 while maintaining the second color in animated color gradient 1615, and/or adds one or more colors to animated color gradient 1615 (e.g., while, optionally, maintaining the first color and the second color in animated color gradient 1615 and/or removing at least one of the first color or the second color from animated color gradient 1615). For example, in some embodiments, computer system 1600 adds the color black and/or a different dark color to animated color gradient 1615 (e.g., in place of the first color to the second color, or as an additional color stop in the color gradient while maintaining the first color and the second color) when computer system transitions to the low power state and/or when the low power version of user interface 1610 is displayed. This can be done, for example, to darken the colors in animated color gradient 1615, thereby reducing power consumption.

In some embodiments, when low power state criteria are satisfied and/or when computer system 1600 transitions to the low power state, computer system 1600 moves source point 1616 to the center of touch-sensitive display and/or the center of indication of time 1612. In some embodiments, when low power state criteria are satisfied and/or when computer system 1600 transitions to the low power state, computer system 1600 slows down movement and/or animation of background 1614 (e.g., slows down movement and/or animation of animated color gradient 1615) and/or stops movement and/or animation of background 1614. FIGS. 16E-16F depict an embodiment in which movement and/or animation of background 1614 is slowed, and not stopped, while computer system 1600 is operating in the low power state. At FIG. 16F, animation of background 1614 has caused background 1614 and/or animated color gradient 1615 to change, and at least a portion of the change is visible through indication of time 1612 on touch-sensitive display 1602. Additionally, at FIG. 16F, the time has changed from “10:09” to “10:10,” resulting in a change in the shape of indication of time 1612, and resulting in different portions of background 1614 being visible through indication of time 1612 (e.g., based on the change in shape of indication of time 1612 to reflect the current time). At FIG. 16F, computer system 1600 detects movement 1628a (e.g., a wrist raise gesture indicative of the user moving computer system 1600 towards his face and/or the user looking at computer system 1600); user input 1628b (e.g., a tap input); and/or user input 1628c (e.g., a press of rotatable and depressible input mechanism 1604a).

At FIG. 16G, in response to detecting movement 1628a, user input 1628b, and/or user input 1628c, computer system 1600 detects that criteria are satisfied for transitioning computer system 1600 from the low power state to the higher power state. At FIG. 16G, in response to detecting that criteria are satisfied for transitioning computer system 1600 from the low power state to the higher power state, computer system 1600 transitions computer system 1600 from the low power state to the higher power state, and displays the unmasked, higher power version of user interface 1610, in which portions of background 1614 outside of indication of time 1612 are no longer masked (e.g., are displayed).

FIGS. 16A-16G above discussed scenarios and/or embodiments in which computer system 1600 displays a higher power version of user interface 1610 when computer system 1600 is operating in the higher power state, and a low power version of user interface 1610 (e.g., a masked version of user interface 1610) when computer system 1600 is operating in the low power state. In some embodiments, computer system 1600 provides a user-selectable setting which, when enabled, causes computer system 1600 to display the low power version of user interface 1610 (e.g., a masked version of user interface 1610 and/or the version of user interface 1610 shown in FIGS. 16E-16F) regardless of whether computer system 1600 is operating in the higher power state or the low power state.

In some embodiments, computer system 1600 periodically removes source point 1616 and/or one or more of target points 1618a-1618c for a period of time (e.g., before reintroducing them). For example, at FIG. 16H, computer system 1600 has removed source point 1600. Accordingly, in FIG. 16H, new colored simulated fluid is not being added to background 1614, which results in animated color gradient 1615 growing smaller in size, and also including fewer portions that are displayed in the first color.

At FIG. 16I, computer system 1600 adds source point 1616 back into background 1614 so that new simulated colored fluid is once again added into background 1614. At FIG. 16H, while computer system 1600 is operating in the higher power state and/or while computer system 1600 displays the higher power version of user interface 1610, computer system 1600 detects user input 1630a (e.g., one or more presses of rotatable and depressible input mechanism 1604a) and/or user input 1630b (e.g., a swipe up input).

At FIG. 16J, in response to detecting user input 1630a and/or user input 1630b, computer system 1600 displays contextual user interface 1632. Contextual user interface 1632 includes indication of time 1634, date indication 1636 (e.g., an indication of the current date and/or a respective date), and contextual content stack 1638. In some embodiments, contextual content stack 1638 includes a stack of two or more cards 1640a-1640c. As shown in FIG. 16J, contextual content stack 1638 includes top card 1640a, middle card 1640b, and bottom card 1640b. In the example shown in FIG. 16J, top card 1640a includes calendar information corresponding to a user of computer system 1600, and middle card includes weather information corresponding to a current location of computer system 1600. In some embodiments, the content and/or order of contextual content stack 1638 changes based on changes in context of computer system 1600. For example, in some embodiments, as the location of computer system 1600 changes, the content of one or more of the cards in contextual content stack 1638 changes based on the change in location of computer system 1600 (e.g., to display weather in the new location). In another example, in some embodiments, top card 1640a is removed from contextual content stack 1638 based on a determination that the event associated with the calendar entry currently shown in top card 1640a has passed. In some embodiments, a user is able to scroll through the cards in contextual content stack 1638 (e.g., changing which card is displayed at the top of contextual content stack 1638) via user input (e.g., via a swipe up or down input on contextual content stack 1638 and/or via rotation of rotatable and depressible input mechanism 1604a). At FIG. 16J, indication of time 1638, date indication 1636, and contextual content stack 1638 are displayed overlaid on background 1614, various embodiments and features of which were described above.

At FIG. 16K, computer system 1600 displays the low power version of user interface 1610 (e.g., a masked version of user interface 1610 in which portions of background 1614 outside of indication of time 1612 are masked and/or obscured). At FIG. 16K, while computer system 1600 is displaying the low power version of user interface 1610, computer system 1600 detects user input 1641a (e.g., a swipe up input) and/or user input 1641b (e.g., one or more presses of rotatable and depressible input mechanism 1604a).

At FIG. 16L, in response to detecting user input 1641a and/or 1641b, computer system 1600 displays a low power version of user interface 1632, in which portions of background 1614 outside of indication of time 1634 are masked (e.g., by a color and/or by black) and/or are not displayed, while portions of background 1614 that are within indication of time 1634 are displayed.

FIG. 17 is a flow diagram illustrating a method for providing time user interfaces using a computer system in accordance with some embodiments. Method 1700 is performed at a computer system (e.g., 100, 300, 500, 600, 1600, and/or 6000) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602, 1602, and/or 6002) (e.g., a display controller, a display, a touch-sensitive display system, a touchscreen, a monitor, and/or a head mounted display system). In some embodiments, the computer system is optionally in communication with one or more one or more input devices (e.g., 602, 1602, 6002, 1604, and/or 1604b) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). Some operations in method 1700 are, optionally, combined, the orders of some operations are, optionally, changed, and some operations are, optionally, omitted.

As described below, method 1700 provides an intuitive way for providing time user interfaces. The method reduces the cognitive burden on a user for accessing time user interfaces, thereby creating a more efficient human-machine interface. For battery-operated computing devices, enabling a user to access time user interfaces faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, while the computer system (e.g., 600, 1600 and/or 6000) is in a first power state (1702) (e.g., a high power state; a normal power state; a regular power state; and/or a higher power state that has higher power consumption than a low power and/or lower power state) (e.g., FIGS. 16A-16D), the computer system displays (1704), via the one or more display generation components (e.g., 602, 1602 and/or 6002), a time user interface (e.g., 610) (e.g., a user interface that includes an analog and/or digital indication of time, a clock face user interface, a watch face user interface, a reduced-power screen, a wake screen, and/or a lock screen) with a first appearance (e.g., 610 in FIGS. 16A-16D) (e.g., a first set of visual characteristics; a first set of visual elements; and/or a first arrangement of visual elements), wherein displaying the time user interface with the first appearance includes concurrently displaying: an indication of a respective time (e.g., 1612) (e.g., an analog and/or digital indication of a current time, past time, or future time; an indication of a respective time that includes one or more digits that are indicative of the respective time; and/or an indication of a respective time that includes one or more clock hands that are indicative of the respective time); and an animated background (e.g., 1614) (e.g., a background that includes movement of one or more visual elements overtime; an animated background that is at least partially positioned behind the indication of the respective time; and/or an animated background that is at least partially obscured by and/or overlapped by the indication of the respective time). While displaying the time user interface with the first appearance (1706), the computer system detects (1708) that low power state criteria are met (e.g., detecting that the user has moved a body part in a prescribed manner; detecting that the user has lowered his or her wrist while wearing the computer system on his or her wrist; detecting one or more user inputs corresponding to a user request to transition to a lower power state; and/or detecting that the user has not provided user input directed to the computer system for a threshold duration of time). In response to detecting that the low power state criteria are met (1710), the computer system displays (1712), via the one or more display generation components, the time user interface (e.g., 1610) with a second appearance (e.g., a second set of visual characteristics; a second set of visual elements; and/or a second arrangement of visual elements) different from the first appearance (e.g., a second appearance that is indicative of the computer system being in the low power state) (e.g., 1610 in FIGS. 16E-16F), wherein, displaying the time user interface with the second appearance includes: displaying (1714) an indication of time (e.g., 1612) (e.g., a second version of the indication of the respective time that is the same as the indication of the respective time; a second version of the indication of the respective time that is a modified version of the indication of the respective time; and/or a second version of the indication of the respective time that includes one or more modifications to the indication of the respective time while, optionally, maintaining one or more visual elements and/or visual characteristics of the indication of the respective time) that includes one or more visual characteristics that are determined based on a respective portion of the animated background (e.g., 1614) that is selected (e.g., to be used to determine an appearance of the indication of time) based on a shape of the indication of time (e.g., in FIG. 16E, only portions of animated background that are within the shape of indication of time 1612 are displayed and/or visible); and ceasing to display (1716) the animated background (e.g., 1614) outside of the respective portion of the animated background (e.g., in FIG. 16E, only portions of animated background that are within the shape of indication of time 1612 are displayed and/or visible). In some embodiments, in response to detecting that the low power state criteria are met, the computer system transitions the computer system from the first power state to a lower power state in which the computer system consumes less power than in the first power state (e.g., a low power state in which the one or more display generation components are darkened to a lower brightness; and/or a lower power state in which the one or more display generation components and/or the time user interface is refreshed at a lower frequency than in the first power state). In some embodiments, the animated background (e.g., 1614) includes (e.g., in some embodiments, is) a simulation of a physical system (e.g., a simulation of a fluid dynamics system). In some embodiments, the low power state criteria include a first timing criterion that pertains to timing of user input and/or user movement (e.g., a timing criterion that is satisfied when it is determined and/or detected that the user has not provided user input directed to the computer system, has not moved in a manner that is consistent with a movement pattern such as a wrist raise gesture or a wrist shake gesture, and/or has not surpassed a threshold amount of movement for a threshold duration of time). In some embodiments, the low power state criteria are satisfied when the first timing criterion is satisfied. In some embodiments, the low power state criteria include a first movement criterion that pertains to detected user movement (e.g., a first movement criterion that is satisfied when it is determined and/or detected that the user has moved a body part in a prescribed manner or in a manner that is consistent with a movement pattern such as a wrist lower gesture or a wrist shake gesture; when it is determined and/or detected that the user has lowered his or her wrist while wearing the computer system on his or her wrist; when one or more user inputs corresponding to a user request to transition to a lower power state are detected; and/or when it is determined and/or detected that the user has not provided user input directed to the computer system and/or has not surpassed a threshold amount of movement for a threshold duration of time). In some embodiments, the low power state criteria are satisfied when the first movement criterion is satisfied. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, displaying the indication of time (e.g., 1612) that includes one or more visual characteristics that are determined based on a respective portion of the animated background (e.g., 1614) that is selected based on a shape of the indication of time comprises: in accordance with a determination that the indication of time is indicative of a first time (e.g., the indication of time is indicating and/or displays a first time) (e.g., 1612 in FIG. 16E), displaying, via the one or more display generation components, the indication of time using a first set of visual characteristics that are determined based on a first portion of the animated background (e.g., a first portion of the animated background that is determined based on a shape of the indication of time that is indicative of the first time); and in accordance with a determination that the indication of time is indicative of a second time different from the first time (e.g., the indication of time is indicating and/or displays a second time) (e.g., 1612 in FIG. 16F), displaying, via the one or more display generation components, the indication of time using a second set of visual characteristics that are different from the first set of visual characteristics and that are determined based on a second portion of the animated background that is different from the first portion of the animated background (e.g., a second portion of the animated background that is determined based on a shape of the indication of time that is indicative of the second time) (e.g., the portion of animated background 1614 that is displayed and/or visible in FIG. 16E is different from the portion of animated background 1614 that is displayed and/or visible in FIG. 16F based on the change in shape of indication of time 1612). In some embodiments, a different portion of the animated background is selected for use in determining an appearance of the indication of time at different times (e.g., at different times that are represented with and/or displayed with different shapes). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, while displaying the time user interface (e.g., 1610) with the second appearance (e.g., FIGS. 16E-16F) (e.g., in some embodiments, while the low power state criteria are met and/or while the computer system is operating in a lower power state): in accordance with a determination that the indication of time (e.g., 1612) is indicative of a first time (e.g., FIG. 16E), the computer system displays, via the one or more display generation components, the indication of time using a first set of visual characteristics that are determined based on a first portion of the animated background (e.g., a first portion of the animated background that is determined based on a shape of the indication of time that is indicative of the first time) (e.g., 1612 in FIG. 16E); and the computer system displays, via the one or more display generation components, the indication of time transitioning from being indicative of the first time to being indicative of a second time different from the first time (e.g., 1612 from FIG. 16E to FIG. 16F), including displaying the indication of time using a second set of visual characteristics that are determined based on a second portion of the animated background that is different from the first portion of the animated background (e.g., a second portion of the animated background that is determined based on a shape of the indication of time that is indicative of the second time) (e.g., the portion of animated background 1614 that is displayed and/or visible in FIG. 16E is different from the portion of animated background 1614 that is displayed and/or visible in FIG. 16F based on the change in shape of indication of time 1612). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, in response to detecting that the low power state criteria are met, the computer system reduces a rate of change of animation of the animated background (e.g., 1614) (e.g., slowing or stopping animation of the animated background). In some embodiments, displaying the indication of time (e.g., 1612) that includes one or more visual characteristics that are determined based on a respective portion of the animated background (e.g., 1614) that is selected based on a shape of the indication of time comprises displaying a first portion of the animated background (e.g., a first portion of the animated background that is overlapped by and/or enclosed by the indication of time). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the animated background (e.g., 1614) includes a first focal point (e.g., 1616). In some embodiments, while displaying, via the one or more display generation components, the animated background (e.g., 1614) with the first focal point (e.g., 1616) positioned at a first location within the animated background (e.g., 1616 in FIG. 16C), detects, via one or more input devices, a first user input (e.g., movement 1622) (e.g., a touch input, a tap input, a gesture input, an air gesture input, and/or a movement input). In some embodiments, in response to detecting the first user input (e.g., movement 1622 in FIG. 16C), the computer system displays, via the one or more display generation components, the animated background (e.g., 1614) with the first focal point (e.g., 1616) positioned at a second location within the animated background different from the first location (e.g., a second location determined based on the first user input) (e.g., from FIG. 16C to FIG. 16D, source point 1616 moves in location based on movement 1622). In some embodiments, the first focal point (e.g., 1616) moves and/or shifts based on user input. In some embodiments, the first focal point acts as a source that injects color and/or objects into the animated background. In some embodiments, the first focal point acts as a sink that absorbs and/or attracts colors and/or objects of the animated background. In some embodiments, the first focal point (e.g., 1616) is not visible and/or is not displayed, but affects visible aspects of the animated background (e.g., 1614). For example, in some embodiments, the first focal point acts as a source that injects visible and/or displayed color and/or objects into the animated background without the focal point itself being directly visible. In another example, in some embodiments, the first focal point acts as a sink and/or gravity source that attracts visible and/or displayed color and/or objects in the animated background without the focal point itself being directly visible. Rather than being directly visible, the location of the focal point can, optionally, be observed by observing the effect of the focal point on content that is displayed via the one or more display generation components. In some embodiments, in response to detecting the first user input (e.g., 1620 and/or 1622): in accordance with a determination that the first user input comprises (e.g., includes, is associated with, and/or corresponds to) a first set of one or more input parameters (e.g., a first input location, a first input duration, a first input direction, and/or a first input direction of movement), the computer system displays, via the one or more display generation components, the animated background with the first focal point positioned at a second location within the animated background different from the first location (e.g., from FIG. 16B to FIG. 16C, source point 1616 moves from a first location to a second location); and in accordance with a determination that the first user input (e.g., 1620 and/or 1622) comprises (e.g., includes, is associated with, and/or corresponds to) a second set of one or more input parameters (e.g., a second input location, a second input duration, a second input direction, and/or a second input direction of movement) different from the first set of one or more input parameters, the computer system displays, via the one or more display generation components, the animated background (e.g., 1614) with the first focal point positioned at a third location within the animated background that is different from the first location and the second location (e.g., from FIG. 16C to FIG. 16D, source point 1616 moves from a second location to a third location). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the animated background (e.g., 1614) includes movement (e.g., movement of one or more simulated objects or substances such as a simulated liquid) towards a first target location (e.g., in some embodiments, movement from the first focal point to the first target location) (e.g., 1618a, 1618b, and/or 1618c). In some embodiments, the first focal point moves and/or shifts based on user input. In some embodiments, the first target location is a fixed location within the animated background (e.g., a center of the animated background and/or a center of the time user interface). In some embodiments, the first target location moves and/or shifts (e.g., over time and/or based on user input). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, displaying the time user interface (e.g., 1610) with the first appearance further comprises: displaying, via the one or more display generation components, the animated background (e.g., 1614) with the first focal point (e.g., 1616) positioned at the first location within the animated background (e.g., FIG. 16G); subsequent to displaying the animated background with the first focal point positioned at the first location within the animated background, displaying, via the one or more display generation components, the animated background without the first focal point (e.g., removing the first focal point from the animated background) (e.g., FIG. 16H); and subsequent to displaying the animated background without the first focal point, displaying, via the one or more display generation components, the animated background with the first focal point positioned at a third location within the animated background (e.g., a third location that is different from or the same as the first location) (e.g., FIG. 16I). In some embodiments, the first focal point is not visible and/or is not displayed, but affects visible aspects of the animated background. For example, in some embodiments, the first focal point acts as a source that injects visible and/or displayed color and/or objects into the animated background without the focal point itself being directly visible, as described in greater detail above. In another example, in some embodiments, the first focal point acts as a sink and/or gravity source that attracts visible and/or displayed color and/or objects in the animated background without the focal point itself being directly visible, as described in greater detail above. In some embodiments, the first focal point occasionally is added or removed from the user interface, causing the one or more simulated objects and/or materials to move differently depending on whether it is present or not. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the first user input includes movement of the computer system (e.g., user input 1620 and/or user input 1622) (e.g., tilting of the computer system and/or rotation of the computer system); and displaying the animated background (e.g., 1614) with the first focal point (e.g., 1616) positioned at a second location within the animated background in response to detecting the first user input comprises: in response to detecting the first user input, moving the first focal point in an upward direction away from a direction of gravity (e.g., a direction of gravity that is detected based on one or more sensors that are in communication with the computer system) (e.g., from FIG. 16B to FIG. 16C, and/or from FIG. 16C to FIG. 16D, source point 1616 moves upward away from the direction of gravity). In some embodiments, the first focal point moves away from a direction of gravity and/or in an upwards direction relative to gravity. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the animated background (e.g., 1614) includes a first respective focal point (e.g., 1616). In some embodiments, in response to detecting that the low power state criteria are met (e.g., FIG. 16E), the computer system moves the first respective focal point (e.g., 1616) from a first position in the animated background (e.g., 1616 in FIG. 16D) to a target position within the animated background that is different from the first position (e.g., 1616 in FIG. 16E). In some embodiments, the first respective focal point is moved to a target location in response to detecting that the low power state criteria are met (e.g., in some embodiments, when transitioning from the first power state to a lower power state). In some embodiments, the target location is a fixed location (e.g., a center of the time user interface or other fixed location within the time user interface). In some embodiments, the first focal point moves and/or shifts based on user input. In some embodiments, the first focal point acts as a source that injects color and/or objects into the animated background. In some embodiments, the first focal point acts as a sink that absorbs and/or attracts colors and/or objects of the animated background. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the animated background (e.g., 1614) further includes a second focal point (e.g., 1618a, 1618b, and/or 1618c) (e.g., in some embodiments, one or more invisible focal points) different from the first focal point (e.g., 1616). In some embodiments, while the computer system is in the first power state (e.g., FIGS. 16A-16D) and while displaying the time user interface (e.g., 1610) with the first appearance, the computer system detects, via one or more input devices, a second user input (e.g., 1620 and/or 1622) (e.g., a touch input, a tap input, a gesture input, an air gesture input, and/or a movement input). In response to detecting the second user input, the computer system: moves the first focal point (e.g., 1616) in a first direction (e.g., a first direction that is determined based on the second user input and/or based on a direction of movement of the second user input) (e.g., from FIG. 16C to FIG. 16D, source point 1616 moves toward the bottom of touch-sensitive display 1602); and moves the second focal point (e.g., 1618a, 1618b, and/or 1618c) in a second direction different from the first direction (e.g., a second direction that is opposite the first direction; and/or a second direction that is determined based on the second user input and/or based on a direction of movement of the second user input) (e.g., from FIG. 16C to FIG. 16D, target points 1618a-1618c move toward the top of touch-sensitive display 1602). In some embodiments, the second focal point (e.g., 1618a, 1618b, and/or 1618c) moves differently from the first focal point (e.g., 1616). In some embodiments, the first focal point is also not visible. In some embodiments, the first focal point differs from the second focal point (and/or one or more additional focal points) in that the first focal point injects color and/or objects into the animated background while the second focal point (and/or the one or more additional focal points) disturb the animated background (and/or colors and/or objects in the animated background) without injecting color and/or objects into the animated background. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, displaying the time user interface (e.g., 1610) with the first appearance (e.g., FIG. 16D) further comprises: displaying, via the one or more display generation components, the indication of the respective time (e.g., 1612) with a first set of one or more simulated reflections (e.g., simulated specular highlights on a simulated curved edge of a material and/or a simulated edge of the indication of time) at a first set of positions on the indication of the respective time (e.g., in FIG. 16D, indication of time 1612 is shown with white simulated reflections on a bottom portion of the numbers in indication of time 1612); and displaying the time user interface with the second appearance different from the first appearance comprises: displaying, via the one or more display generation components, the indication of time (e.g., 1612) with a second set of one or more simulated reflections at a second set of positioned on the indication of time that are different from the first set of positions (e.g., in FIG. 16E, indication of time 1614 is shown with white simulated reflections on a right portion of the numbers in indication of time 1612). In some embodiments, when the low power state criteria are met (e.g., in some embodiments, when transitioning from the first power state to a lower power state), one or more simulated reflections on the indication of time move to different positions. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the animated background (e.g., 1614) includes a first color gradient (e.g., 1615) that comprises a first plurality of colors, including a first color (e.g., 1615a) and a second color (e.g., 1615b) different from the first color (e.g., in some embodiments, a first color gradient that transitions from the first color to the second color and/or that includes a gradual transition from the first color to the second color); and the time user interface (e.g., 1610) with the second appearance (e.g., FIGS. 16E-16F) includes a second color gradient that comprises a second plurality of colors, wherein the second plurality of colors includes the first color and the second plurality of colors is different from the first plurality of colors (e.g., in some embodiments, animated color gradient 1615 has different colors in FIG. 16E than in FIGS. 16A-16D). In some embodiments, the second plurality of colors (e.g., 1615 in FIGS. 16E-16F) includes one or more colors that are included in the first plurality of colors (e.g., 1615 in FIGS. 16A-16D) (e.g., there is some degree of overlap between the first color gradient and the second color gradient). In some embodiments, the second plurality of colors includes the first color and does not include the second color. In some embodiments, the second plurality of colors (e.g., 1615 in FIGS. 16E-16F) includes the first color and the second color and includes one or more additional colors that are not in the first color gradient (e.g., 1615 in FIGS. 16A-16D). In some embodiments, the first color gradient (e.g., 1615 in FIGS. 16A-16D) includes a plurality of gradient stops and/or defined colors that are included in the first color gradient (e.g., in some embodiments, the first color is a first gradient stop and/or a first defined color and the second color is a second gradient stop and/or a second defined color). In some embodiments, the first color gradient also includes one or more blended colors that represent a gradual transition between two or more of the gradient stops and/or defined colors and/or combinations of two or more of the gradient stops and/or defined colors. In some embodiments, the second color gradient (e.g., 1615 in FIGS. 16E-16F) includes a plurality of gradient stops and/or defined colors that are included in the second color gradient (e.g., in some embodiments, a third color that is a third gradient stop and/or a third defined color and a fourth color that is a fourth gradient stop and/or a fourth defined color). In some embodiments, the second color gradient also includes one or more blended colors that represent a gradual transition between two or more of the gradient stops and/or defined colors and/or combinations of two or more of the gradient stops and/or defined colors. In certain alternate embodiments, the animated background includes a first color gradient that includes a first plurality of colors, and the time user interface with the second appearance also includes the first color gradient. Said another way, in some embodiments, the second color gradient is the same as the first color gradient and/or the second plurality of colors is the same as the first plurality of colors. In some embodiments, the first color gradient occurs as a result of and/or is at least in part defined by simulated physics. For example, in some embodiments, the animated background includes a first simulated material (e.g., a first simulated fluid) that is added and/or injected into the animated background (e.g., over time). The animated background displays the simulated material moving around in the animated background, wherein the movement is determined based on simulated physical movement (e.g., simulated fluid movement). In some embodiments, the first simulated material is displayed at a first color at the time the simulated material is added into the animated background, and decays over time, and eventually disappears and/over is removed from the animated background, for example, after a threshold duration of time has elapsed since the material was added to the animated background. In some embodiments, as the first simulated material decays over time, the first simulated material changes (e.g., gradually) from the first color to a second color different from the first color. In some embodiments, as the first simulated material decays over time, the first simulated material changes gradually from the first color to the second color and, over time, is displayed in two or more intermediate colors between the first color and the second color. In some embodiments, the first simulated material is added to the animated background over a period of time such that different portions of the first simulated material are added at different times (e.g., a first portion of the simulated material is added at a first time, and a second portion of the simulated material is added at a second time later than the first time). Accordingly, and at any given time, these different portions will be in different states of decay and, correspondingly, displayed with different colors in a gradient from the first color to the second color, so the gradient corresponds to different colors of the material as it changes in color over time (e.g., starting from the time it is added). For example, at a third time after the first time and the second time, the first portion of the simulated material is displayed in a particular color corresponding to the state of the decay of the first portion, and the second portion of the simulated material is concurrently displayed in a different color that corresponds to the state of decay of the second portion. Accordingly, in some embodiments, the first color gradient occurs as a result of different portions of the first simulated material being in different states of decay at any given time, and being displayed in different colors based on the different states of decay. Displaying user interface elements with different appearances at different times (e.g., such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the first color gradient (e.g., colors in animated color gradient 1615 in FIGS. 16A-16D) includes a first ordered color sequence (e.g., a first ordered color sequence that includes a transition from the first color to the second color and/or orders the first color ahead of the second color) that orders the first plurality of colors in a first order; and the second color gradient (e.g., colors in animated color gradient 1615 in FIGS. 16E-16F) includes a second ordered color sequence that shifts the first ordered color sequence by one or more colors (e.g., shifts the first order forward or backward by one color, or by two colors, or by three colors). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the second plurality of colors (e.g., colors in animated color gradient 1615 in FIGS. 16E-16F) adds one or more colors to the first plurality of colors (e.g., colors in animated color gradient 1615 in FIGS. 16A-16D) (e.g., while maintaining and/or keeping one or more colors of the first plurality of colors; and/or maintaining and/or keeping all colors from the first plurality of colors) or removes one or more colors from the first plurality of colors (e.g., while maintaining and/or keeping one or more colors of the first plurality of colors; and/or maintaining and/or keeping all other colors from the first plurality of colors). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, in accordance with a determination that the first plurality of colors (e.g., colors in animated color gradient 1615 in FIGS. 16A-16D) does not include the color black, the second plurality of colors (e.g., colors in animated color gradient 1615 in FIGS. 16E-16F) adds a respective color that is darker than the other colors in the first color gradient (e.g., the color black). In some embodiments, the respective color is added to the first color gradient while maintaining and/or keeping one or more other colors of the first plurality of colors; and/or, in some embodiments, while maintaining and/or keeping all other colors of the first plurality of colors. In some embodiments, the second plurality of colors differs from the first plurality of colors at least in that the respective color (e.g., black, dark grey, dark purple, or another dark color) replaces the second color. In some embodiments, in accordance with a determination that the first plurality of colors includes the respective color (e.g., black or another dark color), the second plurality of colors maintains the respective color (e.g., black, dark grey, dark purple, or another dark color). As noted previously, in some alternate embodiments, the first color gradient and the second color gradient are the same and/or the first plurality of colors and the second plurality of colors are the same. In some embodiments, in accordance with a determination that the first plurality of colors does not include the color black, the second plurality of colors adds the respective color to the first plurality of colors and/or replaces the second color in the first plurality of colors with the respective color that is darker than the other colors in the first color gradient (e.g., in some embodiments, while maintaining the other colors in the first plurality of colors). In some embodiments, in accordance with a determination that the first plurality of colors includes the color black and/or the respective color, the first plurality of colors and the second plurality of colors is the same and/or the first plurality of colors is maintained in the time user interface with the second appearance. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the indication of the respective time (e.g., 1612) comprises a simulated material that is at least partially translucent (e.g., a simulated glass material, optionally with reflective and/or refractive behavior); and while the computer system is in the first power state (e.g., FIGS. 16A-16D) and the time user interface (e.g., 1610) is displayed with the first appearance (e.g., FIGS. 16A-16D), the animated background (e.g., 1614) is at least partially visible through the simulated material that is at least partially translucent. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the indication of the respective time (e.g., 1612) is displayed with an appearance that is determined based on an appearance of the animated background (e.g., 1614), including; in accordance with a determination that the animated background has a first background appearance (e.g., 1614 in FIG. 16A), the indication of the respective time (e.g., 1612) has a first time appearance (e.g., 1612 in FIG. 16A); and in accordance with a determination that the animated background (e.g., 1614) has a second background appearance (e.g., 1614 in FIG. 16b) that is different from the first background appearance, the indication of the respective time has a second time appearance that is different from the first time appearance (e.g., 1612 in FIG. 16B has a different appearance from 1612 in FIG. 16A). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, while displaying the time user interface (e.g., 1610) with the second appearance (e.g., in some embodiments, while the computer system is in a lower power state) (e.g., FIGS. 16E-16F), the computer system detects a first event (e.g., 1628a, 1628b, and/or 1628c) (e.g., one or more user inputs, one or more tap inputs, a wrist raise, and/or a button press input). In response to detecting the first event, the computer system displays, via the one or more display generation components, the time user interface (e.g., 1610) with the first appearance (e.g., FIG. 16G), including concurrently displaying the indication of the respective time (e.g., 1612) and the animated background (e.g., 1614) (e.g., the animated background without masking and/or re-displaying the animated background outside of the respective portion of the animated background). Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, in response to detecting that the low power criteria are met, the computer system transitions from displaying the time user interface with the first appearance (e.g., 1610 in FIG. 16D) to displaying the time user interface with the second appearance (e.g., 1610 in FIG. 16E), wherein transitioning from displaying the time user interface with the first appearance to displaying the time user interface with the second appearance occurs over a first duration of time; and in response to detecting the first event (e.g., 1628a, 1628b, and/or 1628c), the computer system transitions from displaying the time user interface with the second appearance (e.g., 1610 in FIG. 16F) to displaying the time user interface with the first appearance (e.g., 1610 in FIG. 16G), wherein transitioning from displaying the time user interface with the second appearance to displaying the time user interface with the first appearance occurs over a second duration of time that is shorter than the first duration of time. In some embodiments, the transition of displaying the time user interface with the first appearance to the second appearance is slower than the transition of displaying the time user interface with the second appearance to the first appearance. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, while displaying the time user interface (e.g., 1610), the computer system detects, via one or more input devices, a user request (e.g., 1630a, 1630b, 1641a, and/or 1641b) (e.g., one or more user inputs; one or more touch inputs; one or more gesture inputs; one or more spoken inputs; and/or one or more button press inputs) to display a first contextual user interface (e.g., 1632) (e.g., a user interface that includes information that changes based on a current context of the computer system and/or a user interface that includes information that changes when a context of the computer system changes). In response to detecting the user request to display the first contextual user interface, the computer system displays, via the one or more display generation components, the first contextual user interface (e.g., 1632), including: in accordance with a determination that the time user interface was displayed with the first appearance when the user request to display the first contextual user interface was received (e.g., FIG. 16I) (e.g., in some embodiments, in accordance with a determination that the computer system was operating in the first power state when the user request to display the first contextual user interface was received), displaying the first contextual user interface with a first background that is determined based on the animated background (e.g., 1614) (e.g., the first background is determined based on a state of the animated background at the time that the request to display the first contextual user interface was received) (e.g., 1632 in FIG. 16J); and in accordance with a determination that the time user interface was displayed with the second appearance when the user request to display the first contextual user interface was received (e.g., FIG. 16K) (e.g., in some embodiments, in accordance with a determination that the computer system was operating in a lower power state different from the first power state when the user request to display the first contextual user interface was received), displaying the first contextual user interface (e.g., 1632) with a second background that is different from the first background and is determined based on the time user interface with the second appearance (e.g., FIG. 16L) (e.g., the first background is determined based on a state of the animated background at the time that the request to display the first contextual user interface was received). In some embodiments, displaying the first contextual user interface with a first background that is determined based on the animated background comprises displaying the first contextual user interface with the animated background (e.g., 1614) as the first background and/or as the background of the first contextual user interface (e.g., 1632 in FIG. 16J). In some embodiments, displaying the first contextual user interface (e.g., 1632) with a second background that is different from the first background and is determined based on the time user interface with the second appearance comprises displaying the first contextual user interface with the time user interface with the second appearance as the background; and/or in some embodiments, displaying the first contextual user interface with a second background different from the animated background as the background for the first contextual user interface, wherein, in some embodiments, the second background is used as part of the time user interface with the second appearance, but is not used as part of the time user interface with the first appearance. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the animated background (e.g., 1614) includes one or more components (e.g., one or more centers of gravity; one or more sources of gravity; one or more focal points; one or more object sources; one or more color sources; one or more simulated fluid sources; and/or one or more simulated fluid sinks) that move in a periodic manner (e.g., in some embodiments, source point 1616 moves in a periodic manner, as shown in FIGS. 16A-16B) and have a periodicity of a first respective unit of time; and sixty seconds is divisible by the first respective unit of time to produce a whole number (e.g., a periodicity of 1, 2, 3, 4, 5, 6, 10, 12, 15, 20, 30, or 60 seconds). In some embodiments, the one or more periodic components move in a periodic manner separate from and/or without user input. In some embodiments, the one or more periodic components also move in response to user input (e.g., touch input, movement input, and/or gyroscope-based input), but maintain a periodic movement component that offsets and/or affects the movement that is based on user input. Displaying user interface elements with different appearances at different times (such as by displaying an animated background that changes over time and/or based on detection of certain events) helps to avoid image persistence or burn in effects that can occur with some display technologies when the same object is displayed with the same appearance at the same location repeatedly or for a long period of time.

In some embodiments, the computer system displays, via the one or more display generation components, the time user interface (e.g., 1610), wherein displaying the time user interface further comprises: in accordance with a determination that the computer system is in the first power state and a first setting of the computer system is in a first state (e.g., a first state in which the animated background is enabled; a first state in which the animated background is not masked while the computer system is in the first state; and/or a first state in which the time user interface is displayed with the first appearance while the computer system is in the first state), displaying, via the one or more display generation components, the time user interface with the first appearance (e.g., 1610 in FIGS. 16A-16D); and in accordance with a determination that the computer system is in the first power state and the first setting of the computer system is in a second state different from the first state (e.g., a second state in which the animated background is disabled; a second state in which the animated background is masked while the computer system is in the first state; and/or a second state in which the time user interface is displayed with the second appearance while the computer system is in the first state), displaying, via the one or more display generation components, the time user interface with a third appearance (e.g., 1610 in FIG. 16K) that is different from the first appearance (and, in some embodiments, is different from the second appearance or is the same as the second appearance), wherein, displaying the time user interface with the third appearance includes, displaying a second indication of time (e.g., 1612 in FIG. 16K) (e.g., a version of the indication of the respective time that is the same as the indication of the respective time; a version of the indication of the respective time that is a modified version of the indication of the respective time; and/or a version of the indication of the respective time that includes one or more modifications to the indication of the respective time while, optionally, maintaining one or more visual elements and/or visual characteristics of the indication of the respective time) that includes one or more visual characteristics that are determined based on a portion of the animated background (e.g., 1614) that is selected (e.g., to be used to determine an appearance of the indication of time) based on a shape of the indication of time (e.g., 1612 in FIG. 16K) without displaying the animated background outside of the portion of the animated background. For example, in some embodiments, even when computer system 1600 is operating in the higher power state shown in FIGS. 16A-16D, computer system 1600 displays a masked version of user interface 1610 (e.g., similar to and/or the same as user interface 1610 in FIGS. 16E-16F) if a user has enabled a setting to display the masked version of user interface 1610 even in the higher power state (e.g., in some embodiments, in FIG. 16K, computer system 1600 is operating in the higher power state, but is displaying user interface 1610 with masking of animated background 1614 outside of indication of time 1612 based on user selection of an option to display user interface 1610 in this manner). In some embodiments, the first setting of the computer system is controllable by a user (e.g., based on one or more inputs directed to a settings user interface) to switch the first setting between the first state and the second state. In some embodiments, displaying the time user interface further comprises: in accordance with a determination that the low power state criteria are met (and/or, in some embodiments, that the computer system is in a lower power state different from the first power state), displaying, via the one or more display generation components, the time user interface with the second appearance (e.g., 1610 in FIGS. 16E-16F) (e.g., in some embodiments, regardless of the state of the first setting of the computer system). In some embodiments, displaying the time user interface (e.g., 1610) with the third appearance (e.g., 1610 in FIG. 16K) differs from displaying the time user interface (e.g., 1610) with the second appearance (e.g., 1610 in FIGS. 16E-16F) (e.g., the third appearance differs from the second appearance). In some embodiments, the second appearance (e.g., 1610 in FIGS. 16E-16F) includes animation of the animated background (e.g., 1614) (e.g., animation of the respective portion of the animated background) at a second rate of change of animation, and the third appearance (e.g., 1610 in FIG. 16K) includes animation of the animated background (e.g., 1614) (e.g., 1614) (e.g., animation of the portion of the animated background) at a third rate of change of animation that is faster than the second rate of change of animation. In some embodiments, the second rate of change of animation is zero rate of change such that the second appearance does not include any movement of the respective portion of the animated background. In some embodiments, the first appearance includes animation of the animated background at a first rate of change of animation. In some embodiments, the first rate of change of animation is the same as the third rate of change of animation. In some embodiments, displaying the time user interface with the second appearance (e.g., 1610 in FIGS. 16E-16F) includes displaying the respective portion of the animated background (e.g., 1614) with a second color gradient that includes a second plurality of colors. In some embodiments, the third appearance (e.g., 1610 in FIG. 16K) includes displaying the portion of the animated background with a third color gradient that includes a third plurality of colors. In some embodiments, the third plurality of colors is different from the second plurality of colors. In some embodiments, the second plurality of colors adds one or more colors to the second plurality of colors that is darker than the other colors in the second plurality of colors (e.g., while maintaining all or some of the other colors in the second plurality of colors). In some embodiments, the first appearance includes displaying the animated background with a first color gradient that includes a first plurality of colors. In some embodiments, the first color gradient is the same as the third color gradient and/or the first plurality of colors is the same as the third plurality of colors. Providing the user with an option to selectively enable or disable the animated background enhances the operability of the device by reducing accidental and mistaken inputs, reducing energy usage by the device.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/MVL systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/MBL systems should not misrepresent machine-generated outputs as being human-generated.

As described above, one aspect of the present technology is the gathering and use of data available from various sources to display user interfaces based on ambient conditions. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to display targeted content that is of greater interest to the user. Accordingly, use of such personal information data enables users to have calculated control of the displayed content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of displaying information from an application, the present technology can be configured to allow users to select to “opt in” or “opt out” of participation in the collection of personal information data during registration and/or configuration of the corresponding application or anytime thereafter. In another example, users can select not to provide personal information. In yet another example, users can select to limit the length of time personal information is maintained or entirely prohibit the collection of personal information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and displayed to users by inferring preferences based on non-personal information data or a bare minimum amount of personal information, such as the content being requested by the device associated with a user, other non-personal information available to the computer system, or publicly available information.

1.-196. (canceled)

197. A computer system configured to communicate with one or more display generation components and one or more input devices, comprising:
one or more processors; and
memory storing one or more programs configured to be executed by the one or more processors, the one or more programs including instructions for:
displaying, via the one or more display generation components, a user interface with a visual effect with a first appearance;
detecting, via the one or more input devices, a change in position of a person relative to the one or more display generation components; and
in response to detecting the change in the position of the person relative to the one or more display generation components, displaying, via the one or more display generation components, the user interface with a change in the visual effect, wherein:
in accordance with a determination that the change in position of the person is a first change, displaying the change in the visual effect includes displaying the visual effect with a first updated appearance that is different from the first appearance; and
in accordance with a determination that the change in position of the person is a second change that is different from the first change, displaying the change in the visual effect includes displaying the visual effect with a second updated appearance that is different from the first appearance and the first updated appearance.

198. The computer system of claim 197, wherein:
the first change in position is to a first updated position;
the second change in position is to a second updated position that is different from the first updated position;
the first updated position is between an initial position and the second updated position; and
a respective characteristic of the first updated appearance is between a respective characteristic of the first appearance and a respective characteristic of the second updated appearance.

199. The computer system of claim 197, wherein the visual effect includes a simulated reflection.

200. The computer system of claim 199, wherein the simulated reflection includes a simulated specular highlight.

201. The computer system of claim 199, wherein the simulated reflection includes a first component that translates in a first direction as the position of the person changes in the first direction.

202. The computer system of claim 199, wherein the simulated reflection includes a second component that changes in the first direction and in a second direction that is different from the first direction as the position of the person changes in the first direction and in the second direction.

203. The computer system of claim 202, wherein the simulated reflection that includes a second component that changes in the first direction and in the second direction is based on a position of a simulated light source.

204. The computer system of claim 197, the one or more programs further including instructions for:
after displaying the user interface with the change in the visual effect, in response to a determination that a condition is met, ceasing display of the change in the visual effect.

205. The computer system of claim 204, wherein the condition includes the person being outside a predetermined range.

206. The computer system of claim 204, wherein the condition includes that more than one person is detected via the one or more input devices.

207. The computer system of claim 204, wherein the condition includes a determination that the person is not looking at the computer system.

208. The computer system of claim 204, wherein ceasing display of the change in the visual effect includes gradually changing from displaying the change in the visual effect to forgoing displaying the change in visual effect.

209. The computer system of claim 204, wherein ceasing display of the change in the visual effect includes displaying the visual effect in a default state.

210. The computer system of claim 204, the one or more programs further including instructions for:
after ceasing display of the change in the visual effect, in accordance with a determination that the condition ceases to be met, displaying the change in the visual effect.

211. The computer system of claim 197, wherein the user interface with the visual effect includes an element that appears partially transparent relative to a background element.

212. The computer system of claim 197, wherein the user interface with the visual effect includes background content that is animated.

213. The computer system of claim 212, wherein the background content is animated based on a respective change in position of the person relative to the one or more display generation components.

214. The computer system of claim 197, wherein displaying the user interface includes:
displaying, via the one or more display generation components, a simulated material that is overlaid on a background, wherein:
the visual effect is applied to the simulated material; and
an appearance of the background affects an appearance of the simulated material.

215. The computer system of claim 214, wherein the appearance of the simulated material is based on a blurred version of the background.

216. The computer system of claim 214, wherein the appearance of the simulated material is based on a version of the background with a modified scale.

217. The computer system of claim 216, wherein:
in accordance with a determination that the user interface is a first user interface, the simulated material has an appearance that is based on a version of the background with a first modified scale; and
in accordance with a determination that the user interface is a second user interface that is different from the first user interface, the simulated material has an appearance that is based on a version of the background with a second modified scale that is different from the first modified scale.

218. The computer system of claim 216, wherein:
a first portion of the simulated material includes an appearance of the simulated material that is based on a version of the background with a third modified scale; and
a second portion of the simulated material includes an appearance of the simulated material that is based on a version of the background with a fourth modified scale that is different from the third modified scale.

219. The computer system of claim 214, the one or more programs further including instructions for:
identifying a subject of the background;
creating a modified version of the background that does not include the subject; and
displaying the simulated material with an appearance that is based on the modified version of the background that does not include the subject.

220. The computer system of claim 219, wherein the subject is overlaid on at least a portion of the simulated material.

221. The computer system of claim 219, wherein creating the modified version of the background includes automatically generating a portion of the background where the subject was removed.

222. The computer system of claim 214, wherein the visual effect is applied to a foreground element and wherein the visual effect is not applied to a background element.

223. The computer system of claim 214, the one or more programs further including instructions for:
displaying a first user interface that includes the visual effect applied to a foreground element; and
transitioning display of the first user interface to display of a second user interface that includes the visual effect, wherein transitioning from the first user interface to the second user interface includes:
ceasing to display the foreground element;
replacing display of a background of the first user interface with display of a background of the second user interface; and
resuming display of the foreground element.

224. The computer system of claim 197, wherein:
the change in the visual effect is non-linear with respect to the change in position of the person.

225. The computer system of claim 197, wherein the visual effect includes a color region that responds to movement of the person.

226. A non-transitory computer-readable storage medium storing one or more programs configured to be executed by one or more processors of a computer system that is in communication with one or more display generation components and one or more input devices, the one or more programs including instructions for:
displaying, via the one or more display generation components, a user interface with a visual effect with a first appearance;
detecting, via the one or more input devices, a change in position of a person relative to the one or more display generation components; and
in response to detecting the change in the position of the person relative to the one or more display generation components, displaying, via the one or more display generation components, the user interface with a change in the visual effect, wherein:
in accordance with a determination that the change in position of the person is a first change, displaying the change in the visual effect includes displaying the visual effect with a first updated appearance that is different from the first appearance; and
in accordance with a determination that the change in position of the person is a second change that is different from the first change, displaying the change in the visual effect includes displaying the visual effect with a second updated appearance that is different from the first appearance and the first updated appearance.

227. A method, comprising:
at a computer system that is in communication with one or more display generation components and one or more input devices:
displaying, via the one or more display generation components, a user interface with a visual effect with a first appearance;
detecting, via the one or more input devices, a change in position of a person relative to the one or more display generation components; and
in response to detecting the change in the position of the person relative to the one or more display generation components, displaying, via the one or more display generation components, the user interface with a change in the visual effect, wherein:
in accordance with a determination that the change in position of the person is a first change, displaying the change in the visual effect includes displaying the visual effect with a first updated appearance that is different from the first appearance; and
in accordance with a determination that the change in position of the person is a second change that is different from the first change, displaying the change in the visual effect includes displaying the visual effect with a second updated appearance that is different from the first appearance and the first updated appearance.
